(19) United States
(12) Patent Application Publication
(10) Pub. No.: US 2025/0211694 A1
(43) Pub. Date: Jun. 26, 2025

(54) OPTICAL SCANNING DEVICE AND IMAGE FORMING APPARATUS

(71) Applicant: CANON KABUSHIKI KAISHA, Tokyo (JP)

(72) Inventors: SOYA SAIJO, Tochigi (JP); MASAYASU TERAMURA, Tochigi (JP); TORU YATABE, Tochigi (JP)

(21) Appl. No.: 18/979,403

(22) Filed: Dec. 12, 2024

(30) Foreign Application Priority Data
Dec. 21, 2023 (JP) 2023-215781
Dec. 21, 2023 (JP) 2023-215782
Dec. 21, 2023 (JP) 2023-215785
Nov. 15, 2024 (JP) 2024-199436

(51) Int. Cl. H04N 1/024; G03G 15/043; H04N 1/113

(52) U.S. Cl. CPC H04N 1/02481; G03G 15/043; H04N 1/113; H04N 2201/02431

(57) ABSTRACT

An optical scanning device includes a deflector including a first deflection surface configured to deflect first and second light beams to scan first and second scanned surfaces in a main scanning direction, respectively, and first and second optical systems configured to guide the first and second light beams deflected by the first deflection surface to the first and second scanned surfaces, wherein the first and second optical systems include a common first optical element disposed on first and second optical paths, wherein the first optical system includes a second optical element located between the first optical element and the first scanned surface, wherein the second optical system includes a third optical element located between the first optical element and the second scanned surface, and wherein the first optical element includes first and second optical portions on which the first and second light beams are incident.

### BACKGROUND

### Technical Field

The present disclosure relates to an optical scanning device, and particularly to one suitable for image forming apparatuses such as a laser beam printer (LBP), a digital copying machine, and a multifunction printer (MFP).

### Description of the Related Art

In recent years, miniaturization of optical scanning devices used for image forming apparatuses has been demanded. However, if a reduction in the size of an optical scanning device is attempted, the internal space of the optical scanning device becomes narrower, and optical elements become difficult to dispose without interfering with each other.

Japanese Patent Application Laid-Open No. 2018-128516 discusses an optical scanning device in which multi-stage lenses integrating a plurality of lens surfaces arranged in a sub scanning direction are employed and the lens surfaces of the multi-stage lenses are configured in respective different shapes. This increases the degree of freedom in layout is increased and reduces the number of optical parts.

### SUMMARY

According to some embodiments, an optical scanning device includes a deflector including a first deflection surface configured to deflect first and second light beams to scan first and second scanned surfaces in a main scanning direction, respectively, and first and second optical systems configured to guide the first and second light beams deflected by the first deflection surface to the first and second scanned surfaces, wherein the first and second optical systems include a common first optical element disposed on first and second optical paths extending from the first deflection surface to the first and second scanned surfaces, respectively, wherein the first optical system includes a second optical element located on the first optical path, between the first optical element and the first scanned surface, wherein the second optical system includes a third optical element located on the second optical path, between the first optical element and the second scanned surface, and wherein the first optical element includes first and second optical portions on which the first and second light beams are incident.

Further features of various embodiments of the present disclosure will become apparent from the following description of exemplary embodiments with reference to the attached drawings.

### BRIEF DESCRIPTION OF THE DRAWINGS

FIG. 1A is a sub scanning sectional view of an optical scanning device according to a first exemplary embodiment. FIG. 1B is an optical path diagram of the optical scanning device according to the first exemplary embodiment in main scanning sections. FIG. 1C is an optical path diagram of the optical scanning device according to the first exemplary embodiment in a sub scanning section.

FIGS. 2A and 2B are diagrams illustrating sub scanning sections of multi-stage lenses according to the first exemplary embodiment and a comparative example.

FIG. 3 is a graph illustrating a step height at the interface of lens surfaces of a multi-stage lens according to a first practical example.

FIGS. 4A and 4B are graphs illustrating field curvatures of imaging optical systems according to the first practical example.

FIGS. 5A and 5B are graphs illustrating f0 characteristics of the imaging optical systems according to the first practical example.

FIGS. 6A and 6B are graphs illustrating scanning line curvatures of the imaging optical systems according to the first practical example.

FIG. 7A is a sub scanning sectional view of an optical scanning device according to a second exemplary embodiment. FIG. 7B is an optical path diagram of the optical scanning device according to the second exemplary embodiment in main scanning sections. FIG. 7C is an optical path diagram of the optical scanning device according to the second exemplary embodiment in a sub scanning section.

FIG. 8 is a graph illustrating a step height at the interface of lens surfaces of a multi-stage lens according to a second practical example.

FIGS. 9A and 9B are graphs illustrating field curvatures of imaging optical systems according to the second practical example.

FIGS. 10A and 10B are graphs illustrating fθ characteristics of the imaging optical systems according to the second practical example.

FIGS. 11A and 11B are graphs illustrating scanning line curvatures of the imaging optical systems according to the second practical example.

FIG. 12A is an optical path diagram of an optical scanning device according to a third exemplary embodiment in main scanning sections. FIG. 12B is an optical path diagram of the optical scanning device according to the third exemplary embodiment in a sub scanning section.

FIG. 13 is a sub scanning sectional view of imaging optical systems included in the optical scanning device according to the third exemplary embodiment.

FIG. 14 is a schematic diagram for describing changes of rays due to eccentricity of a deflector.

FIG. 15A is an optical path diagram of an optical scanning device according to a fourth exemplary embodiment in a main scanning section. FIG. 15B is an optical path diagram of the optical scanning device according to the fourth exemplary embodiment in a sub scanning section.

FIG. 16 is a sub scanning sectional view of imaging optical systems included in the optical scanning device according to the fourth exemplary embodiment.

FIGS. 17A and 17B are optical path diagrams of an optical scanning device according to a fifth exemplary embodiment in main scanning sections. FIG. 17C is a sub scanning sectional view of incident optical systems of the optical scanning device according to the fifth exemplary embodiment. FIG. 17D is a sub scanning sectional view of imaging optical systems of the optical scanning device according to the fifth exemplary embodiment.

FIG. 18 is a diagram for describing a first optical element according to the fifth exemplary embodiment.

FIG. 19 is a diagram for describing optical performance according to the fifth exemplary embodiment.

FIGS. 20A and 20B are optical path diagrams of an optical scanning device according to a sixth exemplary embodiment in main scanning sections. FIG. 20C is a sub scanning sectional view of incident optical systems of the optical scanning device according to the sixth exemplary embodiment. FIG. 20D is a sub scanning sectional view of imaging optical systems of the optical scanning device according to the sixth exemplary embodiment.

FIG. 21 is a diagram for describing first optical elements according to the sixth exemplary embodiment.

FIG. 22 is a sub scanning sectional view of a color image forming apparatus.

### DESCRIPTION OF THE EMBODIMENTS

Hereinafter, an optical scanning device according to the present exemplary embodiments will be described in detail with reference to the accompanying drawings. Note that the attached drawings may be drawn in a scale different from the actual scale in order to facilitate understanding of the present exemplary embodiments.

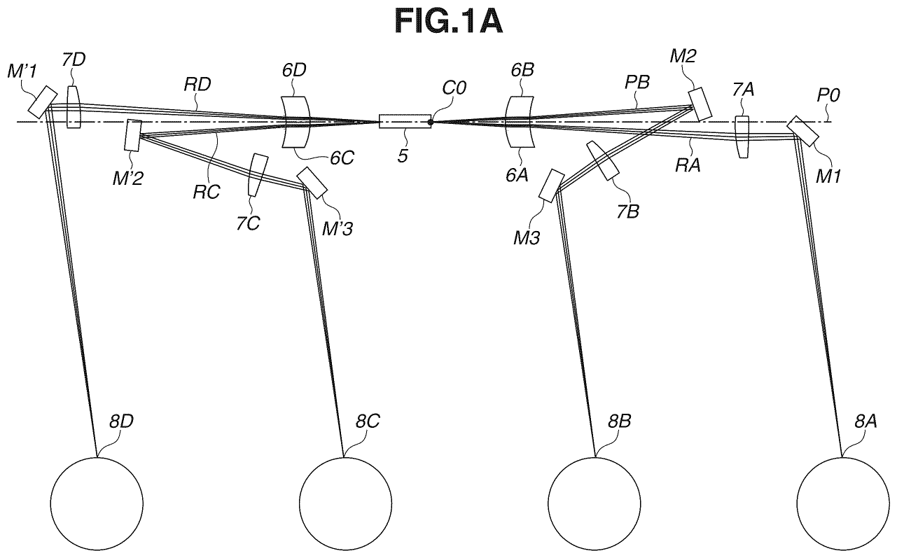

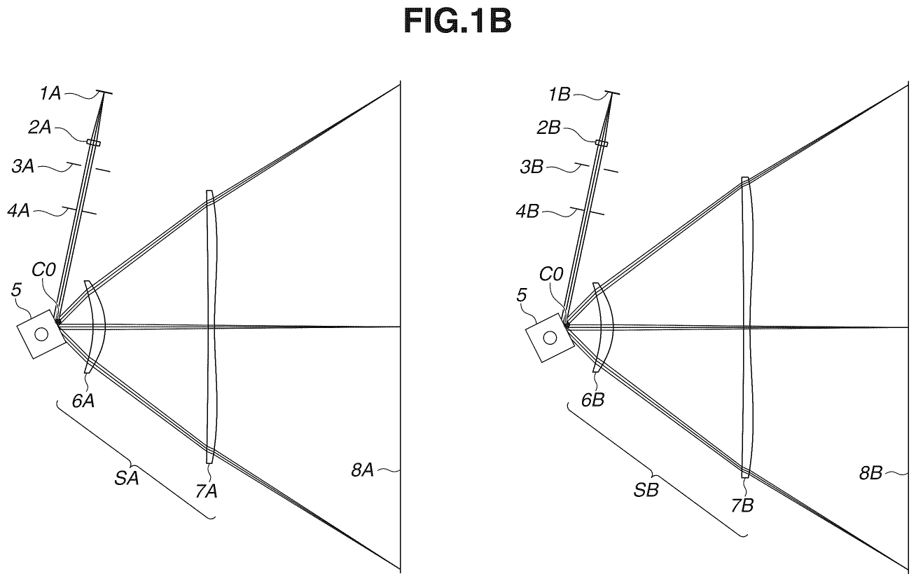

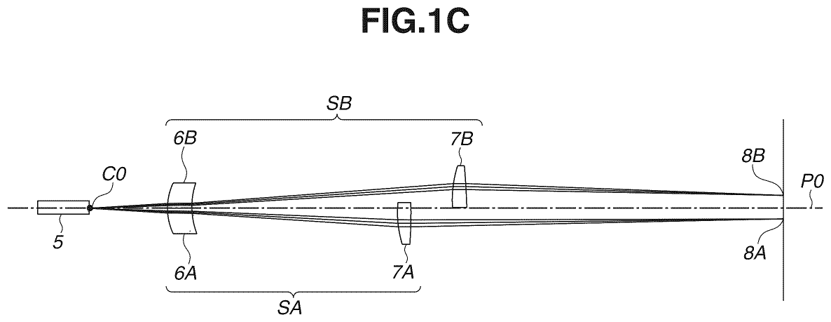

FIG. 1A is a sub scanning sectional view of essential parts of an optical scanning device 100 according to a first exemplary embodiment. FIG. 1B is an optical path diagram of essential parts of the optical scanning device 100 according to the first exemplary embodiment in main scanning sections. FIG. 1C is an optical path diagram of essential parts of the optical scanning device 100 according to the first exemplary embodiment in a sub scanning section.

In the following description, a main scanning direction (Y direction) refers to a direction perpendicular to the rotation axis (or oscillation axis) of a deflector and the optical axis of an imaging optical system (direction in which a light beam is reflected and deflected [deflected and scanned] by a rotating polygon mirror). A sub scanning direction (Z direction) refers to a direction parallel to the rotation axis (or oscillation axis) of the deflector. A main scanning section refers to a section that includes the optical axis and is perpendicular to the sub scanning direction. A sub scanning section refers to a section perpendicular to the main scanning direction.

The optical scanning device 100 according to the present exemplary embodiment includes light sources 1A (first light source), 1B (second light source), 1C (third light source), and 1D (fourth light source), incident optical systems LA, LB, LC, and LD, a deflector 5, imaging optical systems SA (first optical system), SB (second optical system), SC (third optical system), and SD (fourth optical system), and mirrors M1, M2, M3, M′1, M′2, and M′3. Optical elements such as lenses and prisms with reflective surfaces may be used as reflective elements instead of the mirrors. Prisms may be used as refractive elements instead of the lenses.

In the optical scanning device 100 according to the present exemplary embodiment, the imaging optical systems SA and SB and the imaging optical systems SC and SD are located with the single deflector 5 therebetween. The single deflector 5 deflects and scans four light beams RA (first light beam), RB (second light beam), RC (third light beam), and RD (fourth light beam) to scan corresponding scanned surfaces 8A (first scanned surface), 8B (second scanned surface), 8C (third scanned surface), and 8D (fourth scanned surface). The single deflector 5 is shared by the plurality of light beams RA, RB, RC, and RD, and sub scanning oblique incident optical systems are used where light beams are incident on the deflector at oblique angles in the sub scanning direction. The sub scanning oblique incident optical systems are advantageous in that the deflected and reflected light beams are separable without increasing the size of the deflection surface of the optical deflector in the sub scanning direction.

In the imaging optical system SA, the light beam RA (first light beam) deflected by a common deflection surface (first deflection surface) of the deflector (four-sided polygon mirror) 5 serving as a deflection unit passes through a first optical portion 6A and a lens 7A in order, is then folded back by the mirror M1 (first reflective element), and guided to the scanned surface 8A. The first optical portion 6A is a part of a multi-stage lens serving as a first optical element (first refractive element). The lens 7A serves as a second optical element (second refractive element). In the imaging optical system SB, the light beam RB (second light beam) deflected and reflected by the deflection surface of the deflector 5 passes through a second optical portion 6B, is then folded back by the mirror M2 (second reflective element), and passes through a lens 7B. The light beam RB is then folded back by the mirror M3 and reaches the scanned surface 8B. The second optical portion 6B is a part of the multi-stage lens. The lens 7B serves as a third optical element (third refractive element). In the diagram, when the principal ray of a light beam (axial light beam) that reaches the axial image height on the scanned surface is deflected, the point of incidence (point of deflection) of the principal ray on the deflection surface is denoted by C0, and will hereinafter be referred to as an axial deflection point or simply as a deflection point. The plane (reference plane) that intersects with the deflection point C0 and is perpendicular to the rotation axis of the deflector 5 is denoted by P0. The light beams RA and RB incident on the deflection surface intersect at the deflection point C0 and are deflected in the sub scanning section. The lengths of the optical paths from the deflection point C0 to the respective scanned surfaces will hereinafter be referred to as the optical path lengths of the respective imaging optical systems. The optical paths from the deflection surface to the scanned surfaces 8A and 8B will be referred to as a first optical path and a second optical path, respectively.

In the imaging optical system SD (SC), the optical path is routed similarly to the imaging optical system SA (SB). Specifically, in the imaging optical system SC, the light beam RC (third light beam) deflected and reflected by a deflection surface (second deflection surface) of the deflector 5 passes through a third optical portion 6C, is then folded back by the mirror M′2 (fourth reflective element), and passes through a lens 7C. The light beam RC is then folded back by the mirror M′3 (fifth reflective element) and reaches the scanned surface 8C. The third optical portion 6C is a part of a multi-stage lens serving as a fourth optical element (fourth refractive element). The lens 7C serves as a fifth optical element (fifth refractive element). In the imaging optical system SD, the light beam RD (fourth light beam) deflected by the deflection surface of the deflector 5 passes through a fourth optical portion 6D and a lens 7D, is then folded back by the mirror M′1 (sixth reflective element), and guided to the scanned surface 8D. The fourth optical portion 6D is a part of the multi-stage lens. The lens 7D serves as a sixth optical element (sixth refractive element). The optical paths from the deflection surface to the scanned surfaces 8C and 8D will be referred to as a third optical path and a fourth optical path, respectively.

The imaging optical systems SA and SB according to the present exemplary embodiment will be described. The imaging optical systems SA and SB each consist of a plurality of lenses. In the imaging optical system SA (SB), the lens (optical portion) optically closest to the deflector 5 is referred to as the lens 6A (6B), and the lens optically closest to the scanned surface 8A (8B) as the lens 7A (7B). As employed herein, “optically” means “in a state where optical paths are developed”.

The lenses (optical portions) 6A and 6B according to the present exemplary embodiment are arranged in the sub scanning direction and constitute a multi-stage lens (common first optical element) where their incident surfaces and exit surfaces are integrally formed. Such a configuration enables the first and second optical paths corresponding to the light beams RA and RB to share the lens. The number of optical members is thereby reduced to reduce the size and cost of the optical scanning device 100.

In the multi-stage lens according to the present exemplary embodiment, at least either the incident surfaces or the exit surfaces of the lenses 6A and 6B have lens surface shapes asymmetric in the sub scanning direction with respect to the reference plane P0. The upper and lower portions of the multi-stage lens with respect to the reference plane P0 have different shapes in both the main scanning section (generatrix shape) and the sub scanning section (sagittal shape). As employed herein, a generatrix shape refers to the lens surface shape within the main scanning section including the optical axis. By configuring at least either the incident surfaces or the exit surfaces of the lenses 6A and 6B to have different lens surface shapes, the lenses 7A and 7B are located so that the optical positions of the lenses 7A and 7B from the deflection point C0 are different while maintaining the optical performance of the imaging optical systems SA and SB favorable. This increases the degree of freedom in layout.

Compared to the case where the lenses 7A and 7B are located at the same optical positions from the deflection point C0, the lens 7B is thus be located optically closer to the scanned surface than the lens 7A. This leads to avoidance of interference between the lens 7B and the light beam RA in a small space and a reduction in size of the optical scanning device 100.

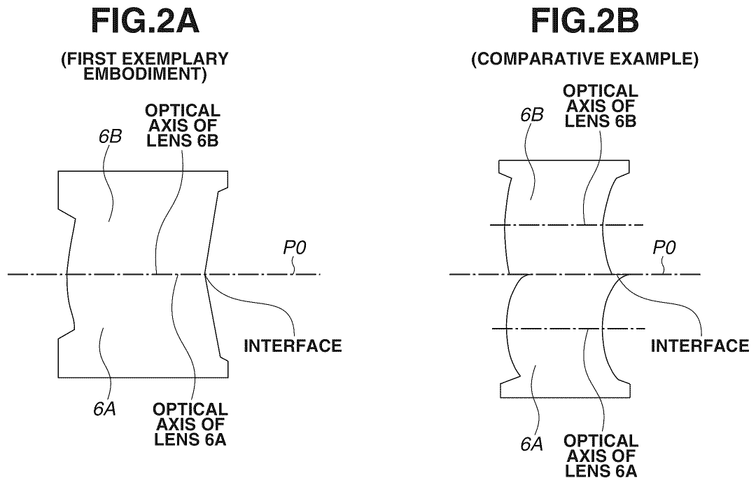

FIG. 2B illustrates a multi-stage lens according to a comparative example (conventional example), where a plurality of optical portions is located so that their optical axes (surface vertexes) are off-centered in the sub scanning direction and differ from each other. If the lenses in the multi-stage lens have different lens surface shapes, the step height in the optical axis direction increases at the interface between the lens surfaces of the multi-stage lens.

In the optical scanning device 100 according to the present exemplary embodiment, as illustrated in FIG. 2A, the lenses 6A and 6B are integrated into the multi-stage lens so that the optical axes of the lenses 6A and 6B are located at the same position, i.e., to not be off-centered from each other in the sub scanning direction. Despite the lens surfaces of the multi-stage lens having different shapes, the step height at the interface of the lens surfaces therefore results only from a difference in the generatrix shapes, and the step height is not affected by a difference in the sagittal shapes. This reduces the step height at the interface of the multi-stage lens, whereby the molding stability of the lenses 6A and 6B is favorably improved.

The multi-stage lens of the optical scanning device 100 according to the present exemplary embodiment desirably satisfies the following inequality (1):

0.01≤|Xmax|≤1.0, (1)

where Xmax (mm) is the maximum value (maximum step height) of the step (deviation in the optical axis direction) across the entire interface between the lens surfaces of different lens surface shapes.

By satisfying inequality (1), it is possible to reduce difference in imaging performance between the optical paths due to the differences in the lens surface shapes of the multi-stage lens. The maximum value set above the upper limit of inequality (1 results in that the step height at the interface is so large that the lens surfaces are significantly deformed and strained by thermal deformation stress occurring near the step due to the step during molding. This affects the effective areas of the lens surfaces for the light beams to pass through, and degrades wavefront aberration. The maximum value set below the lower limit of inequality (1) results in that the amount of variations in shape that is introduced between the lens shapes is so small that the range where the lenses 7A and 7B are freely laid out while maintaining the imaging performance of both the imaging optical systems SA and SB decreases. This makes miniaturization and imaging performance difficult to achieve in a compatible manner.

The multi-stage lens more desirably satisfies inequality (1a):

0.01≤|Xmax|≤0.5. (1a)

The multi-stage lens even more desirably satisfies inequality (1b):

0.02≤|Xmax|≤0.2. (1b)

The imaging optical systems SC and SD according to the present exemplary embodiment have a configuration and optical operation similar to those of the imaging optical systems SA and SB. The lenses (optical portions) 6C and 6D are arranged in the sub scanning direction and constitute a multi-stage lens (common fourth optical element) where their incident surfaces and exit surfaces are integrally formed. The incident surfaces of the optical portions 6C and 6D are independent of each other and have respective different surface vertexes. Similarly, the exit surfaces of the optical portions 6C and 6D are also independent of each other and have respective different surface vertexes. The parts number of lenses is thereby reduced. Since the lenses 6C and 6D have respective different lens surface shapes and the lenses 7C and 7D are located at respective different optical positions from the deflection point C0, the interference between the lens 7C and the light beam RD is avoided in a small space while maintaining the optical characteristics of the imaging optical systems SC and SD favorable. This leads to a reduction in size of the optical scanning device 100.

The optical scanning device 100 according to the present exemplary embodiment is configured so that, in the sub scanning section, the sub scanning oblique incident angle of the imaging optical system SA (SB) and that of the imaging optical system SD (SC) are 180° rotationally symmetrical about a main scanning axis. The main scanning axis refers to an axis that passes through the intersection of the rotation axis of the deflector 5 and the optical axes of the imaging optical systems SA and SD (SB and SC) and is parallel to the main scanning direction. The optical portions 6A and 6D (first and fourth optical portions) are shaped so that one of the optical portions 6A and 6D matches the other if rotated 180° on the sub scanning section (about the main scanning axis). The lens 6A and 7A and the lens 6D and 7D thus have the same lens surface shapes, even if the sagittal shapes are asymmetric about the optical axes like a sagittal tilt configuration, which is used to correct both scanning line curvature and twisted wavefront aberration in a compatible manner in conventional sub scanning oblique incidence optical systems. Similarly, the lenses 6B and 7B and the lenses 6C and 7C have the same lens surface shapes. As a result, the multi-stage lens integrating the lenses 6A and 6B and the multi-stage lens integrating the lenses 6C and 6D are configured as common optical parts. Moreover, the lenses 7A and 7D and the lenses 7B and 7C are configured as respective optical parts of the same shapes. This leads to a reduction in the types of optical parts.

In the optical scanning device 100 according to the present exemplary embodiment, the imaging optical systems SA and SD are optically equivalent, and the imaging optical systems SB and SC are optically equivalent. Such optically equivalent configurations minimize color misregistration when the optical scanning device 100 is used in an image forming apparatus. Moreover, since fθ characteristics are made the same, a common image clock is used to reduce the cost of the circuit substrate.

The optical scanning device 100 according to the present exemplary embodiment thus achieves favorable imaging performance in a manner compatible with miniaturization and a reduction in the parts types.

### (First Practical Example)

An optical scanning device 100 according to a first practical example will now be described. A description of configurations of the optical scanning device 100 according to the present practical example that are similar to those of the optical scanning device 100 according to the foregoing exemplary embodiment will be omitted.

In the optical scanning device 100 according to the present practical example, the light beams RA and RB emitted from the respective light sources 1A and 1B are incident on the deflection surface of the deflector 5 obliquely in the sub scanning section at an angle of αsA=+2.7° and αsB=−2.7° with the reference plane P0, respectively. Similarly, the light beams RC and RD emitted from the respective light sources 1C and 1D are incident on the deflecting surface of the deflector 5 obliquely in the sub scanning section at an angle of αsC=+2.7° and αsD=−2.7° with the reference plane P0, respectively.

Too large an oblique incident angle makes spot distortion caused by twisted wavefront aberration difficult to correct. Too small an oblique incident angle makes the optical paths difficult to separate.

The optical scanning device 100 according to the practical example uses semiconductor lasers as the light sources 1A, 1B, 1C, and 1D.

In the optical scanning device 100 according to the practical example, the incident optical systems LA, LB, LC, and LD include anamorphic lenses 2A, 2B, 2C, and 2D, sub scanning aperture stops 3A, 3B, 3C, and 3D, and main scanning aperture stops 4A, 4B, 4C, and 4D.

The anamorphic lenses 2A, 2B, 2C, and 2D have anamorphic exit surfaces, where the radii of curvature in the main scanning direction and the sub scanning direction are designed to differ so that desired light beams are formed in both the main and sub scanning directions. In the main scanning section, the anamorphic lenses 2A, 2B, 2C, and 2D convert the light beams RA, RB, RC, and RD emitted from the respective light sources 1A, 1B, 1C, and 1D into parallel beams. As employed herein, parallel beams are not limited to strictly parallel ones but include approximately parallel beams such as weakly diverging beams and weakly converging beams. In the sub scanning section, the anamorphic lenses 2A and 2B converge the light beams RA and RB emitted from the light sources 1A and 1B near the deflection surface of the deflector 5, respectively. Similarly, in the sub scanning section, the anamorphic lenses 2C and 2D converge the light beams RC and RD emitted from the light sources 1C and 1D near the deflection surface of the deflector 5, respectively. The anamorphic lenses 2A and 2B have refractive incident surfaces for temperature compensation.

The sub scanning aperture stops 3A, 3B, 3C, and 3D limit the beam diameters, in the sub scanning direction, of the light beams RA, RB, RC, and RD passed through the anamorphic lenses 2A, 2B, 2C, and 2D, respectively. Similarly, the main scanning aperture stops 4A, 4B, 4C, and 4D limit the beam diameters, in the main scanning direction, of the light beams RA, RB, RC, and RD passed through the anamorphic lenses 2A, 2B, 2C, and 2D, respectively. The aperture diameters are designed to form a spot of desired spot diameter on the scanned surfaces 8A (yellow [Y]), 8B (magenta [M]), 8C (cyan [C]), and 8D (black [K]).

The optical scanning device 100 according to the practical example is designed so that in the main scanning section, the principal rays of the light beams RA and RB passed through the incident optical systems LA and LB and incident on the deflection surface and the optical axes of the respective imaging optical systems SA and SB form an angle α of 78°. Similarly, the optical scanning device 100 are designed so that in the main scanning section, the principal rays of the light beams RC and RD passed through the incident optical systems LC and LD and incident on the deflection surface and the optical axes of the respective imaging optical systems SC and SD form an angle α of 78°.

In the optical scanning device 100 according to the practical example, the incident optical systems LA, LB, LC, and LD have the same configurations, with the same distances in the optical axis directions. In the optical scanning device 100 according to the practical example, the anamorphic lenses 2A and 2B and the anamorphic lenses 2C and 2D are constituted by respective integrally molded resin lens to reduce the number of optical parts for cost reduction. However, the effects of the practical example are not limited to such a configuration. In the optical scanning device 100 according to the practical example, the optical parts are disposed in a common layout to reduce the types of part holding units and the types of assembly tools for improved productivity.

The deflector 5 is a four-sided polygon mirror with a circumcircle circle diameter of 10 mm. The deflector 5 is rotated at a constant speed by a motor, whereby the scanned surfaces 8A, 8B, 8C, and 8D are scanned. This achieves an optical scanning device that, when mounted on an image forming apparatus, enables simultaneous scans corresponding to the four colors Y, M, C, and K. The imaging optical systems SA, SB, SC, and SD are configured so that in the sub scanning section, the deflection surfaces 5A of the deflector 5 and the scanned surfaces 8A, 8B, 8C, and 8D are in an optically conjugate relationship for face tangle correction. When a deflector with a plurality of deflection surfaces such as a polygon mirror is used, a face tangle correction optical system is typically employed since the tilt angles of the deflection surfaces in the sub scanning direction vary from one deflection surface to another.

Tables 1, 2, 3, and 4 below illustrate the specifications, optical layout, and lens surface shapes of the optical scanning device 100 according to the present practical example. Table 1 describes the specifications and lens layout of the incident optical system LA and the imaging optical system SA. Table 2 describes the lens surface shapes of the incident optical system LA and the imaging optical system SA. Table 3 describes the specifications and lens layout of the incident optical system LB and the imaging optical system SB. Table 4 describes the lens surface shapes of the incident optical system LB and the imaging optical system SB.

Tables 1 and 3 also illustrate the lens layout of the incident optical system LC and the imaging optical system SC and the lens layout of the incident optical system LD and the imaging optical system SD. The specifications and lens surface shapes of the incident optical system LC and the imaging optical system SC and the specifications and lens surface shapes of the incident optical system LD and the imaging optical system SD are equivalent to those of the input optical system LB and the imaging optical system SB and those of the input optical system LA and the imaging optical system SA, respectively. A description thereof will thus be omitted. The optical layout sections of Tables 1 and 3 describe the coordinates of the reflection points, on the respective mirrors, of the light beams RA and RB traveling toward the image centers (axial image heights) in the main scanning direction on the scanned surfaces.

TABLE 1
Specification values

| | | |
|---|---|---|
| Laser wavelength (nm) | λ | 790 |
| Main scanning direction incident angle (deg) | αm | 78 |
| from incident optical system to deflector | | |
| Sub scanning direction incident angle (deg) | αs | 2.7 |
| from incident optical system to deflector | | |
| Refractive index of anamorphic lens | n2 | 1.524 |
| Refractive index of imaging lens 6 | n6 | 1.524 |
| Refractive index of imaging lens 7 | n7 | 1.524 |
| Sub scanning aperture opening diameter | Z direction | 2.84 |
| (rectangular shape) (mm) | | |
| Main scanning aperture opening diameter | Y direction | 3.75 |
| (rectangular shape) (mm) | | |
| Coordinate of polygon mirror rotation axis | X direction | −6.03 |
| (mm) where axial deflection point of the imaging | Y direction | −3.79 |
| optical system SA is defined as (0, 0, 0) | | |
| Fθ coefficient (mm/rad) | k | 207 |
| Coordinate circumcircle diameter (mm) of | Rp | 20 |
| polygon mirror rotation axis | | |
| Number of polygon mirror surfaces | MEN | 4 |
| Maximum scanning angle of view (deg) | θmax | ±45.12 |
| Image height on scanned surface (mm) | W | ±163 |

Optical layout

| | | Incident optical system LD, imaging optical system SD | | | | | |
|---|---|---|---|---|---|---|---|
| | | | | | Direction of optical axis | | |
| | | Surface coordinates | | | (expressed by direction cosine) | | |
| | | X | Y | Z | X | Y | Z |
| | | coordinate | coordinate | coordinate | component | component | component |
| Light source | | 33.582 | 157.991 | 7.617 | 0.208 | 0.977 | 0.047 |
| Anamorphic | Incident | 26.606 | 125.171 | 6.035 | 0.208 | 0.977 | 0.047 |
| lens | surface | | | | | | |
| | Exit | 25.983 | 122.240 | 5.893 | 0.208 | 0.977 | 0.047 |
| | surface | | | | | | |
| Sub scanning aperture stop | | 22.837 | 107.438 | 5.180 | 0.208 | 0.978 | 0.000 |
| Main scanning aperture | | 16.633 | 78.253 | 3.773 | 0.208 | 0.978 | 0.000 |
| stop | | | | | | | |
| Polygon | Deflection | 0.000 | 0.000 | 0.000 | — | — | — |
| mirror | surface | | | | | | |
| Imaging lens | Incident | 26.000 | 0.000 | 0.000 | 1.000 | 0.000 | 0.000 |
| 6 | surface | | | | | | |
| | Exit | 34.200 | 0.000 | 0.000 | 1.000 | 0.000 | 0.000 |
| | surface | | | | | | |
| Imaging lens | Incident | 103.500 | 0.000 | −5.030 | 1.000 | 0.000 | 0.000 |
| 7 | surface | | | | | | |
| | Exit | 107.800 | 0.000 | −5.030 | 1.000 | 0.000 | 0.000 |
| | surface | | | | | | |
| Mirror M1 | Reflective | 124.127 | 0.000 | −4.860 | 0.652 | 0.000 | 0.759 |
| | surface | | | | | | |

| | | | | | | |
|---|---|---|---|---|---|---|
| Scanned surface | 139.245 | 0.000 | −112.686 | −0.151 | 0.000 | 0.989 |

Optical layout

| | | Incident optical system LD, imaging optical system SD | | | | | |
|---|---|---|---|---|---|---|---|
| | | | | | Direction of optical axis | | |
| | | Surface coordinates | | | (expressed by direction cosine) | | |
| | | X | Y | Z | X | Y | Z |
| | | coordinate | coordinate | coordinate | component | component | component |
| Light source | | −45.642 | 157.991 | −7.617 | −0.208 | 0.977 | −0.047 |
| Anamorphic | Incident | −38.666 | 125.171 | −6.035 | −0.208 | 0.977 | −0.047 |
| lens | surface | | | | | | |
| | Exit | −38.043 | 122.240 | −5.893 | −0.208 | 0.977 | −0.047 |
| | surface | | | | | | |
| Sub scanning aperture stop | | −34.897 | 107.438 | −5.180 | −0.208 | 0.978 | 0.000 |
| Main scanning aperture | | −28.693 | 78.253 | −3.773 | −0.208 | 0.978 | 0.000 |
| stop | | | | | | | |
| Polygon | Deflection | 0.000 | 0.000 | 0.000 | — | — | — |
| mirror | surface | | | | | | |
| Imaging lens | Incident | −38.060 | 0.000 | 0.000 | −1.000 | 0.000 | 0.000 |
| 6 | surface | | | | | | |
| | Exit | −46.260 | 0.000 | 0.000 | −1.000 | 0.000 | 0.000 |
| | surface | | | | | | |
| Imaging lens | Incident | −115.560 | 0.000 | 5.030 | −1.000 | 0.000 | 0.000 |
| 7 | surface | | | | | | |
| | Exit | −119.860 | 0.000 | 5.030 | −1.000 | 0.000 | 0.000 |
| | surface | | | | | | |
| Mirror M1 | Reflective | −126.252 | 5.000 | 4.980 | −0.759 | 0.000 | 0.652 |
| | surface | | | | | | |

| | | | | | | |
|---|---|---|---|---|---|---|
| Scanned surface | −109.755 | 0.000 | −112.686 | −0.151 | 0.000 | 0.989 |

TABLE 2
Aspherical coefficients

| | | Anamorphic lens | | Imaging lens 6 | | Imaging lens 7 | |
|---|---|---|---|---|---|---|---|
| | | Incident | Exit | Incident | Exit | Incident | Exit |
| | | surface | surface | surface | surface | surface | surface |
| Generatrix | R | ∞ | 3.7169E+01 | −7.1101E+01 | −4.2946E+01 | −4.0000E+03 | 3.5012E+02 |
| | K | — | — | 9.4635E−01 | −5.1550E−01 | 0.0000E+00 | −8.7532E+01 |
| | B1 | — | — | 0.0000E+00 | 0.0000E+00 | 0.0000E+00 | 0.0000E+00 |
| | B2 | — | — | 0.0000E+00 | 0.0000E+00 | 0.0000E+00 | 0.0000E+00 |
| | B3 | — | — | 0.0000E+00 | 0.0000E+00 | 0.0000E+00 | 0.0000E+00 |
| | B4 | — | — | −9.1474E−07 | −3.4771E−07 | 0.0000E+00 | −2.0201E−07 |
| | B5 | — | — | 0.0000E+00 | 0.0000E+00 | 0.0000E+00 | 0.0000E+00 |
| | B6 | — | — | 6.7844E−09 | 1.6900E−09 | 0.0000E+00 | 1.6092E−11 |
| | B7 | — | — | 0.0000E+00 | 0.0000E+00 | 0.0000E+00 | 0.0000E+00 |
| | B8 | — | — | −5.7671E−12 | 1.1098E−12 | 0.0000E+00 | −9.3134E−16 |
| | B9 | — | — | 0.0000E+00 | 0.0000E+00 | 0.0000E+00 | 0.0000E+00 |
| | B10 | — | — | 1.6383E−15 | −1.2240E−15 | 0.0000E+00 | 2.5240E−20 |
| Sagittal R | r | ∞ | 2.6170E+01 | 2.0000E+01 | 2.5004E+01 | 3.7079E+01 | −1.5401E+02 |
| | E1 | — | — | 0.0000E+00 | 0.0000E+00 | 0.0000E+00 | −1.2778E−07 |
| | E2 | — | — | 0.0000E+00 | 1.5218E−05 | −7.4583E−07 | 1.8131E−06 |
| | E3 | — | — | 0.0000E+00 | 0.0000E+00 | 0.0000E+00 | −3.2397E−09 |
| | E4 | — | — | 0.0000E+00 | 8.4864E−10 | 0.0000E+00 | −3.0410E−10 |
| | E5 | — | — | 0.0000E+00 | 0.0000E+00 | 0.0000E+00 | 1.3388E−12 |
| | E6 | — | — | 0.0000E+00 | −2.5078E−11 | 0.0000E+00 | 3.0818E−14 |
| | E7 | — | — | 0.0000E+00 | 0.0000E+00 | 0.0000E+00 | −2.0088E−16 |
| | E8 | — | — | 0.0000E+00 | 7.6068E−15 | 0.0000E+00 | −1.9542E−18 |
| | E9 | — | — | 0.0000E+00 | 0.0000E+00 | 0.0000E+00 | 9.8586E−21 |
| | E10 | — | — | 0.0000E+00 | 1.6097E−17 | 0.0000E+00 | 5.8119E−23 |
| Sagittal | M(0, 1) | — | — | 0.0000E+00 | −2.1236E−02 | −1.0066E−01 | 2.3151E−02 |
| non-arc | M(1, 1) | — | — | 0.0000E+00 | 0.0000E+00 | −2.1291E−04 | −2.0022E−04 |
| | M(2, 1) | — | — | 0.0000E+00 | 3.3214E−05 | −1.3143E−05 | −2.3696E−05 |
| | M(3, 1) | — | — | 0.0000E+00 | 0.0000E+00 | 1.1605E−07 | 1.0558E−07 |
| | M(4, 1) | — | — | 0.0000E+00 | 0.0000E+00 | 1.7651E−09 | 3.6747E−09 |
| | M(5, 1) | — | — | 0.0000E+00 | 0.0000E+00 | −1.6159E−11 | −1.4094E−11 |
| | M(6, 1) | — | — | 0.0000E+00 | 0.0000E+00 | 3.0137E−13 | −3.0524E−13 |
| | M(7, 1) | — | — | 0.0000E+00 | 0.0000E+00 | 1.0611E−15 | 9.7328E−16 |
| | M(8, 1) | — | — | 0.0000E+00 | 0.0000E+00 | −1.3056E−17 | 6.5743E−17 |
| | M(9, 1) | — | — | 0.0000E+00 | 0.0000E+00 | −1.6570E−20 | −1.7277E−20 |
| | M(10, 1) | — | — | 0.0000E+00 | 0.0000E+00 | −8.5362E−22 | −3.9596E−21 |
| Diffractive | C(2, 2) | −7.8466E−03 | — | — | — | — | — |
| surface | C(0, 2) | −8.6690E−03 | — | — | — | — | — |

TABLE 3
Specification values

| | | |
|---|---|---|
| Laser wavelength (nm) | λ | 790 |
| Main scanning direction incident angle (deg) from incident optical | αm | 78 |
| system to deflector | | |
| Sub scanning direction incident angle (deg) from incident optical | αs | 2.7 |
| system to deflector | | |
| Refractive index of anamorphic lens | n2 | 1.524 |
| Refractive index of imaging lens 6 | n6 | 1.524 |
| Refractive index of imaging lens 7 | n7 | 1.524 |
| Sub scanning aperture opening diameter (rectangular shape) (mm) | Z direction | 2.84 |
| Main scanning aperture opening diameter (rectangular shape) (mm) | Y direction | 3.75 |
| Coordinate of polygon mirror rotation axis (mm) where axial deflection | X direction | −6.03 |
| point of the imaging optical system SA is defined as (0, 0, 0) | Y direction | −3.79 |
| Fθ coefficient (mm/rad) | k | 207 |
| Coordinate circumcircle diameter (mm) of polygon mirror rotation | Rp | 20 |
| axis | | |
| Number of polygon mirror surfaces | MEN | 4 |
| Maximum scanning angle of view (deg) | θmax | ±45.12 |
| Image height on scanned surface (mm) | W | ±163 |

Optical layout

| | | Incident optical system LB, imaging optical system SB | | | | | |
|---|---|---|---|---|---|---|---|
| | | | | | Direction of optical axis | | |
| | | Surface coordinates | | | (expressed by direction cosine) | | |
| | | X | Y | Z | X | Y | Z |
| | | coordinate | coordinate | coordinate | component | component | component |
| Light source | | 33.582 | 157.991 | −7.617 | 0.208 | 0.977 | −0.047 |
| Anamorphic | Incident | 26.606 | 125.171 | −6.035 | 0.208 | 0.977 | −0.047 |
| lens | surface | | | | | | |
| | Exit | 25.983 | 122.240 | −5.893 | 0.208 | 0.977 | −0.047 |
| | surface | | | | | | |
| Sub scanning aperture stop | | 22.837 | 107.438 | −5.180 | 0.208 | 0.978 | 0.000 |
| Main scanning aperture stop | | 16.633 | 78.253 | −3.773 | 0.208 | 0.978 | 0.000 |
| Polygon | Deflection | 0.000 | 0.000 | 0.000 | — | — | — |
| mirror | surface | | | | | | |
| Imaging lens | Incident | 26.000 | 0.000 | 0.000 | 1.000 | 0.000 | 0.000 |
| 6 | surface | | | | | | |
| | Exit | 34.200 | 0.000 | 0.000 | 1.000 | 0.000 | 0.000 |
| | surface | | | | | | |
| Mirror M2 | Reflective | 88.828 | 0.000 | 5.632 | 0.958 | 0.000 | 0.287 |
| | surface | | | | | | |
| Imaging lens | Incident | 60.258 | 0.000 | −11.298 | 0.835 | 0.000 | 0.550 |
| 7 | surface | | | | | | |
| | Exit | 56.667 | 0.000 | −13.663 | 0.835 | 0.000 | 0.550 |
| | surface | | | | | | |
| Mirror M3 | Reflective | 43.728 | −3.500 | −22.446 | 0.917 | 0.000 | −0.399 |
| | surface | | | | | | |

| | | | | | | |
|---|---|---|---|---|---|---|
| Scanned surface | 56.245 | 0.000 | −112.686 | 0.167 | 0.000 | −0.986 |

Optical layout

| | | Incident optical system LC, imaging optical system SC | | | | | |
|---|---|---|---|---|---|---|---|
| | | | | | Direction of optical axis | | |
| | | Surface coordinates | | | (expressed by direction cosine) | | |
| | | X | Y | Z | X | Y | Z |
| | | coordinate | coordinate | coordinate | component | component | component |
| Light source | | −45.642 | 157.991 | 7.617 | −0.208 | 0.977 | 0.047 |
| Anamorphic | Incident | −38.666 | 125.171 | 6.035 | −0.208 | 0.977 | 0.047 |
| lens | surface | | | | | | |
| | Exit | −38.043 | 122.240 | 5.893 | −0.208 | 0.977 | 0.047 |
| | surface | | | | | | |
| Sub scanning aperture stop | | −34.897 | 107.438 | 5.180 | −0.208 | 0.978 | 0.000 |
| Main scanning aperture stop | | −28.693 | 78.253 | 3.773 | −0.208 | 0.978 | 0.000 |
| Polygon | Deflection | 0.000 | 0.000 | 0.000 | — | — | — |
| mirror | surface | | | | | | |
| Imaging lens | Incident | −38.060 | 0.000 | 0.000 | −1.000 | 0.000 | 0.000 |
| 6 | surface | | | | | | |
| | Exit | −46.260 | 0.000 | 0.000 | −1.000 | 0.000 | 0.000 |
| | surface | | | | | | |
| Mirror M2 | Reflective | −95.312 | 0.000 | −5.275 | −0.991 | 0.000 | 0.132 |
| | surface | | | | | | |
| Imaging lens | Incident | −58.426 | 0.000 | −17.300 | −0.965 | 0.000 | 0.262 |
| 7 | surface | | | | | | |
| | Exit | −54.276 | 0.000 | −18.427 | −0.965 | 0.000 | 0.262 |
| | surface | | | | | | |
| Mirror M3 | Reflective | −39.614 | −3.500 | −21.926 | −0.741 | 0.000 | −0.672 |
| | surface | | | | | | |

| | | | | | | |
|---|---|---|---|---|---|---|
| Scanned surface | −26.755 | 0.000 | −112.686 | 0.167 | 0.000 | −0.986 |

TABLE 4
Aspherical coefficients

| | | Anamorphic lens | | Imaging lens 6 | | Imaging lens 7 | |
|---|---|---|---|---|---|---|---|
| | | Incident | Exit | Incident | Incident | Exit | Incident |
| | | surface | surface | surface | surface | surface | surface |
| Generatrix | R | ∞ | 3.7169E+01 | −7.1101E+01 | −4.3800E+01 | −4.0000E+03 | −3.7997E+02 |
| | K | — | — | 9.4635E−01 | 9.3213E−01 | 0.0000E+00 | −7.4124E+01 |
| | B1 | — | — | 0.0000E+00 | 0.0000E+00 | 0.0000E+00 | 0.0000E+00 |
| | B2 | — | — | 0.0000E+00 | 0.0000E+00 | 0.0000E+00 | 0.0000E+00 |
| | B3 | — | — | 0.0000E+00 | 0.0000E−00 | 0.0000E+00 | 0.0000E+00 |
| | B4 | — | — | −9.1474E−07 | −1.3549E−06 | 0.0000E+00 | 1.3315E−07 |
| | B5 | — | — | 0.0000E+00 | 0.0000E+00 | 0.0000E+00 | 0.0000E+00 |
| | B6 | — | — | 6.7844E−09 | 1.7187E−09 | 0.0000E+00 | −7.2059E−12 |
| | B7 | — | — | 0.0000E+00 | 0.0000E+00 | 0.0000E+00 | 0.0000E+00 |
| | B8 | — | — | −5.7671E−12 | 8.7615E−13 | 0.0000E+00 | 3.0701E−16 |
| | B9 | — | — | 0.0000E+00 | 0.0000E+00 | 0.0000E+00 | 0.0000E+00 |
| | B10 | — | — | 1.6383E−15 | −1.0692E−15 | 0.0000E+00 | −6.0892E−21 |
| Sagittal R | r | ∞ | 2.6170E+01 | 2.0000E+01 | 5.5261E+01 | −3.7426E+01 | 2.4999E+02 |
| | E1 | — | — | 0.0000E+00 | 0.0000E+00 | 0.0000E+00 | −9.4098E−09 |
| | E2 | — | — | 0.0000E+00 | 6.8936E−06 | 3.4815E−07 | −1.4464E−06 |
| | E3 | — | — | 0.0000E+00 | 0.0000E+00 | 0.0000E+00 | 1.6158E−09 |
| | E4 | — | — | 0.0000E+00 | 8.4247E−08 | 0.0000E+00 | 2.7926E−10 |
| | E5 | — | — | 0.0000E+00 | 0.0000E+00 | 0.0000E+00 | −4.7207E−13 |
| | E6 | — | — | 0.0000E+00 | −2.6794E−10 | 0.0000E+00 | −4.4548E−14 |
| | E7 | — | — | 0.0000E+00 | 0.0000E+00 | 0.0000E+00 | 5.3540E−17 |
| | E8 | — | — | 0.0000E+00 | 3.4364E−13 | 0.0000E+00 | 3.9357E−18 |
| | E9 | — | — | 0.0000E+00 | 0.0000E+00 | 0.0000E+00 | −2.0275E−21 |
| | E10 | — | — | 0.0000E+00 | −1.5385E−16 | 0.0000E+00 | −1.3630E−22 |
| Sagittal | M(0, 1) | — | — | 0.0000E+00 | 7.6609E−02 | −1.2108E−01 | 5.8011E−02 |
| non-arc. | M(1, 1) | — | — | 0.0000E+00 | 0.0000E+00 | −2.1291E−04 | −2.0022E−04 |
| | M(2, 1) | — | — | 0.0000E+00 | −3.9065E−05 | −1.1106E−05 | −2.2919E−05 |
| | M(3, 1) | — | — | 0.0000E+00 | 0.0000E+00 | 1.4189E−07 | 1.2876E−07 |
| | M(4, 1) | — | — | 0.0000E+00 | 0.0000E+00 | 5.5567E−10 | 2.6270E−09 |
| | M(5, 1) | — | — | 0.0000E+00 | 0.0000E+00 | −2.5886E−11 | −2.1739E−11 |
| | M(6, 1) | — | — | 0.0000E+00 | 0.0000E+00 | 2.4589E−13 | −2.0667E−13 |
| | M(7, 1) | — | — | 0.0000E+00 | 0.0000E+00 | 2.1501E−15 | 1.6753E−15 |
| | M(8, 1) | — | — | 0.0000E+00 | 0.0000E+00 | −1.1817E−17 | 3.2093E−17 |
| | M(9, 1) | — | — | 0.0000E+00 | 0.0000E+00 | −6.1299E−20 | −4.1993E−20 |
| | M(10, 1) | — | — | 0.0000E+00 | 0.0000E+00 | −9.7167E−23 | −1.4874E−21 |
| Diffractive | C(2, 2) | −7.8466E−03 | — | — | — | — | — |
| surface | C(0, 2) | −8.6690E−03 | — | — | — | — | — |

The incident surfaces of the anamorphic lenses 2A, 2B, 2C, and 2D according to the present practical example are rotationally asymmetric diffractive surfaces, with the phase function @ of the diffraction grating expressed by the following equation:

$$Φ = \frac{2 π}{k λ} + {\sum }_{i , j} {C}_{i , j} {Y}^{i} {Z}^{j}$$

k is the order of diffraction, and k=1 here. λ is the wavelength, and λ=790 nm here.

The generatrix shapes of the lens surfaces of the lenses 6A, 6B, 6C, and 6D and the lenses 7A, 7B, 7C, and 7D according to the present practical example (shapes of the lens surfaces in the main scanning section) are aspherical shapes that are expressed by an up to 10th-order function to be described below. With the intersection of each lens surface (optical surface) and the optical axis as the point of origin, the axis in the optical axis direction as an X-axis, and the axis orthogonal to the X-axis within the main scanning section as a Y-axis, the generatrix shape X are expressed by the following equation:

$$x = \frac{{Y}^{2} / R}{1 + \sqrt{1 - ( 1 + K ) {( Y / R )}^{2}}} + {\sum }_{i} {B}_{i} {Y}^{i}$$

In the present exemplary embodiment, the X-axis is defined with the traveling direction of light as +X side, and the Y-axis is defined with the light source side of the optical axis as +Y side.

Here, with the intersection of each lens surface and the optical axis of the optical portion as the point of origin, the X-, Y-, and Z-axes refer to the optical axis, an axis orthogonal to the optical axis within the main scanning section, and an axis orthogonal to the optical axis within the sub scanning section, respectively. R is the radius of curvature of the generatrix, K is the eccentricity, and Bᵢ (i=1, 2, . . . , 10) are aspherical coefficients.

The sagittal shapes of the lens surfaces of the lenses 6A, 6B, 6C, and 6D and the lenses 7A, 7B, 7C, and 7D according to the present practical example (the shapes of the lens surfaces within a sub scanning section at a given image height) are aspherical shapes expressed by the following equation:

$$S = \frac{{Z}^{2} / {r}^{′}}{1 + \sqrt{1 - {( Z / {r}^{′} )}^{2}}} + {\sum }_{i . j} {m}_{i , j} {Y}^{i} {Z}^{j}$$

Here, S is the sagittal shape defined in a plane that is perpendicular to the main scanning section and includes the normal to the generatrix at each position along the generatrix direction. mᵢⱼ are aspherical coefficients. The term consisting of a first-order function of Z provides the tilt amount in the sagittal direction. In other words, the sagittal tilt amount according to the present practical example corresponds to m_{0,1}. A sagittal tilt surface therefore refers to a surface where m_{0,1} is not zero. The sagittal tilt surface refers to an optical surface where the normal to the generatrix tilts relative to the optical axis (is not parallel to the optical axis) in the sub scanning section including the optical axis. The generatrix here refers to the line of intersection of the optical surface and the main scanning section. Since y=0 on the optical axis, the sagittal tilt amount (the tilt of the normal to the generatrix with respect to the optical axis) in the sub scanning section including the optical axis is expressed as m_{0,1}. The sagittal tilt surface (sagittal tilt changing surface) has an aspherical coefficient m_{2,1} and changes in the sagittal tilt amount with the position Y in the main scanning direction.

The sagittal radius of curvature r′ changes continuously with the Y coordinate of the lens surface, as expressed by the following equation:

$$\frac{1}{{r}^{′}} = \frac{1}{r} + {\sum }_{i} {E}_{i} {Y}^{i}$$

Here, r is the sagittal radius of curvature on the optical axis, and Eᵢ (i=1, 2, . . . , 16) are sagittal variation coefficients.

As can be seen from Tables 2 and 4, in the optical scanning device 100 according to the present practical example, the exit surfaces of the lens 6A (6D) and the optical portion 6B (6C) have different generatrix shapes, sagittal shapes, and sagittal tilt shapes. The two optical portions 6A (6D) and 6B (6C) located above and below in the sub scanning direction of the multi-stage lens thus have different aspherical coefficients. This configures respective different optimum surface shapes to correct the optical characteristics of the imaging optical systems SA (SD) and SB (SC) even if the optical portions 7A (7D) and 7B (7C) are located at different optical positions from the deflection point C0.

As described above, the at least either the pair of incident surfaces or the pair of exit surfaces of the first and second optical portions is offset (has a step) in the optical axis direction at the interface. The incident surfaces of the lens 6A (6D) and the optical portion 6B (6C) are optically closer to the deflection point C0 than the exit surfaces. In the sub scanning section, the distance between the light beams RA (RD) and RB (RC) on the incident surfaces of the lens 6A (6D) and the optical portion 6B (6C) is narrow. If there is a step (offset in the optical axis direction) at the interface of the incident surfaces, deformation or strain of the lens surfaces near the step due to thermal deformation stress is likely to have a high impact. Moreover, vignette is more likely to occur at the step at the interface of the multi-stage lens when the light beams move up and down. In the optical scanning device 100 according to the present practical example, as can be seen from Tables 2 and 4, the incident surfaces of the lens 6A (6D) and the optical portion 6B (6C) are therefore designed to have the same shape so that there is no step at the interface of the lens surfaces of the multi-stage lens.

In the optical scanning device 100 according to the present practical example, the functions expressing the surface shapes of the optical portions are defined by the foregoing definition formulas. However, this is not restrictive, and other definition formulas may be used.

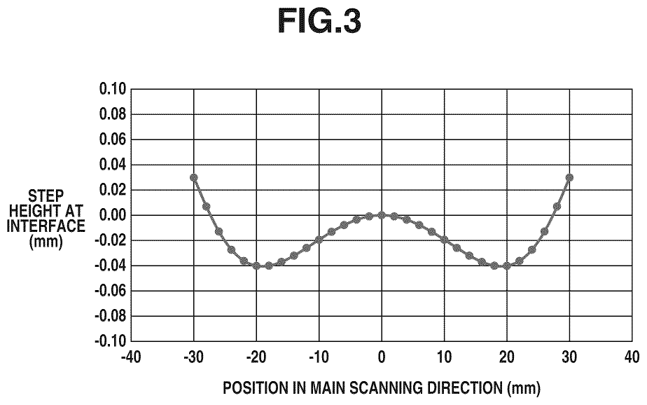

FIG. 3 illustrates the step at the interface of the exit surfaces of the multi-stage lens in the optical scanning device 100 according to the present practical example. In FIG. 3, positive values (negative values) indicate that the position of the generatrix of the optical portion 6A in the optical axis direction is farther from (closer to) the deflector 5 than is the position of the generatrix of the lens 6B in the optical axis direction.

As can be seen from FIG. 3, in the optical scanning device 100 according to the present practical example, the step height at the interface of the exit surfaces of the multi-stage lens is ±0.04 mm at the maximum, which satisfies inequalities (1), (1a), and (1b). In the present practical example, the step height is reduced by configuring the lenes 6A and 6B with the same thicknesses. The shape difference between the exit surfaces of the lenses 6A and 6B is reduced to a sufficiently low level such that the multi-stage lens is integrally molded without problems, and various imaging characteristics are satisfied.

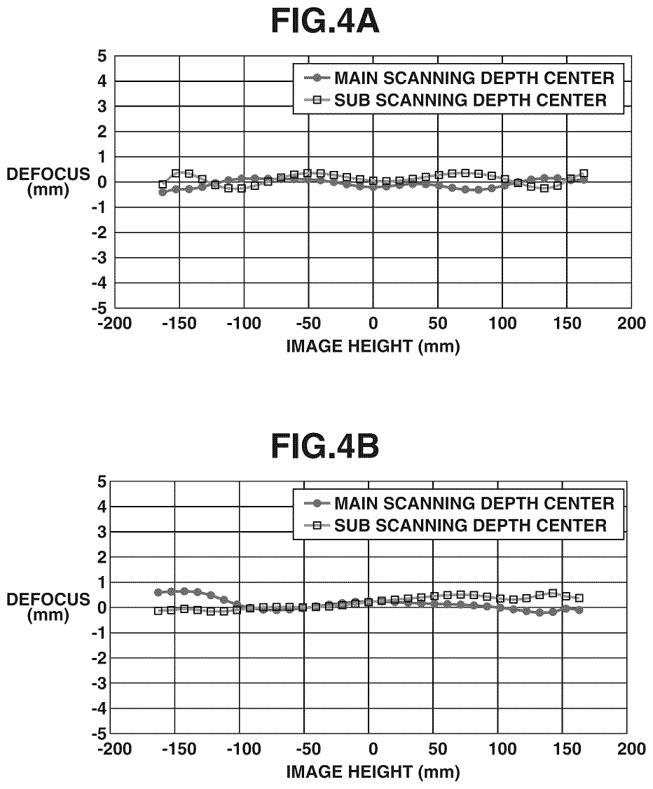

FIGS. 4A and 4B are graphs illustrating field curvatures (defocus characteristics) of the optical scanning device 100 according to the present practical example in the main scanning direction and the sub scanning direction. FIG. 4A corresponds to the light beam RA. FIG. 4B corresponds to the light beam RB. In the present practical example, the effective image width (width of the effective scanning area on the scanned surface) is W=±163 mm. As illustrated in FIGS. 4A and 4B, the field curvatures of both the imaging optical systems SA and SB in both the main and sub scanning directions are favorably corrected on the image plane.

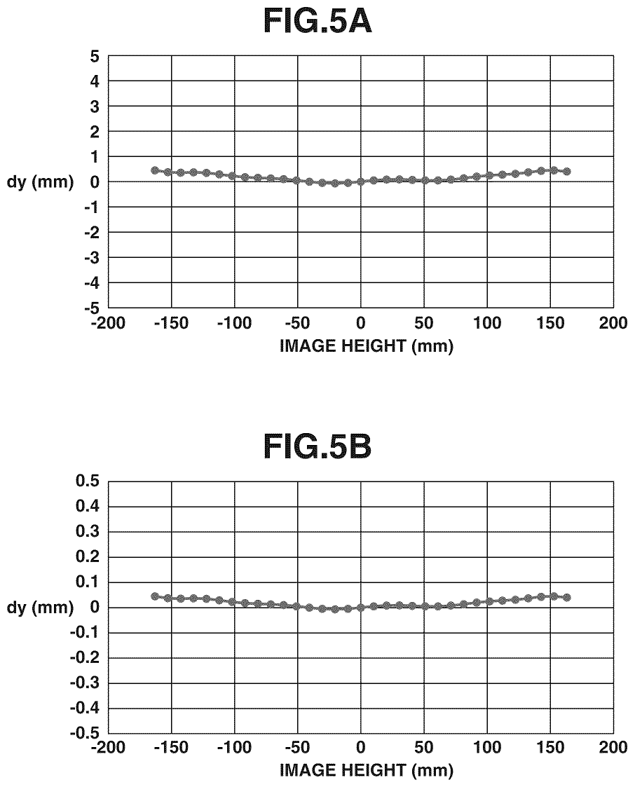

FIGS. 5A and 5B are graphs illustrating fθ characteristics dy of the optical scanning device 100 according to the present practical example. FIG. 5A corresponds to the light beam RA. FIG. 5B corresponds to the light beam RB. The fθ characteristic dy refers to a difference obtained by subtracting an ideal image height from the position where the light beam actually reaches. The fθ characteristics dy of the imaging optical systems SA and SB are favorably corrected.

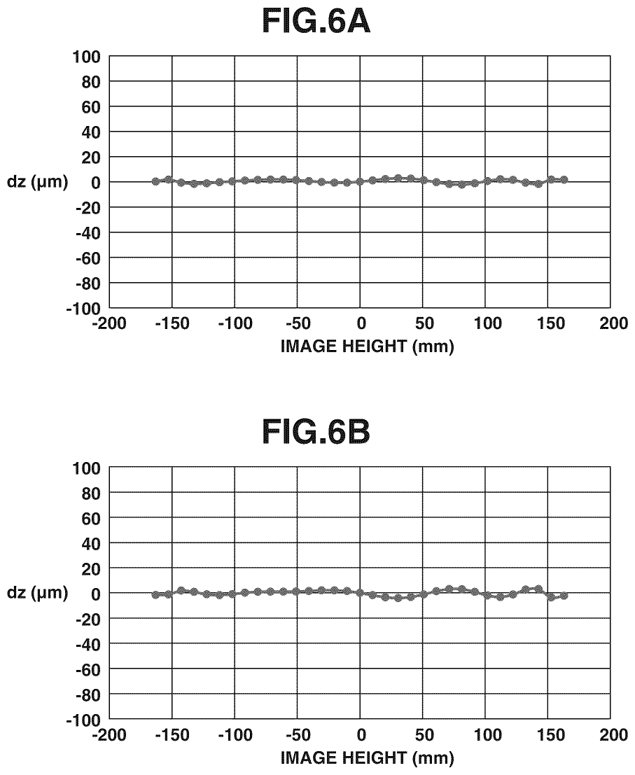

FIGS. 6A and 6B illustrate the dependence, on the position in the main scanning direction, of scanning line curvatures dz of the optical scanning device 100 according to the present practical example on the scanned surfaces 8A and 8B. As employed herein, the scanning line curvature dz refers to a difference between the imaging position in the sub scanning direction at each image height and the imaging position in the main scanning direction at the axial image height on the scanned surface. As illustrated in FIGS. 6A and 6B, the scanning line curvatures dz of both the imaging optical systems SA and SB are favorably corrected on the image plane.

As described above, in the optical scanning device 100 according to the present exemplary embodiment, the imaging optical systems SA and SD are optically equivalent, and the imaging optical systems SB and SC are optically equivalent. While a description of the imaging optical systems SC and SD is omitted, the imaging performance of the imaging optical systems SC and SD is thus similarly favorably corrected.

As described above, in the present practical example, the lenses 6A and 6B optically closest to the deflector 5 are configured as a multi-stage lens. The lens surfaces of the multi-stage lens have different surface shapes, and the lenses 7A and 7B are located at optically different positions. Such a configuration increases the degree of freedom in lens layout, and enables miniaturization. Moreover, the imaging optical systems SA and SD consist of the lenses of the same shapes, and the imaging optical systems SB and SC consist of the lenses of the same shapes. This leads to a reduction in parts types.

Such an optical scanning device 100 enables miniaturization and a reduction in the parts types of the optical elements while reducing the step heights at the interfaces of the multi-stage lenses for stable moldability and favorable imaging performance.

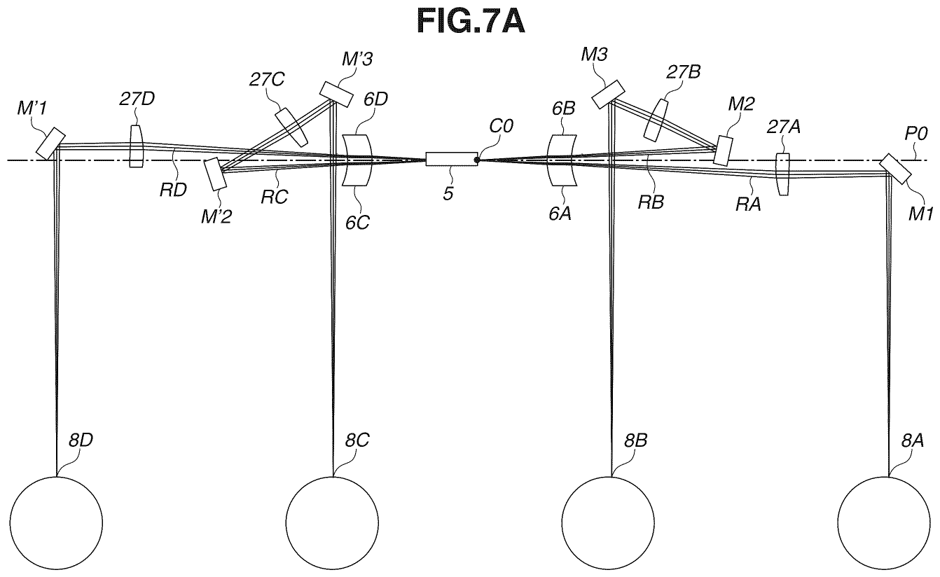

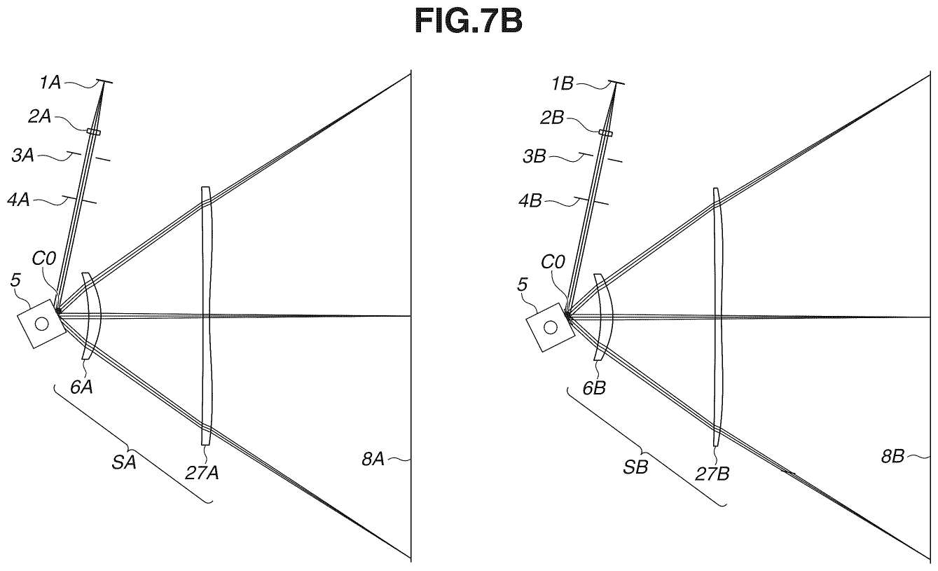

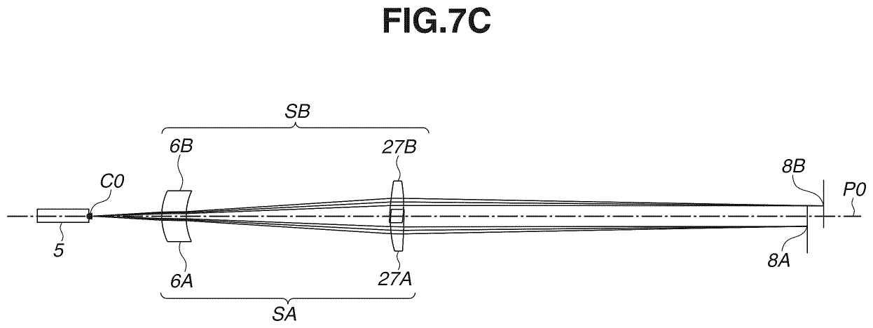

FIG. 7A is a sub scanning sectional view of essential parts of an optical scanning device 200 according to a second exemplary embodiment. FIG. 7B is an optical path diagram of essential parts of the optical scanning device 200 according to the second exemplary embodiment in main scanning sections. FIG. 7C is an optical path diagram of essential parts of the optical scanning device 200 according to the second exemplary embodiment in a sub scanning section.

The optical scanning device 200 according to the present exemplary embodiment has the same configuration as that of the optical scanning device 100 according to the first exemplary embodiment except that lenses 27A to 27D are used instead of the lenses 7A to 7D. Similar members will be described with the same reference numerals.

The imaging optical systems SA and SB according to the present exemplary embodiment consist of a plurality of lenses each. In the imaging optical system SA (SB), the lens optically closest to the deflector will be referred to as a lens 6A (6B), and the lens optically closest to the scanned surface as a lens 27A (27B).

The lenses 6A and 6B according to the present exemplary embodiment are arranged in the sub scanning direction to constitute a multi-stage lens where their incident surfaces and exit surfaces are integrally formed. In the multi-stage lens according to the present exemplary embodiment, at least either the incident surfaces or the exit surfaces of the lenses 6A and 6B have lens surface shapes asymmetric in the sub scanning direction with respect to the reference plane P0. The upper and lower portions of the multi-stage lens with respect to the reference plane P0 have different shapes in both the main scanning section (generatrix shape) and the sub scanning section (sagittal shape). By configuring at least either the incident surfaces or the exit surfaces of the lenses 6A and 6B to have different lens surface shapes, the optical path lengths of the imaging optical systems SA and SB are made different while maintaining the optical performance of the imaging optical systems SA and SB favorable. This leads to an increase in the degree of freedom in layout.

In the optical scanning device 200 according to the present exemplary embodiment, the imaging optical system SA has an optical path length smaller than that of the imaging optical path length SB. This enables a reduction in the size of the optical scanning device 200 in a drum arrangement direction compared to the case where the imaging optical systems SA and SB have the same optical path length.

In the optical scanning device 200 according to the present exemplary embodiment, like the first exemplary embodiment, the lenses 6A and 6B integrally form a multi-stage lens so that the optical axes of the lenses 6A and 6B are located at the same position, i.e., the optical axes of the lenses 6A and 6B are not off-centered from each other in the sub scanning direction. Consequently, even if the lens surfaces of the multi-stage lens have respective different shapes, the step height at the interface of the lens surfaces results only from the shape difference between the generatrix shapes, and the step height is not affected by the difference between the sagittal shapes. This leads to a reduction in the step height at the interface of the multi-stage lens, whereby the molding stability of the lenses 6A and 6B is favorably improved.

The multi-stage lens of the optical scanning device 200 according to the present exemplary embodiment also satisfies inequality (1). The multi-stage lens desirably satisfies inequality (1a), more desirably inequality (1b).

The imaging optical systems SC and SD according to the present exemplary embodiment have a configuration and optical operation similar to those of the imaging optical systems SA and SB. The lenses 6C and 6D are arranged in the sub scanning direction to constitute a multi-stage lens where their incident surfaces and exit surfaces are integrally formed. This reduces the number of lens parts. The lenses 6C and 6D have different lens surfaces shapes, and the imaging optical system SD has an optical path length smaller than that of the imaging optical system SC. This enables a reduction in the size of the optical scanning device 200 in the drum arrangement direction.

Now, the incident angle of the principal ray of a light beam on the deflection surface (angle formed between the main scanning section and the principal ray) in the sub scanning section will be referred to as a sub scanning oblique incident angle. The optical scanning device 200 according to the present exemplary embodiment is configured so that, in the sub scanning section, the sub scanning oblique incident angle corresponding to the imaging optical system SA (SB) and the sub scanning oblique incident angle corresponding to the imaging optical system SD (SC) are 180° rotationally symmetrical about an axis that passes through the intersection of the rotation axis of the deflector 5 and the optical axes of the imaging optical systems and is parallel to the main scanning direction. The lenses 6A and 27A and the lenses 6D and 27D thus have the same lens surface shapes, even if the sagittal shapes are asymmetric about the optical axes like a sagittal tilt shape, which is used to correct both scanning line curvature and twisted wavefront aberration in a compatible manner in conventional sub scanning oblique incidence optical systems. Similarly, the lenses 6B and 27B and the lenses 6C and 27C have the same lens surface shapes. As a result, the multi-stage lens integrating the lenses 6A and 6B and the multi-stage lens integrating the lenses 6C and 6D are configured as common optical parts. Moreover, the lenses 27A and 27D and the lenses 27B and 27C are configured as respective optical parts of the same shapes. This leads to a reduction in the types of optical parts.

In the optical scanning device 200 according to the present exemplary embodiment, the imaging optical systems SA and SD are optically equivalent, and the imaging optical systems SB and SC are optically equivalent. Such optically equivalent configurations minimize color misregistration when the optical scanning device 200 is used in an image forming apparatus. Moreover, since the fθ characteristics are made the same, a common image clock is used to reduce the cost of the circuit substrate.

The optical scanning device 200 according to the present exemplary embodiment thus achieves favorable imaging characteristics in a manner compatible with miniaturization and a reduction in the parts types.

### (Second Practical Example)

An optical scanning device 200 according to a second practical example will now be described. A description of configurations of the optical scanning device 200 according to the present practical example that are similar to those of the optical scanning device 100 according to the foregoing exemplary embodiment and the optical scanning device 200 according to the present exemplary embodiment will be omitted.

Tables 5, 6, 7, and 8 below illustrate the specifications, optical layout, and lens surface shapes of the optical scanning device 200 related to the present practical example. Table 5 describes the specifications and lens layout of the incident optical system LA and the imaging optical system SA. Table 6 describes the lens surface shapes of the incident optical system LA and the imaging optical system SA. Table 7 describes the specifications and lens layout of the incident optical system LB and the imaging optical system SB. Table 8 describes the lens surface shapes of the incident optical system LB and the imaging optical system SB.

Tables 5 and 7 also illustrate the lens layout of the incident optical system LC and the imaging optical system SC and the lens layout of the incident optical system LD and the imaging optical system SD. The specifications and lens surface shapes of the incident optical system LC and the imaging optical system SC and the specifications and lens surface shapes of the incident optical system LD and the imaging optical system SD are equivalent to those of the input optical system LB and the imaging optical system SB and those of the input optical system LA and the imaging optical system SA, respectively. A description thereof will thus be omitted. The optical layout sections of Tables 5 and 7 describe the coordinates of the reflection points, on the respective mirrors, of the light beams RA and RB traveling toward the image centers (axial image heights) in the main scanning direction on the scanned surfaces.

TABLE 5
Specification values

| | | |
|---|---|---|
| Laser wavelength (nm) | λ | 790 |
| Main scanning direction incident angle (deg) from incident optical system | αm | 78 |
| to deflector | | |
| Sub scanning direction incident angle (deg) from incident optical system to | αs | 2.7 |
| deflector | | |
| Refractive index of anamorphic lens | n2 | 1.524 |
| Refractive index of imaging lens 6 | n6 | 1.524 |
| Refractive index of imaging lens 7 | n7 | 1.524 |
| Sub scanning aperture opening diameter (rectangular shape) (mm) | Z direction | 2.84 |
| Main scanning aperture opening diameter (rectangular shape) (mm) | Y direction | 2.70 |
| Coordinate of polygon mirror rotation axis (mm) where axial deflection | X direction | −6.03 |
| point of the imaging optical system SA is defined as (0, 0, 0) | Y direction | −3.79 |
| Fθ coefficient (mm/rad) | k | 220 |
| Coordinate circumcircle diameter (mm) of polygon mirror rotation axis | Rp | 20 |
| Number of polygon mirror surfaces | MEN | 4 |
| Maximum scanning angle of view (deg) | θmax | ±42.45 |
| Image height on scanned surface (mm) | W | ±163 |

Optical layout

| | | Incident optical system LA, imaging optical system SA | | | | | |
|---|---|---|---|---|---|---|---|
| | | | | | Direction of optical axis | | |
| | | Surface coordinates | | | (expressed by direction cosine) | | |
| | | X | Y | Z | X | Y | Z |
| | | coordinate | coordinate | coordinate | component | component | component |
| Light source | | 33.582 | 157.991 | 7.617 | 0.208 | 0.977 | 0.047 |
| Anamorphic | Incident | 26.606 | 125.171 | 6.035 | 0.208 | 0.977 | 0.047 |
| lens | surface | | | | | | |
| | Exit surface | 25.983 | 122.240 | 5.893 | 0.208 | 0.977 | 0.047 |
| Sub scanning aperture stop | | 22.837 | 107.438 | 5.180 | 0.208 | 0.978 | 0.000 |
| Main scanning aperture stop | | 16.633 | 78.253 | 3.773 | 0.208 | 0.978 | 0.000 |
| Polygon | Deflection | 0.000 | 0.000 | 0.000 | — | — | — |
| mirror | surface | | | | | | |
| Imaging lens | Incident | 23.000 | 0.000 | 0.000 | 1.000 | 0.000 | 0.000 |
| 6 | surface | | | | | | |
| | Exit | 31.200 | 0.000 | 0.000 | 1.000 | 0.000 | 0.000 |
| | surface | | | | | | |
| Imaging lens | Incident | 100.000 | 0.000 | −4.660 | 1.000 | 0.000 | 0.000 |
| 7 | surface | | | | | | |
| | Exit | 104.300 | 0.000 | −4.660 | 1.000 | 0.000 | 0.000 |
| | surface | | | | | | |
| Mirror M1 | Reflective | 137.918 | 0.000 | −4.405 | 0.704 | 0.000 | 0.711 |
| | surface | | | | | | |

| | | | | | | |
|---|---|---|---|---|---|---|
| Scanned surface | 137.920 | 0.000 | −106.491 | −0.010 | 0.000 | 1.000 |

Optical layout

| | | Incident optical system LD, imaging optical system SD | | | | | |
|---|---|---|---|---|---|---|---|
| | | | | | Direction of optical axis | | |
| | | Surface coordinates | | | (expressed by direction cosine) | | |
| | | X | Y | Z | X | Y | Z |
| | | coordinate | coordinate | coordinate | component | component | component |
| Light source | | −45.642 | 157.991 | −7.617 | −0.208 | 0.977 | −0.047 |
| Anamorphic | Incident | −38.666 | 125.171 | −6.035 | −0.208 | 0.977 | −0.047 |
| lens | surface | | | | | | |
| | Exit | −38.043 | 122.240 | −5.893 | −0.208 | 0.977 | −0.047 |
| | surface | | | | | | |
| Sub scanning aperture stop | | −34.897 | 107.438 | −5.180 | −0.208 | 0.978 | 0.000 |
| Main scanning aperture stop | | −28.693 | 78.253 | −3.773 | −0.208 | 0.978 | 0.000 |
| Polygon | Deflection | 0.000 | 0.000 | 0.000 | — | — | — |
| mirror | surface | | | | | | |
| Imaging lens | Incident | −35.060 | 0.000 | 0.000 | −1.000 | 0.000 | 0.000 |
| 6 | surface | | | | | | |
| | Exit | −43.260 | 0.000 | 0.000 | −1.000 | 0.000 | 0.000 |
| | surface | | | | | | |
| Imaging lens | Incident | −112.060 | 0.000 | 4.660 | −1.000 | 0.000 | 0.000 |
| 7 | surface | | | | | | |
| | Exit | −116.360 | 0.000 | 4.660 | −1.000 | 0.000 | 0.000 |
| | surface | | | | | | |
| Mirror M1 | Reflective | −141.082 | 5.000 | 4.492 | −0.711 | 0.000 | 0.704 |
| | surface | | | | | | |

| | | | | | | |
|---|---|---|---|---|---|---|
| Scanned surface | −141.080 | 0.000 | −106.491 | −0.010 | 0.000 | 1.000 |

TABLE 6
Aspherical coefficients

| | | Anamorphic lens | | Imaging lens 6 | | Imaging lens 7 | |
|---|---|---|---|---|---|---|---|
| | | Incident | Exit | Incident | Exit | Incident | Exit |
| | | surface | surface | surface | surface | surface | surface |
| Generatrix | R | ∞ | 3.7169E+01 | −8.4523E+01 | −4.7891E+01 | 4.0000E+03 | 3.2798E+02 |
| | K | — | — | 2.2722E+00 | 3.2321E−01 | 0.0000E+00 | −7.1147E+01 |
| | B1 | — | — | 0.0000E+00 | −6.2047E−06 | 0.0000E+00 | 0.0000E+00 |
| | B2 | — | — | 0.0000E+00 | 0.0000E+00 | 0.0000E+00 | 0.0000E+00 |
| | B3 | — | — | 0.0000E+00 | −2.6923E−07 | 0.0000E+00 | 0.0000E+00 |
| | B4 | — | — | −5.8012E−07 | 1.3510E−06 | 0.0000E+00 | −2.2103E−07 |
| | B5 | — | — | 0.0000E+00 | −1.6268E−10 | 0.0000E+00 | 0.0000E+00 |
| | B6 | — | — | 8.7773E−09 | 2.5285E−09 | 0.0000E+00 | 2.2099E−11 |
| | B7 | — | — | 0.0000E+00 | 0.0000E+00 | 0.0000E+00 | 0.0000E+00 |
| | B8 | — | — | −1.0970E−11 | 7.9794E−13 | 0.0000E+00 | −1.5965E−15 |
| | B9 | — | — | 0.0000E+00 | 0.0000E+00 | 0.0000E+00 | 0.0000E+00 |
| | B10 | — | — | 3.6974E−15 | −2.2697E−15 | 0.0000E+00 | 5.5286E−20 |
| Sagittal R | r | ∞ | 2.6170E+01 | 2.0000E+01 | 2.1148E+01 | 3.3319E+01 | −2.7514E+02 |
| | E1 | — | — | 0.0000E+00 | 1.4151E−05 | 0.0000E+00 | −2.2078E−06 |
| | E2 | — | — | 0.0000E+00 | 3.2906E−06 | −2.6126E−06 | 3.6834E−07 |
| | E3 | — | — | 0.0000E+00 | −2.7100E−08 | 0.0000E+00 | −1.0179E−10 |
| | E4 | — | — | 0.0000E+00 | 3.2218E−08 | 0.0000E+00 | −3.8434E−10 |
| | E5 | — | — | 0.0000E+00 | 7.5901E−11 | 0.0000E+00 | 1.1105E−13 |
| | E6 | — | — | 0.0000E+00 | −4.1732E−11 | 0.0000E+00 | 4.3136E−14 |
| | E7 | — | — | 0.0000E+00 | 0.0000E+00 | 0.0000E+00 | −2.4496E−17 |
| | E8 | — | — | 0.0000E+00 | −7.5674E−14 | 0.0000E+00 | −3.1763E−18 |
| | E9 | — | — | 0.0000E+00 | 0.0000E+00 | 0.0000E+00 | 1.7741E−21 |
| | E10 | — | — | 0.0000E+00 | 1.1903E−16 | 0.0000E+00 | 7.1180E−23 |
| Sagittal | M(0, 1) | — | — | 0.0000E+00 | −5.9952E−03 | −7.5634E−02 | 3.8012E−02 |
| non-arc | M(1, 1) | — | — | 0.0000E+00 | 0.0000E+00 | 1.8718E−04 | 1.9387E−04 |
| | M(2, 1) | — | — | 0.0000E+00 | 3.5637E−05 | −1.1242E−05 | −2.2331E−05 |
| | M(3, 1) | — | — | 0.0000E+00 | 0.0000E+00 | −1.9487E−08 | −2.6123E−08 |
| | M(4, 1) | — | — | 0.0000E+00 | 0.0000E+00 | 1.4944E−09 | 3.8894E−09 |
| | M(5, 1) | — | — | 0.0000E+00 | 0.0000E+00 | −9.2803E−12 | −3.1494E−12 |
| | M(6, 1) | — | — | 0.0000E+00 | 0.0000E+00 | 3.4104E−13 | −3.6363E−13 |
| | M(7, 1) | — | — | 0.0000E+00 | 0.0000E+00 | 1.6542E−15 | 3.8135E−16 |
| | M(8, 1) | — | — | 0.0000E+00 | 0.0000E+00 | −9.8717E−18 | 7.7378E−17 |
| | M(9, 1) | — | — | 0.0000E+00 | 0.0000E+00 | −8.5903E−20 | −4.6584E−21 |
| | M(10, 1) | — | — | 0.0000E+00 | 0.0000E+00 | −1.5255E−21 | −4.9633E−21 |
| Diffractive | C(2, 2) | −7.8466E−03 | — | — | — | — | — |
| surface | C(0, 2) | −8.6690E−03 | — | — | — | — | — |

TABLE 7
Specification values

| | | |
|---|---|---|
| Laser wavelength (nm) | λ | 790 |
| Main scanning direction incident angle (deg) from incident optical system to | αm | 78 |
| deflector | | |
| Sub scanning direction incident angle (deg) from incident optical system to | αs | 2.7 |
| deflector | | |
| Refractive index of anamorphic lens | n2 | 1.524 |
| Refractive index of imaging lens 6 | n6 | 1.524 |
| Refractive index of imaging lens 7 | n7 | 1.524 |
| Sub scanning aperture opening diameter (rectangular shape) (mm) | Z direction | 2.84 |
| Main scanning aperture opening diameter (rectangular shape) (mm) | Y direction | 3.75 |
| Coordinate of polygon mirror rotation axis (mm) where axial deflection point of | X direction | −6.03 |
| the imaging optical system SA is defined as (0, 0, 0) | Y direction | −3.79 |
| F0 coefficient (mm/rad) | k | 207 |
| Coordinate circumcircle diameter (mm) of polygon mirror rotation axis | Rp | 20 |
| Number of polygon mirror surfaces | MEN | 4 |
| Maximum scanning angle of view (deg) | θmax | ±45.12 |
| Image height on scanned surface (mm) | W | ±163 |

Optical layout

| | | Incident optical system LB, imaging optical system SB | | | | | |
|---|---|---|---|---|---|---|---|
| | | | | | Direction of optical axis | | |
| | | Surface coordinates | | | (expressed by direction cosine) | | |
| | | X | Y | Z | X | Y | Z |
| | | coordinate | coordinate | coordinate | component | component | component |
| Light source | | 33.582 | 157.991 | −7.617 | 0.208 | 0.977 | −0.047 |
| Anamorphic | Incident | 26.606 | 125.171 | −6.035 | 0.208 | 0.977 | −0.047 |
| lens | surface | | | | | | |
| | Exit | 25.983 | 122.240 | −5.893 | 0.208 | 0.977 | −0.047 |
| | surface | | | | | | |
| Sub scanning aperture stop | | 22.837 | 107.438 | −5.180 | 0.208 | 0.978 | 0.000 |
| Main scanning aperture stop | | 16.633 | 78.253 | −3.773 | 0.208 | 0.978 | 0.000 |
| Polygon | Deflection | 0.000 | 0.000 | 0.000 | — | — | — |
| mirror | surface | | | | | | |
| Imaging lens | Incident | 23.000 | 0.000 | 0.000 | 1.000 | 0.000 | 0.000 |
| 6 | surface | | | | | | |
| | Exit | 31.200 | 0.000 | 0.000 | 1.000 | 0.000 | 0.000 |
| | surface | | | | | | |
| Mirror M2 | Reflective | 79.950 | 0.000 | 3.842 | 0.979 | 0.000 | −0.204 |
| | surface | | | | | | |
| Imaging lens | Incident | 61.964 | 0.000 | 12.756 | 0.916 | 0.000 | −0.400 |
| 27 | surface | | | | | | |
| | Exit | 58.024 | 0.000 | 14.477 | 0.916 | 0.000 | −0.400 |
| | surface | | | | | | |
| Mirror M3 | Reflective | 44.925 | −3.500 | 20.000 | 0.551 | 0.000 | −0.834 |
| | surface | | | | | | |

| | | | | | | |
|---|---|---|---|---|---|---|
| Scanned surface | 44.920 | 0.000 | −106.491 | 0.009 | 0.000 | −1.000 |

Optical layout

| | | Incident optical system LC, imaging optical system SC | | | | | |
|---|---|---|---|---|---|---|---|
| | | | | | Direction of optical axis | | |
| | | Surface coordinates | | | (expressed by direction cosine) | | |
| | | X | Y | Z | X | Y | Z |
| | | coordinate | coordinate | coordinate | component | component | component |
| Light source | | −45.642 | 157.991 | 7.617 | −0.208 | 0.977 | 0.047 |
| Anamorphic | Incident | −38.666 | 125.171 | 6.035 | −0.208 | 0.977 | 0.047 |
| lens | surface | | | | | | |
| | Exit | −38.043 | 122.240 | 5.893 | −0.208 | 0.977 | 0.047 |
| | surface | | | | | | |
| Sub scanning aperture stop | | −34.897 | 107.438 | 5.180 | −0.208 | 0.978 | 0.000 |
| Main scanning aperture stop | | −28.693 | 78.253 | 3.773 | −0.208 | 0.978 | 0.000 |
| Polygon | Deflection | 0.000 | 0.000 | 0.000 | — | — | — |
| mirror | surface | | | | | | |
| Imaging lens | Incident | −35.060 | 0.000 | 0.000 | −1.000 | 0.000 | 0.000 |
| 6 | surface | | | | | | |
| | Exit | −43.260 | 0.000 | 0.000 | −1.000 | 0.000 | 0.000 |
| | surface | | | | | | |
| Mirror M2 | Reflective | −85.974 | 0.000 | −3.538 | −0.958 | 0.000 | −0.286 |
| | surface | | | | | | |
| Imaging lens | Incident | −63.459 | 0.000 | 9.698 | −0.836 | 0.000 | −0.548 |
| 27 | surface | | | | | | |
| | Exit | −59.863 | 0.000 | 12.055 | −0.836 | 0.000 | −0.548 |
| | surface | | | | | | |
| Mirror M3 | Reflective | −48.075 | −3.500 | 20.000 | −0.471 | 0.000 | −0.882 |
| | surface | | | | | | |

| | | | | | | |
|---|---|---|---|---|---|---|
| Scanned surface | −48.080 | 0.000 | −106.491 | 0.009 | 0.000 | −1.000 |

TABLE 8
Aspherical coefficients

| | | Anamorphic lens | | Imaging lens 6 | | Imaging lens 27 | |
|---|---|---|---|---|---|---|---|
| | | Incident | Exit | Incident | Exit | Incident | Exit |
| | | surface | surface | surface | surface | surface | surface |
| Generatrix | R | ∞ | 3.7169E+01 | −8.4523E+01 | −4.9247E+01 | −4.0000E+03 | −4.9649E+02 |
| | K | — | — | 2.2722E+00 | 2.1080E−01 | 0.0000E+00 | −1.6541E+02 |
| | B1 | — | — | 0.0000E+00 | −2.4962E−05 | 0.0000E+00 | 0.0000E+00 |
| | B2 | — | — | 0.0000E+00 | 0.0000E+00 | 0.0000E+00 | 0.0000E+00 |
| | B3 | — | — | 0.0000E+00 | −7.7015E−08 | 0.0000E+00 | 0.0000E+00 |
| | B4 | — | — | −5.8012E−07 | 1.0130E−06 | 0.0000E+00 | 2.1893E−07 |
| | B5 | — | — | 0.0000E+00 | −2.5180E−10 | 0.0000E+00 | 0.0000E+00 |
| | B6 | — | — | 8.7773E−09 | 2.4851E−09 | 0.0000E+00 | −2.1087E−11 |
| | B7 | — | — | 0.0000E+00 | 0.0000E+00 | 0.0000E+00 | 0.0000E+00 |
| | B8 | — | — | −1.0970E−11 | 5.4965E−13 | 0.0000E+00 | 1.5143E−15 |
| | B9 | — | — | 0.0000E+00 | 0.0000E+00 | 0.0000E+00 | 0.0000E+00 |
| | B10 | — | — | 3.6974E−15 | −2.1205E−15 | 0.0000E+00 | −5.2654E−20 |
| Sagittal R | r | ∞ | 2.6170E+01 | 2.0000E+01 | 2.0940E+01 | −1.0198E+02 | 4.2742E+01 |
| | E1 | — | — | 0.0000E+00 | 3.6159E−05 | 0.0000E+00 | 1.1149E−06 |
| | E2 | — | — | 0.0000E+00 | 1.4466E−06 | 2.3309E−06 | −1.0383E−06 |
| | E3 | — | — | 0.0000E+00 | −2.7548E−07 | 0.0000E+00 | 6.0375E−10 |
| | E4 | — | — | 0.0000E+00 | 3.3704E−08 | 0.0000E+00 | 6.4580E−10 |
| | E5 | — | — | 0.0000E+00 | 3.2831E−10 | 0.0000E+00 | −8.9265E−14 |
| | E6 | — | — | 0.0000E+00 | −6.6139E−11 | 0.0000E+00 | −1.0438E−13 |
| | E7 | — | — | 0.0000E+00 | 0.0000E+00 | 0.0000E+00 | −2.6179E−19 |
| | E8 | — | — | 0.0000E+00 | 1.4507E−14 | 0.0000E+00 | 1.2114E−17 |
| | E9 | — | — | 0.0000E+00 | 0.0000E+00 | 0.0000E+00 | 5.2096E−22 |
| | E10 | — | — | 0.0000E+00 | 3.7599E−17 | 0.0000E+00 | −6.0257E−22 |
| Sagittal | M(0, 1) | — | — | 0.0000E+00 | 6.8439E−03 | −1.0303E−01 | 1.4321E−02 |
| non-are | M(1, 1) | — | — | 0.0000E+00 | 0.0000E+00 | −3.0725E−04 | −2.8323E−04 |
| | M(2, 1) | — | — | 0.0000E+00 | −3.1798E−05 | −1.1037E−05 | −2.0933E−05 |
| | M(3, 1) | — | — | 0.0000E+00 | 0.0000E+00 | 1.5724E−07 | 1.4442E−07 |
| | M(4, 1) | — | — | 0.0000E+00 | 0.0000E+00 | 1.2642E−09 | 3.1537E−09 |
| | M(5, 1) | — | — | 0.0000E+00 | 0.0000E+00 | −7.0330E−12 | −1.1101E−11 |
| | M(6, 1) | — | — | 0.0000E+00 | 0.0000E+00 | 2.0577E−13 | −3.8856E−13 |
| | M(7, 1) | — | — | 0.0000E+00 | 0.0000E+00 | −3.1116E−16 | 1.2036E−15 |
| | M(8, 1) | — | — | 0.0000E+00 | 0.0000E+00 | −6.9892E−18 | 7.7020E−17 |
| | M(9, 1) | — | — | 0.0000E+00 | 0.0000E+00 | 1.1233E−20 | −8.7839E−20 |
| | M(10, 1) | — | — | 0.0000E+00 | 0.0000E+00 | −2.4887E−21 | −6.4458E−21 |
| Diffractive | C(2, 2) | −7.8466E−03 | — | — | — | — | — |
| surface | C(0, 2) | −8.6690E−03 | — | — | — | — | — |

As can be seen from Tables 6 and 8, in the optical scanning device 200 according to the present practical example, the exit surfaces of the lens 6A (6D) and the optical portion 6B (6C) have different generatrix shapes, sagittal shapes, and sagittal tilt shapes. The two optical portions 6A (6D) and 6B (6C) located above and below in the sub scanning direction of the multi-stage lens thus have different aspherical coefficients. This configures respective different, optimum surface shapes to correct the optical characteristics of the imaging optical systems SA (SD) and SB (SC) even if the imaging optical systems SA and SB have different optical path lengths.

The incident surfaces of the lens 6A (6D) and the optical portion 6B (6C) are optically closer to the deflection point C0 than the exit surfaces. In the sub scanning section, the distance between the light beams RA (RD) and RB (RC) on the incident surfaces of the lens 6A (6D) and the optical portion 6B (6C) is narrow. If there is a step at the interface between the incident surfaces of the multi-stage lens or otherwise the upper and lower lens surfaces in the sub scanning direction have different shapes, deformation or strain of the lens surfaces near the step due to thermal deformation stress is likely to have a high impact. Moreover, vignette is more likely to occur at the step at the interface of the multi-stage lens when the light beams move up and down. In the optical scanning device 200 according to the present practical example, as can be seen from Tables 6 and 8, the incident surfaces of the lens 6A (6D) and the optical portion 6B (6C) are therefore designed to have the same shape so that there is no step at the interface of the lens surfaces of the multi-stage lens.

In the optical scanning device 200 according to the present practical example, the functions expressing the surface shapes of the optical portions are defined by the foregoing definition formulas. However, this is not restrictive, and other definition formulas may be used.

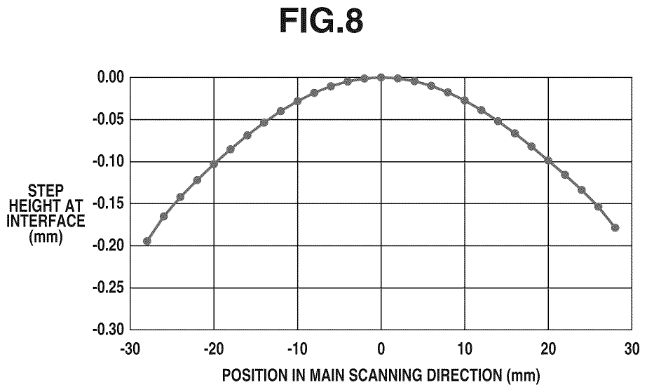

FIG. 8 illustrates the step at the interface of the exit surfaces of the multi-stage lens in the optical scanning device 200 according to the present practical example. In FIG. 8, positive values (negative values) indicate that the position of the generatrix of the optical portion 6A in the optical axis direction is farther from (closer to) the deflector 5 than is the position of the generatrix of the lens 6B in the optical axis direction.

As can be seen from FIG. 8, in the optical scanning device 200 according to the present practical example, the step height at the interface of the exit surfaces of the multi-stage lens is −0.194 mm at the maximum, which satisfies inequalities (1), (1a), and (1b). The shape difference between the exit surfaces of the lenses 6A and 6B is reduced to a sufficiently low level such that the multi-stage lens is integrally molded without problems, and various imaging characteristics are satisfied.

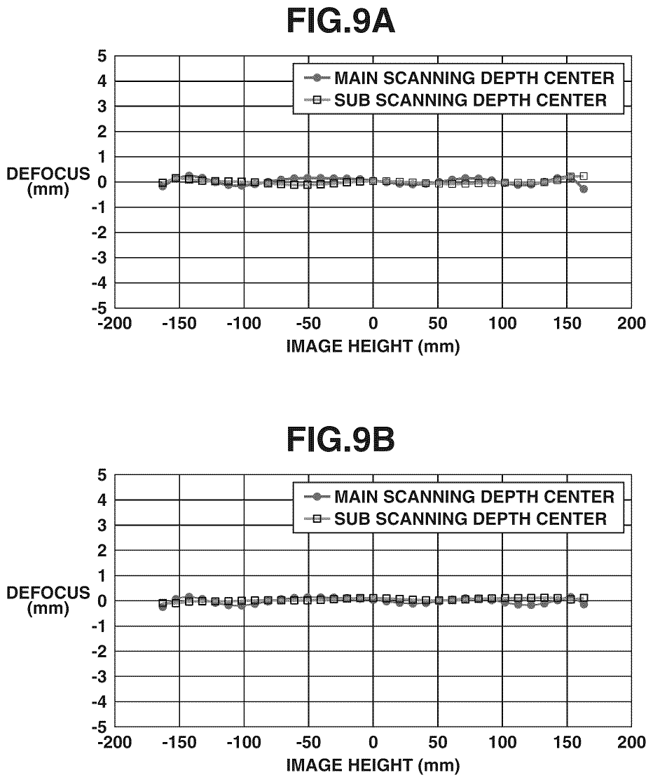

FIGS. 9A and 9B are graphs illustrating field curvatures (defocus characteristic) of the optical scanning device 200 according to the present practical example in the main scanning direction and the sub scanning direction. FIG. 9A corresponds to the light beam RA. FIG. 9B corresponds to the light beam RB. In the present practical example, the effective image width (width of the effective scanning area on the scanned surface) is W=±163 mm. As illustrated in FIGS. 9A and 9B, the field curvatures of both the imaging optical systems SA and SB in both the main and sub scanning directions are favorably corrected on the image plane.

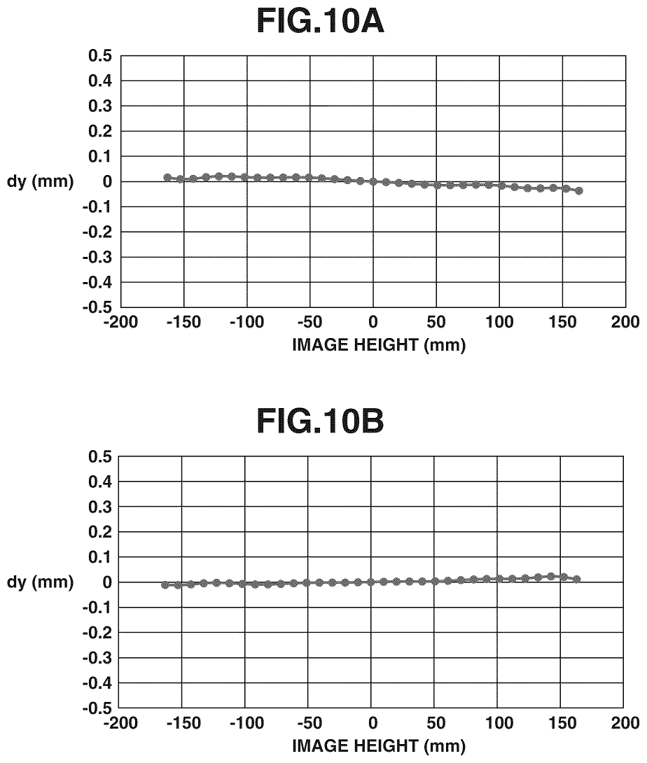

FIGS. 10A and 10B are graphs illustrating the fθ characteristics dy of the optical scanning device 200 according to the practical example. FIG. 10A corresponds to the light beam RA. FIG. 10B corresponds to the light beam RB. The fθ characteristic dy refers to a difference obtained by subtracting an ideal image height from the position where the light beam actually reaches. The fθ characteristics dy of the imaging optical systems SA and SB are favorably corrected.

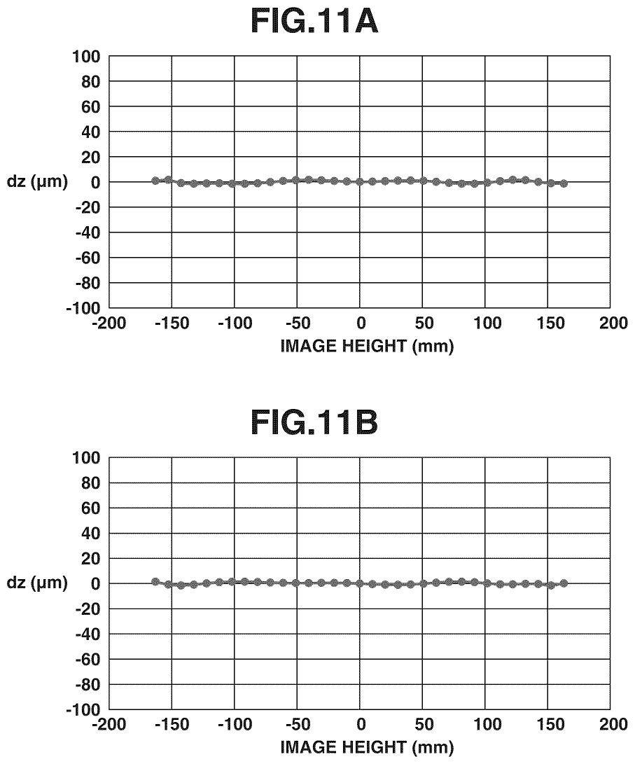

FIGS. 11A and 11B illustrate the dependence, on the position in the main scanning direction, of the scanning line curvatures dz of the optical scanning device 200 according to the present exemplary embodiment on the scanned surfaces 8A and 8B. Here, the scanning line curvature dz refers to a difference between the imaging position in the sub scanning direction at each image height and the imaging position in the main scanning direction at the axial image height on the scanned surface. As illustrated in FIGS. 11A and 11B, the scanning line curvatures dz of both the imaging optical systems SA and SB are favorably corrected on the image plane.

As described above, in the optical scanning device 200 according to the present exemplary embodiment, the imaging optical systems SA and SD are optically equivalent, and the imaging optical systems SB and SC are optically equivalent. While a description of the imaging optical systems SC and SD is omitted, the imaging performance of the imaging optical systems SC and SD is thus similarly favorably corrected.

As described above, in the present practical example, the lenses 6A and 6B optically closest to the deflector 5 are configured as a multi-stage lens. The lens surfaces of the multi-stage lens have different surface shapes, and the imaging optical systems SA and SB have different optical path lengths. Such a configuration increases the degree of freedom in lens layout, and enables miniaturization. Moreover, the imaging optical systems SA and SD consist of the lenses of the same shapes and the imaging optical systems SB and SC consist of the lenses of the same shapes. This leads to reduction in parts types.

Such an optical scanning device 200 enables miniaturization and a reduction in the parts types of the optical elements while reducing the step heights at the interfaces of the multi-stage lenses for stable moldability and favorable imaging performance.

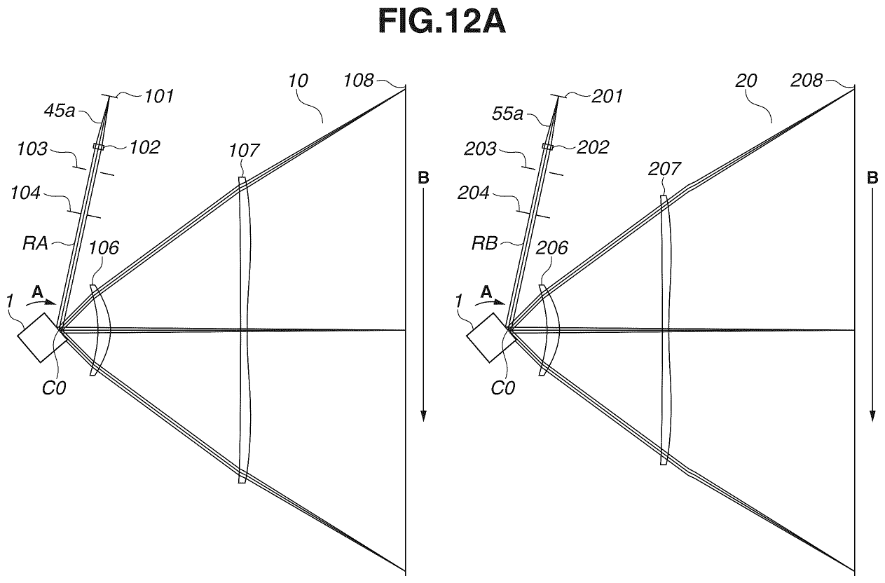

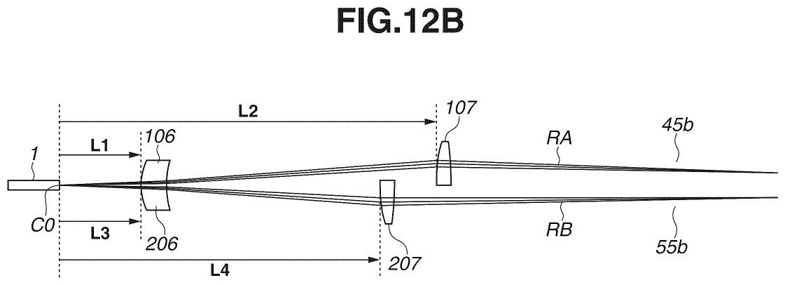

FIG. 12A is an optical path diagram of essential parts of optical scanning devices 10 and 20 according to a third exemplary embodiment in main scanning sections. FIG. 12B is an optical path diagram of essential parts of the optical scanning devices 10 and 20 according to the third exemplary embodiment in a sub scanning section.

The optical scanning devices 10 and 20 according to the present exemplary embodiment include first and second light sources 101 and 201, first and second anamorphic collimator lenses 102 and 202, first and second sub scanning aperture stops 103 and 203, and first and second main scanning aperture stops 104 and 204.

The optical scanning devices 10 and 20 according to the present exemplary embodiment also include a deflector 1, first fθ lenses 106 and 206 (first imaging elements), and second fθ lenses 107 and 207 (second and third imaging elements).

The first fθ lens 106 is located between the deflector 1 and the second fθ lens 107 on the optical path. The first f lens 206 is located between the deflector 1 and the second fθ lens 207 on the optical path.

Semiconductor lasers are used as the first and second light sources 101 and 201.

The first and second anamorphic collimator lenses 102 and 202 convert light beams RA and RB (first and second light beams) emitted from the first and second light sources 101 and 201 into parallel beams in the main scanning section, and converge the light beams RA and RB in a sub scanning direction. Here, parallel beams are not limited to strictly parallel ones but include approximately parallel beams such as weakly diverging beams and weakly converging beams.

The first and second sub scanning aperture stops 103 and 203 limit the beam diameters, in the sub scanning direction, of the light beams RA and RB passed through the first and second anamorphic collimator lenses 102 and 202.

The first and second main scanning aperture stops 104 and 204 limit the beam diameters, in the main scanning direction, of the light beams RA and RB passed through the first and second anamorphic collimator lenses 102 and 202.

The light beams RA and RB emitted from the first and second light sources 101 and 201 are thus each converged near the deflection surface of the deflector 1 only in the sub scanning direction and formed as a line image long in the main scanning direction.

The deflector 1 is rotated in the direction of the arrow A in the diagram by a not-illustrated driving unit such as a motor, whereby the deflector 1 deflects the incident light beams RA and RB. For example, the deflector 1 consists of a polygon mirror.

The first fθ lens 106 and the second fθ lens 107 are anamorphic imaging lenses having different power in the main scanning section and the sub scanning section. The first and second fθ lenses 106 and 107 converge (guide) the light beam RA deflected by the deflection surface of the deflector 1 onto the first scanned surface 108.

The first fθ lens 206 and the second fθ lens 207 are anamorphic imaging lenses having different power in the main scanning section and the sub scanning section. The first and second fθ lenses 206 and 207 converge (guide) the light beam RB deflected by the deflection surface of the deflector 1 onto the second scanned surface 208.

In the optical scanning device 10 according to the present exemplary embodiment, a first incident optical system 45a consists of the first anamorphic collimator lens 102, the first sub scanning aperture stop 103, and the first main scanning aperture stop 104. In the optical scanning device 20, a second incident optical system 55a consists of the second anamorphic collimator lens 202, the second sub scanning aperture stop 203, and the second main scanning aperture stop 204.

In the optical scanning device 10 according to the present exemplary embodiment, a first imaging optical system 45b consists of the first and second fθ lenses 106 and 107. In the optical scanning device 20, a second imaging optical system 55b consists of the first and second fθ lenses 206 and 207.

The refractive power of the second fθ lenses 107 and 207 in the sub scanning section is higher than that of the first fθ lenses 106 and 206 in the sub scanning section, respectively, i.e., the highest in the first and second imaging optical systems 45b and 55b, respectively.

The light beam RA emitted from the emission point of the first light source 101 is converted into a parallel beam by the first anamorphic collimator lens 102.

The converted light beam RA is then passed through the first sub scanning aperture stop 103, passed through the first main scanning aperture stop 104, and incident on the deflector 1.

The light beam RA emitted from the first light source 101 and incident on the deflector 1 is deflected and scanned by the deflector 1, is then converged upon the first scanned surface 108 by the first imaging optical system 45b, and scans the first scanned surface 108 at constant speed.

The light beam RB emitted from the emission point of the second light source 201 is converted into a parallel beam by the second anamorphic collimator lens 202.

The converted light beam RB is then passed through the second main scanning aperture stop 203, passed through the second main scanning aperture stop 204, and incident on the deflection surface of the deflector 1.

The light beam RB emitted from the second light source 201 and incident on the deflection surface of the deflector 1 is deflected and scanned by the deflector 1, is then converged upon the second scanned surface 208 by the second imaging optical system 55b, and scans the second scanned surface 208 at constant speed.

Since the deflector 1 rotates in the direction of the arrow A in the diagram, the deflected and scanned light beams RA and RB scan the first and second scanned surfaces 108 and 208 in the direction of the arrow B in the diagram, respectively.

The deflection point (axial deflection point) of the principal ray of the axial light beams on the deflection surface of the deflector 1 is denoted by C0. The deflection point C0 serves as a reference point for the first and second imaging optical systems 45b and 55b.

In the present exemplary embodiment, first and second photosensitive drums 108 and 208 are used as the first and second scanned surfaces 108 and 208, respectively.

The exposure distributions on the first and second photosensitive drums 108 and 208 in the sub scanning direction are formed by rotating the first and second photosensitive drums 108 and 208 in the sub scanning direction upon each main scanning exposure.

Tables 9 to 11 below illustrate the characteristics of the first and second incident optical systems 45a and 55a and the first and second imaging optical system 45b and 55b of the optical scanning devices 10 and 20 according to the present exemplary embodiment.

TABLE 9
Properties of light sources 101 and 201

| | | |
|---|---|---|
| Wavelength | λ (nm) | 790 |
| Incident deflection to deflection surface 205 of | | p-polarized light |
| deflector 1 | | |
| Full angle at half maximum in main scanning | FFPy (deg) | 12.00 |
| direction | | |
| Full angle at half maximum in sub scanning | FFPz (deg) | 30.00 |
| direction | | |

Aperture shape

| | Main scanning | Sub scanning |
|---|---|---|
| | direction | direction |
| Sub scanning apertures 103 and 203 | 3.750 | 2.840 |
| Main scanning apertures 104 and 204 | 3.750 | 2.840 |

Refractive index

| | | |
|---|---|---|
| Anamorphic collimator lenses 102 and 202 | N1 | 1.5282 |

Optical element shape

| | | Main scanning | Sub scanning |
|---|---|---|---|
| | | direction | direction |
| Radius of curvature of incident surfaces of | r1a (mm) | ∞ | ∞ |
| anamorphic collimator lenses 102 and 202 | | | |
| Radius of curvature of exit surfaces of anamorphic | r1b (mm) | −37.169 | −26.170 |
| collimator lenses 102 and 202 | | | |
| Phase coefficient of incident surfaces of the | DO | −7.847E−03 | −8.669E−03 |
| anamorphic collimator lenses 102 and 202 | | | |

Focal length

| | | Main scanning | Sub scanning |
|---|---|---|---|
| | | direction | direction |
| Anamorphic collimator lenses 102 and 202 | fcol | 33.94 | 27.15 |
| | (mm) | | |

Layout

| | | |
|---|---|---|
| Light sources 101 and 201 to anamorphic | d0 | 28.09 |
| collimator lenses 102 and 202 | (mm) | |
| From incident surface of anamorphic collimator | d1 | 5.50 |
| lenses 102 and 202 to | (mm) | |
| Exit surface of anamorphic collimator lenses 102 | | |
| and 202 | | |
| From exit surfaces of the anamorphic collimator | d2 | 3.00 |
| lenses 102 and 202 to | (mm) | |
| sub scanning apertures 103 and 203 | | |
| From sub scanning apertures 103 and 203 to | d4 | 15.15 |
| main scanning apertures 104 and 204 | (mm) | |
| From main scanning apertures 104 and 204 to | d5 | 80.09 |
| deflection surface of deflector 1 | (mm) | |
| Incident angle of light exited from main scanning | A1 | 78.00 |
| aperture 104 | (deg) | |
| to deflection surface in main scanning section | | |
| Incident angle of light exited from main scanning | A2 | 78.00 |
| aperture 204 | (deg) | |
| to deflection surface in main scanning section | | |
| Incident angle of light exited from main scanning | A3 | 2.70 |
| aperture 104 | (deg) | |
| to deflection surface in sub scanning section | | |
| Incident angle of light exited from main scanning | A4 | −2.70 |
| aperture 204 | (deg) | |
| to deflection surface in sub scanning section | | |

TABLE 10
fθ coefficient scanning angle, angle of view

| | | |
|---|---|---|
| fθ coefficient | k (mm/rad) | 207 |
| Scanning width | W (mm) | 330 |
| Maximum angle of view | θ (deg) | 45.7 |

Refractive index

| | | |
|---|---|---|
| Refractive index of fθ lens 106 | N5 | 1.5282 |
| Refractive index of fθ lens 107 | N6 | 1.5282 |

Deflector

| | | |
|---|---|---|
| Number of deflection surfaces | | 4 |
| Circumcircle radius | Rpol (mm) | 10 |
| Rotation center-deflection reference point C0 (optical axis | Xpol (mm) | 6.03 |
| direction) | | |
| Rotation center-deflection reference point C0 (main scanning | Ypol (mm) | 3.79 |
| direction) | | |

Scanning optical system, layout

| | | |
|---|---|---|
| From deflection reference point C0 to | d12 (mm) | 26.00 |
| incident surface of fθ lens 106 | | |
| From incident surface of fθ lens 106 to | d13 (mm) | 8.20 |
| exit surface of fθ lens 106 | | |
| From exit surface of fθ lens 106 to | d14 (mm) | 87.80 |
| incident surface of fθ lens 107 | | |
| From incident surface of fθ lens 107 to | d15 (mm) | 4.30 |
| exit surface of fθ lens 107 | | |
| Form exit surface of fθ lens 107 to | d16 (mm) | 106.70 |
| photosensitive drum 108 | | |
| From deflection reference point C0 to | L1 (mm) | 26.00 |
| incident surface of fθ lens 106 | | |
| From deflection reference point C0 to | L2 (mm) | 122.00 |
| incident surface of fθ lens 107 | | |
| From deflection reference point C0 to | T2 (mm) | 233.00 |
| photosensitive drum 108 | | |
| Sub scanning decentering amount of fθ lens 107 | shiftZ (mm) | 7.21 |

| Generatrix shape of fθ lens 106 | | | Generatrix shape of fθ lens 107 | | |
|---|---|---|---|---|---|
| | Incident Surface | Exit Surface | | Incident Surface | Exit Surface |
| | Opposite light | Opposite light | | Opposite light | Opposite light |
| | source side | source side | | source side | source side |
| R | −71.101 | 43.800 | R | −4000 | 379.967 |
| ku | 9.464E−01 | −9.321E−01 | ku | 0 | −7.412E+01 |
| B4u | −9.147E−07 | −1.355E−06 | B4u | 0 | −1.332E−07 |
| B6u | 6.784E−09 | 1.719E−09 | B6u | 0 | 7.206E−12 |
| B8u | −5.767E−12 | 8.761E−13 | B8u | 0 | −3.070E−16 |
| B10u | 1.638E−15 | −1.069E−15 | B10u | 0 | 6.089E−21 |
| B12u | 0 | 0 | B12u | 0 | 0.000E+00 |

| | Light source side | Light source side | | Light source side | Light source side |
|---|---|---|---|---|---|
| kl | 9.464E−01 | −9.321E−01 | kl | 0 | −7.412E+01 |
| B4l | −9.147E−07 | −1.355E−06 | B4l | 0 | −1.332E−07 |
| B6l | 6.784E−09 | 1.719E−09 | B6l | 0 | 7.206E−12 |
| B8l | −5.767E−12 | 8.761E−13 | B8l | 0 | −3.070E−16 |
| B10l | 1.638E−15 | −1.069E−15 | B10l | 0 | 6.089E−21 |
| B12l | 0 | 0 | B12l | 0 | 0.000E+00 |

| Sagittal shape of fθ lens 106 | | | Sagittal shape of fθ lens 107 | | |
|---|---|---|---|---|---|
| | Incident Surface | Exit Surface | | Incident Surface | Exit Surface |
| | Sagittal curvature | Sagittal curvature | | Sagittal curvature | Sagittal curvature |
| | R change | R change | | R change | R change |
| r | 20.000 | 55.261 | r | 37.426 | −249.9931 |
| E1 | 0 | 0 | E1 | 0.000E+00 | 9.40981E−09 |
| E2 | 0 | 6.894E−06 | E2 | −3.482E−07 | 1.44641E−06 |
| E3 | 0 | 0 | E3 | 0 | −1.61579E−09 |
| E4 | 0 | 8.425E−08 | E4 | 0.000E+00 | −2.7926E−10 |
| E5 | 0 | 0 | E5 | 0 | 4.72069E−13 |
| E6 | 0 | −2.679E−10 | E6 | 0.000E+00 | 4.45476E−14 |
| E7 | 0 | 0 | E7 | 0 | −5.35403E−17 |
| E8 | 0 | 3.4364E−13 | E8 | 0.000E+00 | −3.93574E−18 |
| E9 | 0 | 0 | E9 | 0 | 2.02748E−21 |
| E10 | 0 | −1.53852E−16 | E10 | 0 | 1.36304E−22 |

| | Sagittal tilt | Sagittal tilt | | Sagittal tilt | Sagittal tilt |
|---|---|---|---|---|---|
| M0_1 | 0 | 7.661E−02 | M0_1 | 1.211E−01 | −5.801E−02 |
| M1_1 | 0 | 0.000E+00 | M1_1 | 2.129E−04 | 2.002E−04 |
| M2_1 | 0 | −3.906E−05 | M2_1 | 1.111E−05 | 2.292E−05 |
| M3_1 | 0 | 0.000E+00 | M3_1 | −1.419E−07 | −1.288E−07 |
| M4_1 | 0 | 0.000E+00 | M4_1 | −5.557E−10 | −2.627E−09 |
| M5_1 | 0 | 0 | M5_1 | 2.589E−11 | 2.174E−11 |
| M6_1 | 0 | 0 | M6_1 | −2.459E−13 | 2.067E−13 |
| M7_1 | 0 | 0 | M7_1 | −2.150E−15 | −1.675E−15 |
| M8_1 | 0 | 0 | M8_1 | 1.182E−17 | −3.209E−17 |
| M9_1 | 0 | 0 | M9_1 | 6.130E−20 | 4.199E−20 |
| M10_1 | 0 | 0 | M10_1 | 9.717E−23 | 1.487E−21 |
| M11_1 | 0 | 0 | M11_1 | 0 | 0 |
| M12_1 | 0 | 0 | M12_1 | 0 | 0 |

TABLE 11
fθ coefficient scanning angle, angle of view

| | | |
|---|---|---|
| fθ coefficient | k (mm/rad) | 207 |
| Scanning width | W (mm) | 330 |
| Maximum angle of view | θ (deg) | 45.7 |

Refractive index

| | | |
|---|---|---|
| Refractive index of fθ lens 206 | N5 | 1.5282 |
| Refractive index of fθ lens 207 | N6 | 1.5282 |

Deflector

| | | |
|---|---|---|
| Number of deflection surfaces | | 4 |
| Circumcircle radius | Rpol (mm) | 10 |
| Rotation center-deflection reference point C0 (optical | Xpol (mm) | 6.03 |
| axis direction) | | |
| Rotation center-deflection reference point C0 (main | Ypol (mm) | 3.79 |
| scanning direction) | | |

Scanning optical system, layout

| | | |
|---|---|---|
| From deflection reference point C0 to | d12 (mm) | 26.00 |
| incident surface of fθ lens 206 | | |
| From incident surface of fθ lens 206 to | d13 (mm) | 8.20 |
| exit surface of fθ lens 206 | | |
| From exit surface of fθ lens 206 to | d14 (mm) | 69.30 |
| incident surface of fθ lens 107 | | |
| From incident surface of fθ lens 207 to | d15 (mm) | 4.30 |
| exit surface of fθ lens 207 | | |
| Form exit surface of fθ lens 207 to | d16 (mm) | 125.20 |
| photosensitive drum 208 | | |
| From deflection reference point C0 to | L3 (mm) | 26.00 |
| incident surface of fθ lens 206 | | |
| From deflection reference point C0 to | L4 (mm) | 103.50 |
| incident surface of fθ lens 207 | | |
| From deflection reference point C0 to | T2 (mm) | 233.00 |
| photosensitive drum 208 | | |
| Sub scanning decentering amount of fθ lens 207 | shiftZ (mm) | 5.03 |

| Generatrix shape of fθ lens 206 | | | Generatrix shape of fθ lens 207 | | |
|---|---|---|---|---|---|
| | Incident Surface | Exit Surface | | Incident Surface | Exit Surface |
| | Opposite light | Opposite light | | Opposite light | Opposite light |
| | source side | source side | | source side | source side |
| R | −71.101 | −42.946 | R | −4000 | 350.123 |
| ku | 9.464E−01 | −5.155E−01 | ku | 0 | −8.753E+01 |
| B4u | −9.147E−07 | −3.477E−07 | B4u | 0 | −2.020E−07 |
| B6u | 6.784E−09 | 1.690E−09 | B6u | 0 | 1.609E−11 |
| B8u | −5.767E−12 | 1.110E−12 | B8u | 0 | −9.313E−16 |
| B10u | 1.638E−15 | −1.224E−15 | B10u | 0 | 2.524E−20 |
| B12u | 0 | 0 | B12u | 0 | 0 |

| | Light source side | Light source side | | Light source side | Light source side |
|---|---|---|---|---|---|
| kl | 9.464E−01 | −5.155E−01 | kl | 0 | −8.753E+01 |
| B4l | −9.147E−07 | −3.477E−07 | B4l | 0 | −2.020E−07 |
| B6l | 6.784E−09 | 1.690E−09 | B6l | 0 | 1.609E−11 |
| B8l | −5.767E−12 | 1.110E−12 | B8l | 0 | −9.313E−16 |
| B10l | 1.638E−15 | −1.224E−15 | B10l | 0 | 2.524E−20 |
| B12l | 0 | 0 | B12l | 0 | 0 |
| Sagittal shape of fθ lens 206 | | | Sagittal shape of fθ lens 207 | | |
| | Incident Surface | Exit Surface | | Incident Surface | Exit Surface |
| | Sagittal curvature | Sagittal curvature | | Sagittal curvature | Sagittal curvature |
| | R change | R change | | R change | R change |
| r | 20.000 | 25.004 | r | 37.079 | −154.0078 |
| E1 | 0 | 0 | E1 | 0 | −1.27778E−07 |
| E2 | 0 | 1.522E−05 | E2 | −7.458E−07 | 1.81313E−06 |
| E3 | 0 | 0 | E3 | 0 | −3.2397E−09 |
| E4 | 0 | 8.486E−10 | E4 | 0 | −3.04103E−10 |
| E5 | 0 | 0 | E5 | 0 | 1.33875E−12 |
| E6 | 0 | −2.508E−11 | E6 | 0 | 3.08183E−14 |
| E7 | 0 | 0 | E7 | 0 | −2.00884E−16 |
| E8 | 0 | 7.60678E−15 | E8 | 0 | −1.95419E−18 |
| E9 | 0 | 0 | E9 | 0 | 9.85865E−21 |
| E10 | 0 | 1.60971E−17 | E10 | 0 | 5.81192E−23 |

| | Sagittal tilt | Sagittal tilt | | Sagittal tilt | Sagittal tilt |
|---|---|---|---|---|---|
| M0_1 | 0 | 2.124E−02 | M0_1 | −1.007E−01 | 2.315E−02 |
| M1_1 | 0 | 0 | M1_1 | −2.129E−04 | −2.002E−04 |
| M2_1 | 0 | −3.321E−05 | M2_1 | −1.314E−05 | −2.370E−05 |
| M3_1 | 0 | 0 | M3_1 | 1.161E−07 | 1.056E−07 |
| M4_1 | 0 | 0 | M4_1 | 1.765E−09 | 3.675E−09 |
| M5_1 | 0 | 0 | M5_1 | −1.616E−11 | −1.409E−11 |
| M6_1 | 0 | 0 | M6_1 | 3.014E−13 | −3.052E−13 |
| M7_1 | 0 | 0 | M7_1 | 1.061E−15 | 9.733E−16 |
| M8_1 | 0 | 0 | M8_1 | −1.306E−17 | 6.574E−17 |
| M9_1 | 0 | 0 | M9_1 | −1.657E−20 | −1.728E−20 |
| M10_1 | 0 | 0 | M10_1 | −8.536E−22 | −3.960E−21 |
| M11_1 | 0 | 0 | M11_1 | 0 | 0 |
| M12_1 | 0 | 0 | M12_1 | 0 | 0 |

Next, the effects of the optical scanning devices 10 and 20 according to the present exemplary embodiment will be described.

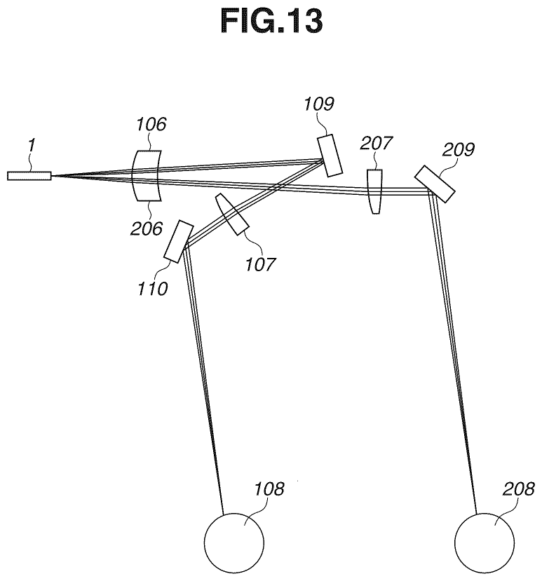

FIG. 13 illustrates a folded layout of the optical scanning devices 10 and 20 according to the present exemplary embodiment, using reflective elements.

As illustrated in FIG. 13, the first imaging optical system 45b includes reflecting mirrors 109 and 110. The second imaging optical system 55b includes a reflecting mirror 209.

Reflective elements with vapor deposition films are used as the reflecting mirrors 109, 110, and 209.

In the present exemplary embodiment, the light emitted from the first fθ lens 106 of the first imaging optical system 45b is deflected and reflected by the reflecting mirror 109, passed through the second fθ lens 107, deflected and reflected by the reflecting mirror 110, and guided to the photosensitive drum 108. The light emitted from the second fθ lens 207 of the second imaging optical system 55b is deflected and reflected by the reflecting mirror 209 and guided to the photosensitive drum 208.

If the distance between the photosensitive drums 108 and 208 is reduced to miniaturize the image forming apparatus, and the second fθ lens 107 of the first imaging optical system 45b and the second fθ lens 207 of the second imaging optical system 55b are located at optically equivalent distances from the deflector 1, the second fθ lenses 107 and 207 interfere with the light beams RA and RB.

In the present exemplary embodiment, to solve this issue, the second fθ lens 107 of the first imaging optical system 45b is located closer to the deflector 1 than the second fθ lens 207 of the second imaging optical system 55b.

Such a layout prevents interference between the fθ lenses and the light beams while reducing the size of the image forming apparatus.

However, since the second fθ lenses 107 and 207 of the first and second imaging optical systems 45b and 55b are located at different positions, the first f lenses 106 and 206 of the respective imaging optical systems 45b and 55b desirably have different power in the sub scanning direction so that the imaging optical systems 45b and 55b have approximately the same sub scanning magnifications.

Table 12 below illustrates the characteristics of the first fθ lenses 106 and 206 and the second fθ lenses 107 and 207 according to the present exemplary embodiment.

TABLE 12

| | fθ lens 106 | | | fθ lens 206 | | |
|---|---|---|---|---|---|---|
| | Incident | Exit | Entire | Incident | Exit | Entire |
| | Surface | Surface | system | Surface | Surface | system |
| Refractive index | 1.5282 | | | 1.5282 | | |
| Thickness | 8.2 | | | 8.2 | | |
| Radius of | 20 | 55.261 | — | 20 | 25.004 | — |
| curvature | | | | | | |
| Refractive | 0.0264 | −0.0096 | 0.0182 | 0.0264 | −0.0211 | 0.0083 |
| power | | | | | | |
| Tilt amount | 0 | 0.0766 | — | 0 | 0.0810 | — |
| (M0_1) | | | | | | |
| Focal length | 37.865 | −104.623 | 54.927 | 37.865 | −47.339 | 120.790 |

| | fθ lens 107 | | | fθ lens 207 | | |
|---|---|---|---|---|---|---|
| | Incident | Exit | Entire | Incident | Exit | Entire |
| | Surface | Surface | system | Surface | Surface | system |
| Refractive index | 1.5282 | | | 1.5282 | | |
| Thickness | 4.3 | | | 4.3 | | |
| Radius of | 37.426 | −249.993 | — | 37.079 | −154.008 | — |
| curvature | | | | | | |
| Refractive | 0.0141 | 0.0021 | 0.0161 | 0.0142 | 0.0034 | 0.0175 |
| power | | | | | | |
| Tilt amount | 0.1211 | −0.0580 | — | 0 | 0.0810 | — |
| (M0_1) | | | | | | |
| Focal length | 70.857 | 473.300 | 61.951 | 70.200 | 291.576 | 57.022 |

In the present exemplary embodiment, the sagittal curvature (curvature in the sub scanning section) of the exit surface of the first fθ lens 106 of the optical scanning device 10 on the optical axis (near the axis) is 55.261. The sagittal curvature of the exit surface of the first fθ lens 206 of the optical scanning device 20 near the axis is 25.004.

The compact configuration described above is achieved by thus making the sagittal curvatures of the exit surfaces of the first fθ lenses 106 and 206 different.

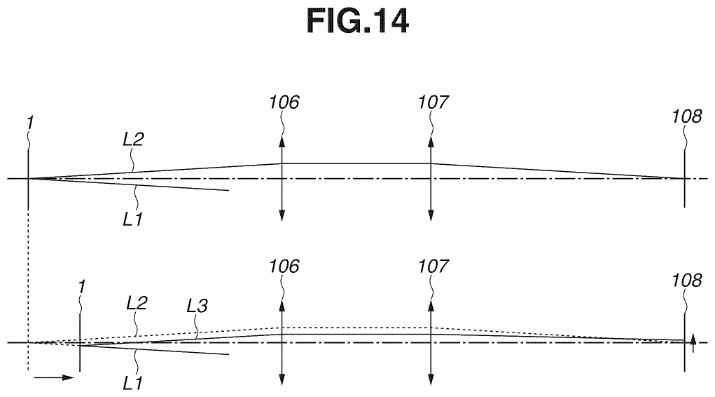

FIG. 14 schematically illustrates the optical paths when the deflector 1 according to the present exemplary embodiment deviates in position.

The upper part of FIG. 14 is a schematic diagram illustrating the optical paths when the deflector 1 is at an ideal position. The lower part of FIG. 14 is a schematic diagram illustrating the optical paths when the deflector 1 is located off the ideal position.

In the diagram, a ray L1 is incident on the deflector 1. A ray L2 results when the deflector 1 is at the ideal position. A ray L3 results when the deflector 1 is located off the ideal position.

The amount of change in the deviation of the light irradiation position on the photosensitive drum due to a positional deviation caused by an assembly error of the deflector 1 varies depending on the oblique incident angle on the deflector 1.

As the deflector 1 rotates in the direction of the arrow A in FIG. 12A, the deflection surfaces appear and disappear in the sub scanning direction. To reduce the distribution of deviations in the main scanning direction, the sagittal curvature is changed, which further reduces deviations in the irradiation position on the photosensitive drum.

In the present exemplary embodiment, as illustrated in Tables 10 and 11, the exit surfaces of the first fθ lenses 106 and 206 are surfaces of which the sagittal curvature changes in the main scanning direction.

In the sub scanning section, the following inequalities (2) and (3) are desirably simultaneously satisfied:

$$\vert θ2 \vert \geq \vert θ1 \vert , and \qquad ( 2 )$$

$$- 2.5 < θ 2 / θ 1 < 2.5 , \qquad ( 3 )$$

where θ1 is the incident angle of the principal ray of the first light beam RA corresponding to the optical scanning device 10 on the deflection surface of the deflector 1, and θ2 is the incident angle of the principal ray of the second light beam RB corresponding to the optical scanning device 20 on the deflection surface of the deflector 1. A difference in the irradiation position deviations caused by the optical scanning devices 10 and 20 on the photosensitive drums 108 and 208 is thereby reduced.

The incident angles θ1 and θ2 more desirably satisfy the following inequality (3a), still more desirably inequality (3b):

$$- 2.0 < θ 2 / θ 1 < 2. , and \qquad ( 3 a )$$

$$- 1.5 < θ 2 / θ 1 < 1.5 . \qquad ( 3 b )$$

θ1=θ2 is even more desirable.

In the present exemplary embodiment, the incident angle θ1 of the principal ray of the optical scanning device 10 in the sub scanning direction is 2.7°. The incident angle θ2 of the principal ray of the optical scanning device 20 in the sub scanning direction is −2.7°.

If the deflector 1 of the optical scanning device 10 moves by 15 μm in the optical axis direction, the ray L3 moves by 1.5 μm from the ray L2 on the photosensitive drum 108. If the deflector 1 of the optical scanning device 20 moves by 15 μm in the optical axis direction, the ray L3 moves by −1.5 μm from the ray L2 on the photosensitive drum 208.

The relative difference is 3 μm. With a resolution of 600 dpi, the difference has an impact of approximately 7% on the 42.3-μm pitch, and the image quality is not much affected.

In the present exemplary embodiment, |θ2|=|θ1| and θ2/θ1=−1. This satisfies |θ2|≥|θ1| and −2.5<θ2/θ1<2.5.

As a result, the amount of positional deviation caused by the optical scanning devices 10 and 20 on the photosensitive drums is reduced.

In the present exemplary embodiment, the optical scanning devices 10 and 20 include an optical path including the two reflective elements 109 and 110 and an optical path including the one reflective element 209, respectively, where the signs of the oblique incident angles are opposite. In such a configuration, the deviations on the photosensitive drums 108 and 208 due to a positional deviation of the deflector 1 occur in the same direction.

The configuration that θ2/θ1<0 and the difference between the numbers of reflective elements included in the optical scanning devices 10 and 20 is an odd number further reduces the amount of positional deviation.

As a result, the amount of positional deviation caused by the optical scanning devices 10 and 20 on the photosensitive drums 108 and 208 is further reduced.

Here, the relative difference is 0 μm, which leads to a further reduction in the impact on the image quality.

As a modification of the present exemplary embodiment, in a case where θ1 is 2.7° and θ2 is −6.7°, this yields θ2/θ1=−2.48.

In such a case, if the deflector 1 of the optical scanning device 10 moves by 15 μm in the optical axis direction, the ray L3 moves by 1.5 μm from the ray L2 on the photosensitive drum 108. If the deflector 1 of the optical scanning device 20 moves by 15 μm in the optical axis direction, the ray L3 moves by −3.72 μm from the ray L2 on the photosensitive drum 208.

The relative difference is 5.22 μm. With a resolution of 600 dpi, the difference has an impact of approximately 12.3% on the 42.3-μm pitch.

In this modification, since θ2/θ1<0, the amount of positional deviation is further reduced if the difference between the numbers of reflective elements included in the optical scanning devices 10 and 20 is an odd number.

As another modification of the present exemplary embodiment, in a case where θ1 is 1.1° and θ2 is 2.7°, this yields θ2/θ1=2.45.

In such a case, if the deflector 1 of the optical scanning device 10 moves by 15 μm in the optical axis direction, the ray L3 moves by 0.6 μm from the ray L2 on the photosensitive drum 108. If the deflector 1 of the optical scanning device 20 moves by 15 μm in the optical axis direction, the ray L3 moves by 1.5 μm from the ray L2 on the photosensitive drum 208.

The relative difference is 0.9 μm. With a resolution of 600 dpi, the difference has an impact of approximately 2.1% on the 42.3-μm pitch.

In this modification, since θ2/θ1>0, the amount of positional deviation is further reduced if the difference between the numbers of reflective elements included in the optical scanning devices 10 and 20 is an even number.

In such a case, if the deflector 1 of the optical scanning device 10 moves by 15 μm in the optical axis direction, the ray L3 moves by 1.5 μm from the ray L2 on the photosensitive drum 108. If the deflector 1 of the optical scanning device 20 moves by 15 μm in the optical axis direction, the ray L3 moves by −3.72 μm from the ray L2 on the photosensitive drum 208.

The first fθ lenses 106 and 206 used in the present exemplary embodiment desirably consist of an integrally molded lens in view of miniaturization and a reduction in image quality difference.

Effects similar to those of the present exemplary embodiment are obtainable even if the incident surfaces of the first fθ lenses 106 and 206 have different sagittal curvatures like the exit surfaces.

With the foregoing configuration, the optical scanning devices 10 and 20 according to the present exemplary embodiment provide compact optical scanning devices while reducing a difference in image quality.

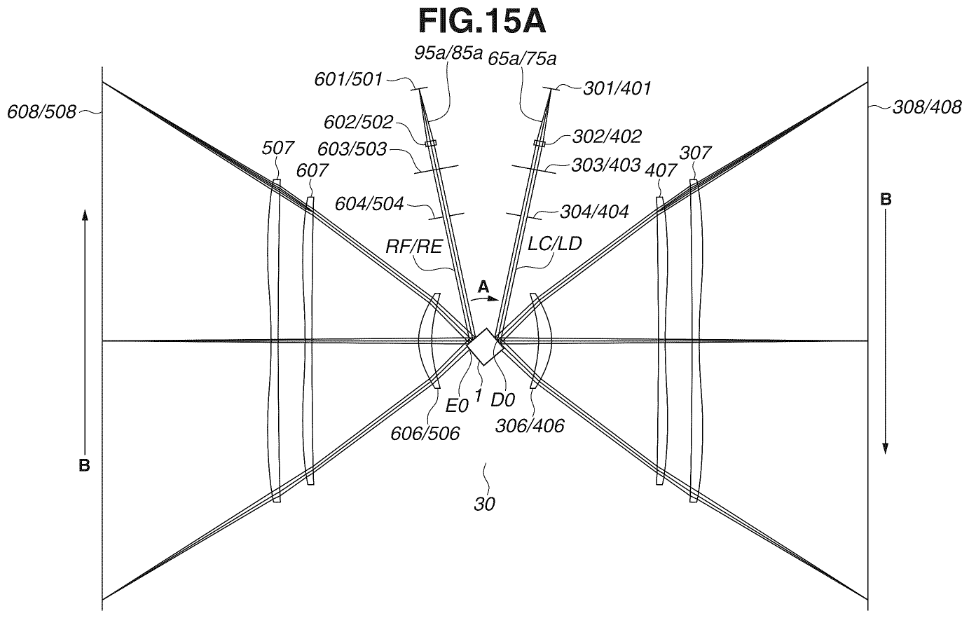

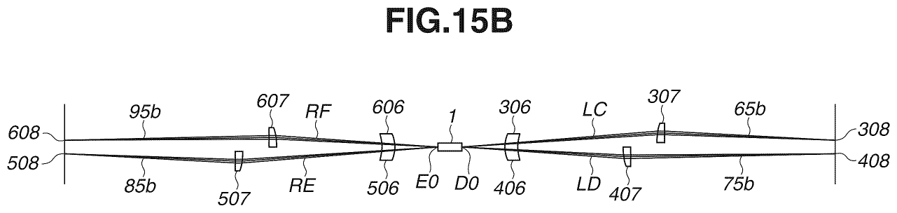

FIG. 15A is an optical path diagram of essential parts of an optical scanning device 30 according to a fourth exemplary embodiment in a main scanning section. FIG. 15B is an optical path diagram of essential parts of imaging optical systems included in the optical scanning device 30 according to the fourth exemplary embodiment in a sub scanning section.

The optical scanning device 30 according to the present exemplary embodiment includes first, second, third, and fourth light sources 301, 401, 501, and 601, first, second, third, and fourth anamorphic collimator lenses 302, 402, 502, and 602, first, second, third, and fourth sub scanning aperture stops 303, 403, 503, and 603, and first, second, third, and fourth main scanning aperture stops 304, 404, 504, and 604.

The optical scanning device 30 according to the present exemplary embodiment also includes a deflector 1, first fθ lenses 306, 406, 506, and 606 (first imaging elements), second fθ lenses 307 and 407 (second and third imaging elements), and second fθ lenses 507 and 607 (second and third imaging elements).

The first fθ lens 306 is located between the deflector 1 and the second fθ lens 307 on the optical path. The first fθ lens 406 is located between the deflector 1 and the second fθ lens 407 on the optical path. The first fθ lens 506 is located between the deflector 1 and the second fθ lens 507 on the optical path. The first fθ lens 606 is located between the deflector 1 and the second fθ lens 607 on the optical path.

Semiconductor lasers are used as the first, second, third, and fourth light sources 301, 401, 501, and 601.

The first, second, third, and fourth anamorphic collimator lenses 302, 402, 502, and 602 convert light beams RC, RD, RE, and RF (first, second, third, and fourth light beams) emitted from the first, second, third, and fourth light sources 301, 401, 501, and 601 into parallel beams in the main scanning section, and converge the light beams RC, RD, RE, and RF in the sub scanning direction. Here, parallel beams are not limited to strictly parallel ones but include approximately parallel beams such as weakly diverging beams and weakly converging beams.

The first, second, third, and fourth sub scanning aperture stops 303, 403, 503, and 603 limit the beam diameters, in the sub scanning direction, of the light beams RC, RD, RE, and RF passed through the first, second, third, and fourth anamorphic collimator lenses 302, 402, 502, and 602.

The first, second, third, and fourth main scanning aperture stops 304, 404, 504, and 604 limit the beam diameters, in the main scanning direction, of the light beams RC, RD, RE, and RF passed through the first, second, third, and fourth anamorphic collimator lenses 302, 402, 502, and 602.

In such a manner, the light beams RC, RD, RE, and RF emitted from the first, second, third, and fourth light sources 301, 401, 501, and 601 are each converged near a deflection surface of the deflector 1 only in the sub scanning direction and formed as a line image long in the main scanning direction.

The deflector 1 is rotated in the direction of the arrow A in the diagram by a not-illustrated driving unit such as a motor, whereby the deflector 1 deflects the incident light beams RC, RD, RE, and RF. For example, the deflector 1 consists of a polygon mirror.

The first fθ lens 306 and the second fθ lens 307 are anamorphic imaging lenses having different power in the main scanning section and the sub scanning section. The first and second fθ lenses 306 and 307 converge (guide) the light beam RC deflected by the deflection surface of the deflector 1 onto a first scanned surface 308.

The first fθ lens 406 and the second fθ lens 407 are anamorphic imaging lenses having different power in the main scanning section and the sub scanning section. The first and second fθ lenses 406 and 407 converge (guide) the light beam RD deflected by the deflection surface of the deflector 1 onto a second scanned surface 408.

The first fθ lens 506 and the second fθ lens 507 are anamorphic imaging lenses having different power in the main scanning section and the sub scanning section. The first and second fθ lenses 506 and 507 converge (guide) the light beam RE deflected by a deflection surface of the deflector 1 onto a third scanned surface 508.

The first fθ lens 606 and the second fθ lens 607 are anamorphic imaging lenses having different power in the main scanning section and the sub scanning section. The first and second fθ lenses 606 and 607 converge (guide) the light beam RF deflected by the deflection surface of the deflector 1 onto a fourth scanned surface 608.

In the optical scanning device 30 according to the present exemplary embodiment, a first incident optical system 65a consists of the first anamorphic collimator lens 302, the first sub scanning aperture stop 303, and the first main scanning aperture stop 304. A second incident optical system 75a consists of the second anamorphic collimator lens 402, the second sub scanning aperture stop 403, and the second main scanning aperture stop 404. A third incident optical system 85a consists of the third anamorphic collimator lens 502, the third sub scanning aperture stop 503, and the third main scanning aperture stop 504. A fourth incident optical system 95a consists of the fourth anamorphic collimator lens 602, the fourth sub scanning aperture stop 603, and the fourth main scanning aperture stop 604.

In the optical scanning device 30 according to the present exemplary embodiment, a first imaging optical system 65b consists of the first fθ lens 306 and the second fθ lens 307. A second imaging optical system 75b consists of the first fθ lens 406 and the second fθ lens 407. A third imaging optical system 85b consists of the first fθ lens 506 and the second fθ lens 507. A fourth imaging optical system 95b consists of the first fθ lens 606 and the second fθ lens 607.

The refractive power of the second fθ lenses 307, 407, 507, and 607 in the sub scanning section is higher than that of the first fθ lens 306, 406, 506, and 606 in the main scanning section, respectively, i.e., the highest in the first, second, third, and fourth imaging optical systems 65b, 75b, 85b, and 95b, respectively.

The light beam RC emitted from the emission point of the first light source 301 is converted into a parallel beam in the main scanning section and converged in the sub scanning direction by the first anamorphic collimator lens 302.

The resulting light beam RC is passed through the first sub scanning aperture stop 303, passed through the first main scanning aperture stop 304, and incident on a deflection surface of the deflector 1.

The light beam RC emitted from the first light source 301 and incident on the deflection surface of the deflector 1 is deflected and scanned by the deflector 1, is then converged upon on the first scanned surface 308 by the first imaging optical system 65b, and scans the first scanned surface 308 at constant speed.

The light beam RD emitted from the emission point of the second light source 401 is converted into a parallel beam in the main scanning section and converged in the sub scanning direction by the second anamorphic collimator lens 402.

The resulting light beam RD is passed through the second sub scanning aperture stop 403, passed through the second main scanning aperture stop 404, and incident on the deflection surface of the deflector 1.

The light beam RD emitted from the second light source 401 and incident on the deflection surface of the deflector 1 is deflected and scanned by the deflector 1, is then converged upon on the second scanned surface 408 by the second imaging optical system 75b, and scans the second scanned surface 408 at constant speed.

The light beam RE emitted from the emission point of the third light source 501 is converted into a parallel beam in the main scanning section and converged in the sub scanning direction by the third anamorphic collimator lens 502.

The resulting light beam RE is passed through the third sub scanning aperture stop 503, passed through the third main scanning aperture stop 504, and incident on a deflection surface of the deflector 1.

The light beam RE emitted from the third light source 501 and incident on the deflection surface of the deflector 1 is deflected and scanned by the deflector 1, is then converged upon on the third scanned surface 508 by the third imaging optical system 85b, and scans the third scanned surface 508 at constant speed.

The light beam RF emitted from the emission point of the fourth light source 601 is converted into a parallel beam in the main scanning section and converged in the sub scanning direction by the fourth anamorphic collimator lens 602.

The resulting light beam RF is passed through the fourth sub scanning aperture stop 603, passed through the fourth main scanning aperture stop 604, and incident on the deflection surface of the deflector 1.

The light beam RF emitted from the fourth light source 601 and incident on the deflection surface of the deflector 1 is deflected and scanned by the deflector 1, is then converged upon on the fourth scanned surface 608 by the fourth imaging optical system 95b, and scans the fourth scanned surface 608 at constant speed.

Since the deflector 1 rotates in the direction of the arrow A in the diagram, the deflected and scanned light beams RC, RD, RE, and RF scan the first, second, third, and fourth scanned surfaces 308, 408, 508, and 608 in the direction of the arrow B in the diagram, respectively.

The deflection points (axial deflection points) of the principal rays of the axial light beams on the deflection surfaces of the deflector 1 are denoted by DO and E0. The deflection points D0 and E0 serve as reference points for the first, second, third, and fourth imaging optical systems 65b, 75b, 85b, and 95b.

In the present exemplary embodiment, first, second, third, and fourth photosensitive drums 308, 408, 508, and 608 are used as the first, second, third, and fourth scanned surfaces 308, 408, 508, and 608.

The exposure distributions on the first, second, third, and fourth photosensitive drums 308, 408, 508, and 608 in the sub scanning direction are formed by rotating the first, second, third, and fourth photosensitive drums 308, 408, 508, and 608 in the sub scanning direction upon each main scanning exposure.

Tables 13 to 15 below illustrate the characteristics of the first, second, third, and fourth incident optical systems 65a, 75a, 85a, and 95a, and the first, second, third, and fourth imaging optical systems 65b, 75b, 85b, and 95b of the optical scanning device 30 according to the present exemplary embodiment.

TABLE 13
Properties of light sources 301, 401, 501 and 601

| | | |
|---|---|---|
| Wavelength | λ | 790 |
| | (nm) | |
| Incident deflection to deflection surface 205 of | | p-polarized light |
| deflector 1 | | |
| Full angle at half maximum in main scanning | FFPy | 12.00 |
| direction | (deg) | |
| Full angle at half maximum in sub scanning | FFPz | 30.00 |
| direction | (deg) | |

Aperture shape

| | Main scanning | Sub scanning |
|---|---|---|
| | direction | direction |
| Sub scanning apertures 303, 403, 503 and 603 | 3.750 | 2.840 |
| Main scanning apertures 304, 404, 504 and 604 | 3.750 | 2.840 |

Refractive index

| | | |
|---|---|---|
| Anamorphic collimator lenses 302, 402, 502 and 602 | N1 | 1.5282 |

Optical element shape

| | | Main scanning | Sub scanning |
|---|---|---|---|
| | | direction | direction |
| Radius of curvature of incident surfaces of | r1a | ∞ | ∞ |
| anamorphic collimator lenses 302, 402, 502 and | (mm) | | |
| 602 | | | |
| Radius of curvature of exit surfaces of | r1b | −37.169 | −26.170 |
| anamorphic collimator lenses 302, 402 502 and | (mm) | | |
| 602 | | | |
| Phase coefficient of incident surfaces of the | DO | −7.847E−03 | −8.669E−03 |
| anamorphic collimator lenses 302, 402, 502 and | | | |
| 602 | | | |

Focal length

| | | Main | Sub |
|---|---|---|---|
| | | scanning | scanning |
| | | direction | direction |
| Anamorphic collimator lenses 302, 402, 502 and 602 | fcol (mm) | 33.94 | 27.15 |

Layout

| | | |
|---|---|---|
| From light sources 301, 401, 501 and 601 to incident | d0 (mm) | 33.59 |
| surfaces of anamorphic collimator lenses 302, 402, 502 | | |
| and 602 | | |
| From incident surfaces of anamorphic collimator lenses | d1 (mm) | 3.00 |
| 302, 402, 502 and 602 to exit surfaces of incident surfaces | | |
| of anamorphic collimator lenses 302, 402, 502 and 602 | | |
| From exit surfaces of incident surfaces of anamorphic | d2 (mm) | 15.15 |
| collimator lenses 302, 402, 502 and 602 to sub scanning | | |
| apertures 303, 403, 503 and 603 | | |
| From sub scanning apertures 303, 403, 503 and 603 to | d4 (mm) | 29.87 |
| Main scanning apertures 304, 404, 504 and 604 | | |
| From main scanning apertures 304, 404, 504 and 604 to | d5 (mm) | 80.09 |
| deflection surface of deflector 1 | | |
| Incident angle of light exited from main scanning aperture | A1 (deg) | 78.00 |
| 304 to deflection surface in main scanning section | | |
| Incident angle of light exited from main scanning aperture | A2 (deg) | 78.00 |
| 404 to deflection surface in main scanning section | | |
| Incident angle of light exited from main scanning aperture | A3 (deg) | 102.00 |
| 504 to deflection surface in main scanning section | | |
| Incident angle of light exited from main scanning aperture | A4 (deg) | 102.00 |
| 604 to deflection surface in main scanning section | | |
| Incident angle of light exited from main scanning aperture | A5 (deg) | 2.70 |
| 304 to deflection surface in sub scanning section | | |
| Incident angle of light exited from main scanning aperture | A6 (deg) | −2.70 |
| 404 to deflection surface in sub scanning section | | |
| Incident angle of light exited from main scanning aperture | A7 (deg) | −2.70 |
| 504 to deflection surface in sub scanning section | | |
| Incident angle of light exited from main scanning aperture | A8 (deg) | 2.70 |
| 604 to deflection surface in sub scanning section | | |

TABLE 14
fθ coefficient scanning angle, angle of view

| | | |
|---|---|---|
| fθ coefficient | k (mm/rad) | 207 |
| Scanning width | W (mm) | 330 |
| Maximum angle of view | θ (deg) | 45.7 |

Refractive index

| | | |
|---|---|---|
| Refractive index of fθ lenses 306 and 506 | N5 | 1.5282 |
| Refractive index of fθ lenses 307 and 507 | N6 | 1.5282 |

Deflector

| | | |
|---|---|---|
| Number of deflection surfaces | | 4 |
| Circumcircle radius | Rpol (mm) | 10 |
| Rotation center-deflection reference point D0 (optical axis | Xpol (mm) | 6.03 |
| direction) | | |
| Rotation center-deflection reference point D0 (main | Ypol (mm) | 3.79 |
| scanning direction) | | |

Scanning optical system, layout

| | | |
|---|---|---|
| From deflection reference point D0 to | d12 (mm) | 26.00 |
| incident surfaces of fθ lenses 306 and 506 | | |
| From incident surfaces of fe lenses 306 and 506 to | d13 (mm) | 8.20 |
| exit surfaces of fθ lenses 306 and 506 | | |
| From exit surfaces of fe lenses 306 and 506 to | d14 (mm) | 87.80 |
| incident surfaces of fθ lenses 307 and 507 | | |
| From incident surfaces of fθ lenses 307 and 507 to | d15 (mm) | 4.30 |
| exit surfaces of fθ lenses 307 and 507 | | |
| From exit surfaces of fθ lenses 307 and 507 to | d16 (mm) | 106.70 |
| photosensitive drums 308 and 508 | | |
| From deflection reference point D0 to | L1 (mm) | 26.00 |
| incident surfaces of fθ lenses 306 and 506 | | |
| From deflection reference point D0 to | L2 (mm) | 122.00 |
| incident surfaces of fθ lenses 307 and 507 | | |
| From deflection reference point D0 to | T2 (mm) | 233.00 |
| photosensitive drums 308 and 508 | | |
| Sub scanning decentering amount of fθ lenses 307 and | shiftZ (mm) | 9.06 |
| 507 | | |

| Generatrix shape of fθ lenses 306 and 506 | | | Generatrix shape of fθ lenses 307 and 507 | | |
|---|---|---|---|---|---|
| | Incident Surface | Exit Surface | | Incident Surface | Exit Surface |
| | Opposite light | Opposite light | | Opposite light | Opposite light |
| | source side | source side | | source side | source side |
| R | −71.974 | −44.323 | R | −4000 | 383.925 |
| ku | 8.921E−01 | −1.162E+00 | ku | 0 | −7.626E+01 |
| B4u | −7.612E−07 | −1.519E−06 | B4u | 0 | −1.344E−07 |
| B6u | 6.789E−09 | 1.750E−09 | B6u | 0 | 7.455E−12 |
| B8u | −5.889E−12 | 9.640E−13 | B8u | 0 | −3.304E−16 |
| B10u | 1.617E−15 | −1.195E−15 | B10u | 0 | 7.016E−21 |
| B12u | 0 | 0 | B12u | 0 | 0.000E+00 |

| | Light source side | Light source side | | Light source side | Light source side |
|---|---|---|---|---|---|
| kl | 8.921E−01 | −1.162E+00 | kl | 0 | −7.626E+01 |
| B4l | −7.612E−07 | −1.519E−06 | B4l | 0 | −1.344E−07 |
| B6l | 6.789E−09 | 1.750E−09 | B6l | 0 | 7.455E−12 |
| B8l | −5.889E−12 | 9.640E−13 | B8l | 0 | −3.304E−16 |
| B10l | 1.617E−15 | −1.195E−15 | B10l | 0 | 7.016E−21 |
| B12l | 0 | 0 | B12l | 0 | 0.000E+00 |
| Sagittal shape of fθ lenses 306 and 506 | | | Sagittal shape of fθ lenses 307 and 507 | | |
| | Incident Surface | Exit Surface | | Incident Surface | Exit Surface |
| | Sagittal curvature | Sagittal curvature | | Sagittal curvature | Sagittal curvature |
| | R change | R change | | R change | R change |
| r | 20.000 | 54.586 | r | 46.180 | −110.3864 |
| E1 | 0 | 0 | E1 | 0 | −7.53378E−07 |
| E2 | 0 | 3.970E−06 | E2 | 5.267E−09 | 1.78758E−06 |
| E3 | 0 | 0 | E3 | 0 | −7.47644E−10 |
| E4 | 0 | 9.864E−08 | E4 | 0 | −2.81187E−10 |
| E5 | 0 | 0 | E5 | 0 | 1.8249E−13 |
| E6 | 0 | −2.887E−10 | E6 | 0 | 4.07154E−14 |
| E7 | 0 | 0 | E7 | 0 | −1.73958E−17 |
| E8 | 0 | 3.62156E−13 | E8 | 0 | −3.24923E−18 |
| E9 | 0 | 0 | E9 | 0 | 5.08768E−22 |
| E10 | 0 | −1.61888E−16 | E10 | 0 | 9.97713E−23 |

| | Sagittal tilt | Sagittal tilt | | Sagittal tilt | Sagittal tilt |
|---|---|---|---|---|---|
| M0_1 | 0 | 1.136E−01 | M0_1 | 1.499E−01 | −7.953E−02 |
| M1_1 | 0 | 0 | M1_1 | 2.041E−05 | 1.318E−05 |
| M2_1 | 0 | −5.071E−05 | M2_1 | 3.507E−08 | 1.547E−05 |
| M3_1 | 0 | 0 | M3_1 | −4.837E−08 | −4.462E−08 |
| M4_1 | 0 | 0 | M4_1 | 5.229E−10 | −1.812E−09 |
| M5_1 | 0 | 0 | M5_1 | 1.018E−11 | 8.807E−12 |
| M6_1 | 0 | 0 | M6_1 | −2.073E−13 | 1.663E−13 |
| M7_1 | 0 | 0 | M7_1 | −9.447E−16 | −7.761E−16 |
| M8_1 | 0 | 0 | M8_1 | 2.868E−18 | −2.426E−17 |
| M9_1 | 0 | 0 | M9_1 | 2.861E−20 | 2.113E−20 |
| M10_1 | 0 | 0 | M10_1 | −7.599E−23 | 4.798E−22 |
| M11_1 | 0 | 0 | M11_1 | 0 | 0 |
| M12_1 | 0 | 0 | M12_1 | 0 | 0 |

TABLE 15
fθ coefficient scanning angle, angle of view

| | | |
|---|---|---|
| fθ coefficient | k (mm/rad) | 207 |
| Scanning width | W (mm) | 330 |
| Maximum angle of view | θ (deg) | 45.7 |

Refractive index

| | | |
|---|---|---|
| Refractive index of fθ lenses 406 and 606 | N5 | 1.5282 |
| Refractive index of fθ lenses 407 and 607 | N6 | 1.5282 |

Deflector

| | | |
|---|---|---|
| Number of deflection surfaces | | 4 |
| Circumcircle radius | Rpol (mm) | 10 |
| Rotation center-deflection reference point E0 (optical axis | Xpol (mm) | −6.03 |
| direction) | | |
| Rotation center-deflection reference point E0 (main | Ypol (mm) | 3.79 |
| scanning direction) | | |

Scanning optical system, layout

| | | |
|---|---|---|
| From deflection reference point E0 to | d12 (mm) | 26.00 |
| incident surfaces of fθ lenses 406 and 606 | | |
| From incident surfaces of fθ lenses 406 and 606 to | d13 (mm) | 8.20 |
| exit surfaces of fθ lenses 406 and 606 | | |
| From exit surfaces of fθ lenses 406 and 606 to | d14 (mm) | 66.60 |
| incident surfaces of fθ lenses 407 and 607 | | |
| From incident surfaces of fθ lenses 407 and 607 to | d15 (mm) | 4.30 |
| exit surfaces of fθ lenses 407 and 607 | | |
| From exit surfaces of fθ lenses 407 and 607 to | d16 (mm) | 127.90 |
| photosensitive drums 408 and 608 | | |
| From deflection reference point E0 to | L3 (mm) | 26.00 |
| incident surfaces of fθ lenses 406 and 606 | | |
| From deflection reference point E0 to | L4 (mm) | 100.80 |
| incident surfaces of fθ lenses 407 and 607 | | |
| From deflection reference point E0 to | T2 (mm) | 233.00 |
| photosensitive drums 408 and 608 | | |
| Sub scanning decentering amount of fθ lenses 407 and | shiftZ (mm) | 5.96 |
| 607 | | |

| Generatrix shape of fθ lenses 406 and 606 | | | Generatrix shape of fθ lenses 407 and 607 | | |
|---|---|---|---|---|---|
| | Incident Surface | Exit Surface | | Incident Surface | Exit Surface |
| | Opposite light | Opposite light | | Opposite light | Opposite light |
| | source side | source side | | source side | source side |
| R | −71.974 | −43.211 | R | −4000 | 345.598 |
| ku | 8.921E−01 | −5.727E−01 | ku | 0 | −9.021E+01 |
| B4u | −7.612E−07 | −1.995E−07 | B4u | 0 | −2.166E−07 |
| B6u | 6.789E−09 | 1.645E−09 | B6u | 0 | 1.801E−11 |
| B8u | −5.889E−12 | 1.272E−12 | B8u | 0 | −1.069E−15 |
| B10u | 1.617E−15 | −1.418E−15 | B10u | 0 | 2.983E−20 |
| B12u | 0 | 0 | B12u | 0 | 0 |

| | Light source side | Light source side | | Light source side | Light source side |
|---|---|---|---|---|---|
| kl | 8.921E−01 | −5.727E−01 | kl | 0 | −9.021E+01 |
| B4l | −7.612E−07 | −1.995E−07 | B4l | 0 | −2.166E−07 |
| B6l | 6.789E−09 | 1.645E−09 | B6l | 0 | 1.801E−11 |
| B8l | −5.889E−12 | 1.272E−12 | B8l | 0 | −1.069E−15 |
| B10l | 1.617E−15 | −1.418E−15 | B10l | 0 | 2.983E−20 |
| B12l | 0 | 0 | B12l | 0 | 0 |

| Sagittalshape of fθ lenses 406 and 606 | | | Sagittalshape of fθ lenses 407 and 607 | | |
|---|---|---|---|---|---|
| | Incident Surface | Exit Surface | | Incident Surface | Exit Surface |
| | Sagittal | Sagittal | | Sagittal | Sagittal |
| | curvature | curvature | | curvature | curvature |
| | R change | R change | | R change | R change |
| r | 20.000 | 20.586 | r | 26.855 | 294.0214 |
| E1 | 0 | 0 | E1 | 0 | 1.96971E−07 |
| E2 | 0 | 1.558E−05 | E2 | −5.144E−06 | −2.36769E−06 |
| E3 | 0 | 0 | E3 | 0 | −3.44358E−09 |
| E4 | 0 | −3.394E−08 | E4 | 0 | −2.46843E−10 |
| E5 | 0 | 0 | E5 | 0 | 1.49969E−12 |
| E6 | 0 | 3.964E−11 | E6 | 0 | 1.69237E−14 |
| E7 | 0 | 0 | E7 | 0 | −2.50442E−16 |
| E8 | 0 | −6.55816E−14 | E8 | 0 | −1.79515E−18 |
| E9 | 0 | 0 | E9 | 0 | 1.40544E−20 |
| E10 | 0 | 5.40111E−17 | E10 | 0 | 7.11738E−23 |

| | Sagittal tilt | Sagittal tilt | | Sagittal tilt | Sagittal tilt |
|---|---|---|---|---|---|
| M0_1 | 0 | 3.928E−02 | M0_1 | −1.514E−01 | 1.072E−02 |
| M1_1 | 0 | 0 | M1_1 | −5.638E−06 | 2.983E−06 |
| M2_1 | 0 | −3.676E−05 | M2_1 | −2.604E−05 | −4.002E−05 |
| M3_1 | 0 | 0 | M3_1 | 1.312E−07 | 1.175E−07 |
| M4_1 | 0 | 0 | M4_1 | 5.689E−09 | 7.909E−09 |
| M5_1 | 0 | 0 | M5_1 | −3.827E−11 | −3.145E−11 |
| M6_1 | 0 | 0 | M6_1 | 8.340E−14 | −6.667E−13 |
| M7_1 | 0 | 0 | M7_1 | 5.134E−15 | 3.847E−15 |
| M8_1 | 0 | 0 | M8_1 | −2.894E−17 | 8.307E−17 |
| M9_1 | 0 | 0 | M9_1 | −2.202E−19 | −1.374E−19 |
| M10_1 | 0 | 0 | M10_1 | −5.517E−22 | −5.821E−21 |
| M11_1 | 0 | 0 | M11_1 | 0 | 0 |
| M12_1 | 0 | 0 | M12_1 | 0 | 0 |

The radius of curvature r′ in the sub scanning section changes continuously with the y coordinate of the lens surface.

Next, the effects of the optical scanning device 30 according to the present exemplary embodiment will be described.

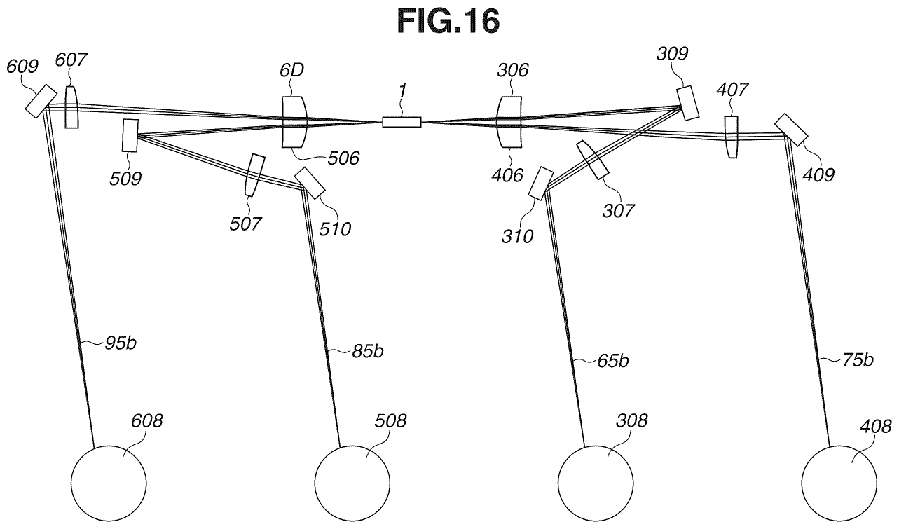

FIG. 16 illustrates a folded layout of the optical scanning device 30 according to the present exemplary embodiment, using reflective elements.

As illustrated in FIG. 16, the first imaging optical system 65b includes reflecting mirrors 309 and 310. The second imaging optical system 75b includes a reflecting mirror 409. The third imaging optical system 85b includes reflecting mirrors 509 and 510. The fourth imaging optical system 95b includes a reflecting mirror 609.

Reflective elements with vapor deposition films are used as the reflecting mirrors 309, 310, 409, 509, 510, and 609.

In the present exemplary embodiment, the light emitted from the first fθ lens 306 of the first imaging optical system 65b is deflected and reflected by the reflecting mirror 309, passed through the second fθ lens 307, reflected and deflected by the reflecting mirror 310, and guided to the photosensitive drum 308. The light emitted from the second fθ lens 407 of the second imaging optical system 75b is deflected and reflected by the reflecting mirror 409, and guided to the photosensitive drum 408. The light emitted from the first fθ lens 506 of the third imaging optical system 85b is deflected and reflected by the reflecting mirror 509, passed through the second fθ lens 507, deflected and reflected by the reflecting mirror 510, and guided to the photosensitive drum 508. The light emitted from the second fθ lens 607 of the fourth imaging optical system 95b is deflected and reflected by the reflecting mirror 609, and guided to the photosensitive drum 608.

If the distance between the photosensitive drums 308 and 408 is reduced to miniaturize the image forming apparatus and the second fθ lenses 307 and 407 of the first and second imaging optical systems 65b and 75b are located at optically equivalent distances from the deflector 1, the second fθ lenses 307 and 407 interfere with the light beams RC and RD.

If the distance between the photosensitive drums 508 and 608 is reduced and the second fθ lenses 507 and 607 of the third and fourth imaging optical systems 85b and 95b are located at optically equivalent distances from the deflector 1, the second θ lenses 507 and 607 interfere with the light beams RE and RF.

To solve this issue, in the present exemplary embodiment, the second fθ lens 307 of the first imaging optical system 65b is located closer to the deflector 1 than the second fθ lens 407 of the second imaging optical system 75b. The second fθ lens 507 of the third imaging optical system 85b is located closer to the deflector 1 than the second fθ lens 607 of the fourth imaging optical system 95b.

Such a layout prevents interference between the fθ lenses and the light beams while reducing the size of the image forming apparatus.

However, since the second fθ lenses 307 and 407 of the first and second imaging optical systems 65b and 75b are located at difference positions, the first fθ lenses 306 and 406 of the imaging optical systems 65b and 75b desirably have different power in the substrate scanning direction to make the sub scanning magnifications (imaging magnifications in the sub scanning section) of the respective imaging optical systems approximately the same.

Table 16 illustrates the characteristics of the first fθ lenses 306, 406, 506, and 606, and the second fθ lenses 307, 407, 507, and 607 according to the present exemplary embodiment.

TABLE 16

| | fθ lenses 306 and 506 | | | fθ lenses 406 and 606 | | |
|---|---|---|---|---|---|---|
| | Incident | Exit | Entire | Incident | Exit | Entire |
| | Surface | Surface | system | Surface | Surface | system |
| Refractive index | 1.5282 | | | 1.5282 | | |
| Thickness | 8.2 | | | 8.2 | | |
| Radius of | 20 | 54.586 | — | 20 | 20.586 | — |
| curvature | | | | | | |
| Refractive | 0.0264 | −0.0097 | 0.0181 | 0.0264 | −0.0257 | 0.0044 |
| power | | | | | | |
| Tilt amount | 0 | 0.1136 | — | 0 | 0.0393 | — |
| (M0_1) | | | | | | |
| Focal length | 37.865 | −103.345 | 55.235 | 37.865 | −38.974 | 227.912 |

| | fθ lenses 307 and 507 | | | fθ lenses 407 and 607 | | |
|---|---|---|---|---|---|---|
| | Incident | Exit | Entire | Incident | Exit | Entire |
| | Surface | Surface | system | Surface | Surface | system |
| Refractive index | 1.5282 | | | 1.5282 | | |
| Thickness | 4.3 | | | 4.3 | | |
| Radius of | 46.180 | −110.386 | — | 26.855 | 294.021 | — |
| curvature | | | | | | |
| Refractive | 0.0114 | 0.0048 | 0.0161 | 0.0197 | −0.0018 | 0.0180 |
| power | | | | | | |
| Tilt amount | 0.1499 | −0.0795 | — | −0.15136 | 0.0107 | — |
| (M0_1) | | | | | | |
| Focal length | 87.430 | 208.989 | 62.233 | 50.843 | −556.657 | 55.644 |

In the present exemplary embodiment, the exit surfaces of the first fθ lenses 306 and 506 of the optical scanning device 30 have a sagittal curvature of 54.586 on the optical axis (near the axis). The exit surfaces of the first fθ lenses 406 and 606 have a sagittal curvature of 20.586 near the axis.

The compact configuration described above is achieved by thus making the sagittal curvatures of the exit surfaces of the first fθ lenses 306 and 506 and those of the first fθ lenses 406 and 606 different from each other.

In the present exemplary embodiment, as illustrated in Tables 14 and 15, the exit surfaces of the first fθ lenses 306, 406, 506, and 606 are surfaces of which the sagittal curvatures change in the main scanning direction.

The difference in the irradiation position deviations caused by the optical scanning device 30 on the photosensitive drums 308 and 408 is reduced by satisfying |θ2|≥|θ1| and −2.5<θ2/θ1<2.5, where θ1 is the incident angle of the principal ray of the first light beam RC on the deflector 1 in the sub scanning direction, and θ2 is the incident angle of the principal ray of the second light beam RD in the sub scanning direction.

In the present exemplary embodiment, the incident angle θ1 of the principal ray of the first light beam RC in the sub scanning direction is 2.7°. The incident angle θ2 of the principal ray of the second light beam RD in the sub scanning direction is-2.7°.

If the deflector 1 of the optical scanning device 30 moves by 15 μm in the optical axis direction, the principal rays move by 1.5 μm on the photosensitive drum 108, by −1.5 μm on the photosensitive drum 408, by 1.5 μm on the photosensitive drum 508, and by −1.5 μm on the photosensitive drum 608.

The relative difference is 3 μm. With a resolution of 600 dpi, the difference has an impact of approximately 7% on the 42.3-μm pitch, and the image quality is not much affected.

In the present exemplary embodiment, |θ2|=|θ1| and θ2/θ1=−1. This satisfies |θ2|≥|θ1| and −2.5<θ2/θ1<2.5.

As a result, the amount of positional deviation caused by the optical scanning device 30 on the photosensitive drums 308, 408, 508, and 608 is reduced.

In the present exemplary embodiment, the optical device 30 includes an optical path including the two reflective elements 309 and 310 and an optical path including the one reflective element 409, where the signs of the oblique incident angles are opposite. With such a configuration, the deviations on the photosensitive drums 308 and 408 due to a positional deviation of the deflector 1 occur in the same direction.

In the present exemplary embodiment, the optical device 30 includes an optical path including the two reflective elements 509 and 510 and an optical path including the one reflective element 609, where the signs of the oblique incident angles are opposite. With such a configuration, the deviations on the photosensitive drums 508 and 608 due to a positional deviation of the deflector 1 occur in the same direction.

The configuration that θ2/θ1<0 and the difference between the numbers of reflective elements included in the optical paths of the optical scanning device 30 is an odd number further reduces the amount of positional deviation.

As a result, the amount of positional deviation caused by the optical scanning device 30 on the photosensitive drums is further reduced.

In the present exemplary embodiment, the relative difference is 0 μm, and the impact on the image quality is further reduced.

As a modification of the present exemplary embodiment, in a case where θ1 is 2.7° and θ2 is −6.7°, this yields θ2/θ1=−2.48.

In such a case, if the deflector 1 of the optical scanning device 30 moves by 15 μm in the optical axis direction, the principal rays move by 1.5 μm on the photosensitive drum 308, by −3.72 μm on the photosensitive drum 408, by 1.5 μm on the photosensitive drum 508, and by −3.72 μm on the photosensitive drum 608.

The relative difference is 5.22 μm. With a resolution of 600 dpi, the difference has an impact of approximately 12.3% on the 42.3-μm pitch.

In this modification, since θ2/θ1<0, the amount of positional deviation is further reduced if the difference between the numbers of reflective elements included in the optical scanning device 30 is an odd number.

As another modification of the present exemplary embodiment, in a case where θ1 is 1.1° and θ2 is 2.7°, this yields θ2/θ1=2.45.

In such a case, if the deflector 1 of the optical scanning device 30 moves by 15 μm in the optical axis direction, the principal rays move by 0.6 μm on the photosensitive drum 308, by 1.5 μm on the photosensitive drum 408, by 0.6 μm on the photosensitive drum 508, and by 1.5 μm on the photosensitive drum 608.

The relative difference is 0.9 μm. With a resolution of 600 dpi, the difference has an impact of approximately 2.1% on the 42.3-μm pitch.

In this modification, since θ2/θ1>0, the amount of positional deviation is further reduced if the difference between the numbers of reflective elements included in the optical scanning device 30 is an even number.

In such a case, if the deflector 1 of the optical scanning device 30 moves by 15 μm in the optical axis direction, the ray L3 moves by 1.5 μm from the ray L2 on the photosensitive drum 308. The ray L3 moves by −3.72 μm from the ray L2 on the photosensitive drum 408.

The first fθ lenses 306 and 406 and the first fθ lenses 506 and 606 used in the present exemplary embodiment desirably consist of integrally molded lenses in view of miniaturization and a reduction in image quality difference.

The fθ lenses 306 and 307 and the fθ lenses 506 and 507, as well as the fe lenses 406 and 407 and the fθ lenses 606 and 607, desirably consist of respective different lenses in view of miniaturization since the degree of freedom in layout increases.

Effects similar to those of the present exemplary embodiment are obtainable even if the incident surfaces of the first fθ lenses 306, 406, 506, and 606 have different sagittal curvatures like the exit surfaces.

With the foregoing configuration, the optical scanning device 30 according to the present exemplary embodiment provides a compact optical scanning device while reducing a difference in image quality.

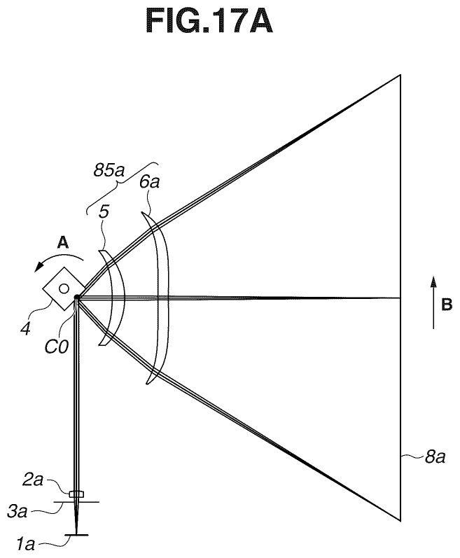

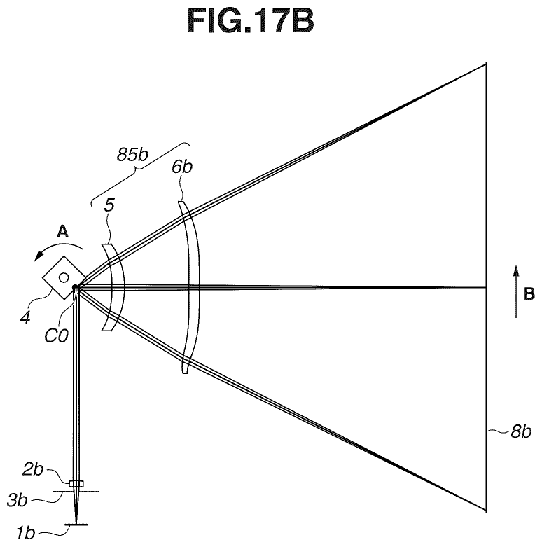

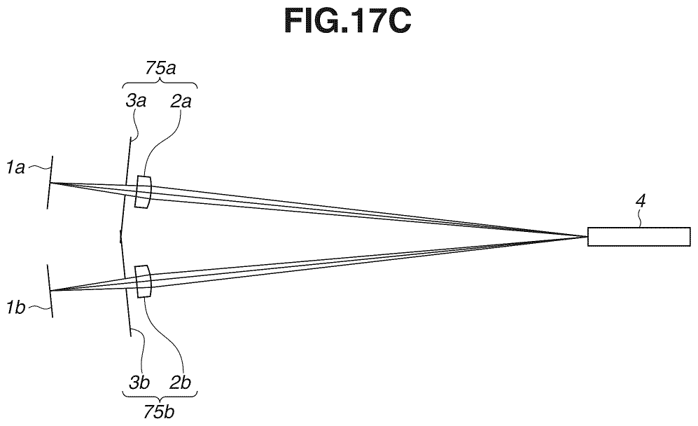

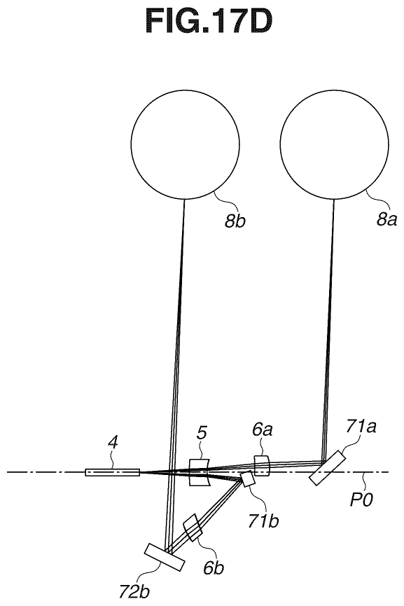

FIGS. 17A and 17B are optical path diagrams of essential parts of an optical scanning device 100 according to a fifth exemplary embodiment in main scanning sections. FIGS. 17C and 17D are sub scanning sectional views of incident optical systems and imaging optical systems included in the optical scanning device 100 according to the fifth exemplary embodiment.

The optical scanning device 100 according to the present exemplary embodiment includes first and second light sources 1 and 1b, first and second anamorphic lenses 2a and 2b, and first and second aperture stops 3a and 3b.

The optical scanning device 100 according to the present exemplary embodiment also includes a deflector 4, a first fθ lens (first optical element) 5, second fθ lenses 6a and 6b, and reflective members 71a, 71b, and 72a.

Semiconductor lasers are used as the first and second light sources 1a and 1b.

The first and second anamorphic lenses 2a and 2b have different positive powers (refractive powers) in the main scanning direction and the sub scanning direction separately so that the light beams emitted from the light sources 1a and 1b are converted into approximately parallel beams in the main scanning direction and converge in the sub scanning direction.

The first and second aperture stops 3a and 3b limit the beam diameters of light beams RA and RB emitted from the first and second light sources 1a and 1b.

In such a manner, the light beams RA and RB emitted from the first and second light sources 1a and 1b are converged near a deflection surface 41 of the deflector 4 only in the sub scanning direction, and formed as line images long in the main scanning direction.

The deflector 4 is rotated in the direction of the arrow A in the diagram by a not-illustrated driving unit such as a motor, and thereby deflects the light beams RA and RB incident on the deflector 4. The deflector 4 consists of a polygon mirror, for example.

The first fθ lens 5 and the second fθ lenses 6a and 6b are anamorphic imaging lenses having different power in the main scanning section and the sub scanning section. The first fθ lens 5 and the second fθ lenses 6a and 6b converge (guide) the light beams RA and RB deflected by the deflection surface 41 of the deflector 4 onto first and second scanned surfaces 8a and 8b.

The first fθ lens 5 is a multi-stage lens where a first optical portion 5a and a second optical portion 5b are arranged in the sub scanning direction. More specifically, the incident surface of the fθ lens 5 consists of the incident surface of the first optical portion 5a and the incident surface of the second optical portion 5b. The exit surface of the fθ lens 5 consists of the exit surface of the first optical portion 5a and the exit surface of the second optical portion 5b. The exit surfaces of the first and second optical portions 5a and 5b have respective different lens surface shapes.

The reflective members 71a, 71b, and 72a are units for reflecting a light beam. Vapor deposition mirrors are used as the reflective members 71a, 71b, and 72a.

In the optical scanning device 100 according to the present exemplary embodiment, a first incident optical system 75a consists of the first anamorphic lens 2a and the first aperture stop 3a. A second incident optical system 75b consists of the second anamorphic lens 2b and the second aperture stop 3b.

In the optical scanning device 100 according to the present exemplary embodiment, a first imaging optical system 85a consists of the first optical portion 5a of the first fθ lens 5 and the second fθ lens 6a. A second imaging optical system 85b consists of the second optical portion 5b of the first fθ lens 5 and the second fθ lens 6b.

In the optical scanning device 100 according to the present exemplary embodiment, the optical axes of the first and second incident optical systems 75a and 75b form an angle of −3.0° and +3.0° with the main scanning section, respectively, in the sub scanning section.

The light beam RA emitted from the emission point of the first light source 1a passes through the first aperture stop 3a, and is then converted into a parallel beam in the main scanning direction and converged in the sub scanning direction by the first anamorphic lens 2a.

The resulting light beam RA is then incident on the deflection surface 41 of the deflector 4 from above in the sub scanning direction.

The light beam RA emitted from the first light source 1a and incident on the deflection surface 41 of the deflector 4 is deflected by the deflector 4, is then converged upon the first scanned surface 8a by the first imaging optical system 85a, and scans the first scanned surface 8a at constant speed.

The light beam RB emitted from the emission point of second light source 1b passes through the second aperture stop 3b, and is then converted into a parallel beam in the main scanning direction and converged in the sub scanning direction by the second anamorphic lens 2a.

The resulting light beam RB is then incident on the deflection surface 41 of the deflector 4 from below in the sub scanning direction.

The light beam RB emitted from the second light source 1b and incident on the deflection surface 41 of the deflector 4 is deflected by the deflector 4, is then converged upon the second scanned surface 8b by the second imaging optical system 85b, and scans the second scanned surface 8b at constant speed.

Since the deflector 4 rotates in the direction of the arrow A in the diagram, the deflected light beams RA and RB scan the first and second scanned surfaces 8a and 8b in the direction of the arrow B in the diagram, respectively.

The deflection point (axial deflection point) of the principal rays of the axial light beams on the deflection surface 41 of the deflector 4 is denoted by C0. In the sub scanning direction, the light beams RA and RB emitted from the first and second light sources 1a and 1b intersect at the deflection point C0. The deflection point C0 also serves as a reference point for the first and second imaging optical systems 85a and 85b. The plane (reference plane) that intersects with the deflection point C0 and is perpendicular to the rotation axis of the deflector 4 is denoted by P0. In the following description, the lengths of the optical paths from the deflection point C0 to the scanned surfaces will be referred to as optical path lengths.

In the present exemplary embodiment, first and second photosensitive drums 8a and 8b are used as the first and second scanned surfaces 8a and 8b.

The exposure distributions on the first and second photosensitive drums 8a and 8b in the sub scanning direction are formed by rotating the first and second photosensitive drums 8a and 8b in the sub scanning direction upon each main scanning exposure.

Tables 17 and 18 below illustrate the characteristics of the first and second incident optical systems 75a and 75b and the first and second imaging optical systems 85a and 85b of the optical scanning device 100 according to the present exemplary embodiment.

TABLE 17
Configuration of incident optical system 75a and layout of imaging optical system 85a

| | | |
|---|---|---|
| Use wavelength | λ (nm) | 792 |
| Number of Light emissions | n | 4 |
| Laser cover glass thickness | d1 (mm) | 0.250 |
| Laser cover glass refractive index | n1 | 1.510 |
| From light source light emission point to aperture stop | d2 (mm) | 16.000 |
| From aperture stop to incident surface of anamorphic lens | d3 (mm) | 2.321 |
| Anamorphic lens thickness | d4 (mm) | 3.000 |
| Anamorphic lens refractive index | n2 | 1.528 |
| Main incident surface of anamorphic lens | R1m (mm) | ∞ |
| Sub incident surface of anamorphic lens | R1s (mm) | ∞ |
| Radius of curvature of exit surface of anamorphic lens in | R2m (mm) | −14.990 |
| main scanning direction | | |
| Radius of curvature of exit surface of anamorphic lens in sub | R2s (mm) | −12.500 |
| scanning direction | | |
| From exit surface of anamorphic lens to deflection reference | d5 (mm) | 92.679 |
| point | | |
| Deflection reference point to incident surface of first fθ lens | d6 (mm) | 17.200 |
| First fθ lens thickness | d8 (mm) | 6.000 |
| First fθ lens refractive index | n3 | 1.528 |
| From exit surface of first fθ lens to reflective member | d8 (mm) | 10.000 |
| From reflective member to incident surface of second fθ lens | d9 (mm) | 29.939 |
| Second fθ lens thickness | d10 (mm) | 5.000 |
| Second fθ lens refractive index | n4 | 1.528 |
| From deflection reference point to scanned surface | (mm) | 155.733 |
| Incident angle of light on deflector 4 in main scanning | α (degree) | 90.000 |
| direction in optical system | | |
| Incident angle of light on deflector 4 in sub scanning | β (degree) | −3.000 |
| direction in optical system | | |
| fθ coefficient | K (mm/rad) | 131.000 |
| Effective scanning angle | θ (degree) | ±46.76 |
| Effective scanning width | W (mm) | ±107 |
| Number of surfaces of deflector 4 | surface | 4 |
| Circumcircle radius of deflector 4 | Rpol (mm) | 10 |
| Center position of deflector 4 | PX (mm) | −5.683 |
| Center position of deflector 4 | PY (mm) | 4.315 |
| Aperture stop diameter | Rectangle (mm) | Main 1.80 × |
| | | Sub 1.02 |

Lens surface data of imaging optical system 85a

| | | first fθ lens 5 | | second fθ lens 6a | |
|---|---|---|---|---|---|
| | | Incident | Exit | Incident | Exit |
| | | Surface | Surface | Surface | Surface |
| Generatrix | R | −64.070 | −33.831 | −5853.774 | 709.507 |
| | ky | −22.378 | 0.528 | −19151.604 | −208.498 |
| | B1 | 0.000E+00 | 0.000E+00 | 0.000E+00 | 0.000E+00 |
| | B2 | 0.000E+00 | 0.000E+00 | 0.000E+00 | 0.000E+00 |
| | B3 | 0.000E+00 | 0.000E+00 | 0.000E+00 | 0.000E+00 |
| | B4 | −1.870E−05 | 2.719E−06 | −8.385E−07 | −3.549E−06 |
| | B5 | 8.164E−21 | −2.652E−21 | −1.786E−08 | −1.167E−08 |
| | B6 | 2.176E−08 | −5.981E−09 | −1.622E−09 | 7.769E−10 |
| | B7 | −2.023E−23 | 6.395E−24 | −8.922E−12 | −1.201E−11 |
| | B8 | −2.559E−11 | 8.325E−12 | 3.331E−13 | −1.172E−12 |
| | B9 | 1.550E−26 | −4.750E−27 | 1.686E−14 | 1.363E−14 |
| | B10 | 1.700E−27 | −6.424E−28 | 5.755E−17 | 5.347E−16 |
| | B11 | −3.733E−30 | 1.102E−30 | −5.111E−18 | −3.965E−18 |
| | B12 | −3.397E−31 | 1.251E−31 | 5.947E−35 | −1.496E−19 |
| Sagittal | r | 13.000 | 12.190 | 23.647 | −49.374 |
| | E1 | 0.000E+00 | 0.000E+00 | −4.662E−06 | −6.246E−06 |
| | E2 | 0.000E+00 | −4.892E−04 | 1.575E−04 | 1.444E−04 |
| | E3 | 0.000E+00 | 0.000E+00 | 1.304E−07 | 1.642E−07 |
| | E4 | 0.000E+00 | 4.864E−06 | −2.760E−07 | −1.971E−07 |
| | E5 | 0.000E+00 | 0.000E+00 | −8.910E−11 | −2.163E−10 |
| | E6 | 0.000E+00 | −1.650E−08 | 3.966E−10 | 2.368E−10 |
| | E7 | 0.000E+00 | 0.000E+00 | −2.215E−13 | −1.575E−13 |
| | E8 | 0.000E+00 | 2.665E−11 | −2.699E−13 | −1.288E−13 |
| | E9 | 0.000E+00 | 0.000E+00 | 3.219E−16 | 3.251E−16 |
| | E10 | 0.000E+00 | −1.267E−14 | 6.337E−17 | 2.216E−17 |
| | E11 | 0.000E+00 | 0.000E+00 | −2.206E−20 | −5.317E−20 |
| | E12 | 0.000E+00 | 0.000E+00 | −2.185E−33 | −1.512E−33 |
| | m0_1 | 0.000E+00 | 0.000E+00 | −1.336E−02 | −5.508E−02 |
| | m1_1 | 0.000E+00 | 0.000E+00 | 1.134E−04 | 1.551E−04 |
| | m2_1 | 0.000E+00 | 1.423E−04 | −9.300E−05 | −7.636E−05 |
| | m3_1 | 0.000E+00 | 0.000E+00 | 1.425E−06 | 6.130E−07 |
| | m4_1 | 0.000E+00 | −3.019E−07 | 9.189E−08 | 5.200E−08 |
| | m5_1 | 0.000E+00 | 0.000E+00 | −4.045E−09 | −8.988E−10 |
| | m6_1 | 0.000E+00 | −1.535E−09 | −1.340E−10 | −8.066E−11 |
| | m7_1 | 0.000E+00 | 0.000E+00 | 4.641E−12 | −3.071E−13 |
| | m8_1 | 0.000E+00 | 3.510E−12 | 8.000E−14 | 1.465E−14 |
| | m9_1 | 0.000E+00 | 0.000E+00 | −2.141E−15 | 1.282E−15 |
| | m10_1 | 0.000E+00 | 0.000E+00 | −7.126E−17 | −1.705E−18 |
| | m11_1 | 0.000E+00 | 0.000E+00 | 2.315E−19 | −6.196E−19 |
| | m12_1 | 0.000E+00 | 0.000E+00 | 1.993E−20 | −4.353E−21 |

TABLE 18
Configuration of incident optical system 75b•and layout of imaging optical system 85b

| | | |
|---|---|---|
| Use wavelength | λ (nm) | 790 |
| Number of Light emissions | n | 4 |
| Laser cover glass thickness | d1 (mm) | 0.250 |
| Laser cover glass refractive index | n1 | 1.510 |
| From light source light emission point to aperture stop | d2 (mm) | 16.000 |
| From aperture stop to incident surface of anamorphic lens | d3 (mm) | 2.321 |
| Anamorphic lens thickness | d4 (mm) | 3.000 |
| Anamorphic lens refractive index | n2 | 1.528 |
| Main incident surface of anamorphic lens | R1m (mm) | ∞ |
| Sub incident surface of anamorphic lens | R1s (mm) | ∞ |
| Radius of curvature of exit surface of anamorphic lens in | R2m (mm) | −15.100 |
| main scanning direction | | |
| Radius of curvature of exit surface of anamorphic lens in sub | R2s (mm) | −12.500 |
| scanning direction | | |
| From exit surface of anamorphic lens to deflection reference | d5 (mm) | 92.679 |
| point | | |
| Deflection reference point to incident surface of first fθ lens | d6 (mm) | 17.200 |
| First fθ lens thickness | d7 (mm) | 6.000 |
| First fθ lens refractive index | n3 | 1.528 |
| From exit surface of first fθ lens to incident surface of second | d8 (mm) | 30.939 |
| fθ lens | | |
| Second fθ lens thickness | d9 (mm) | 5.000 |
| Second fθ lens refractive index | n4 | 1.528 |
| From exit surface of Second fθ lens to reflective member | d10 (mm) | 15.000 |
| From deflection reference point to scanned surface | (mm) | 197.000 |
| Incident angle of light on deflector 4 in main scanning | α (degree) | 90.000 |
| direction in optical system | | |
| Incident angle of light in deflector 4 in sub scanning direction | β (degree) | 3.000 |
| in optical system | | |
| fθ coefficient | K (mm/rad) | 167.000 |
| Effective scanning angle | θ (degree) | ±46.18 |
| Effective scanning width | W (mm) | ±107 |
| Number of surfaces of deflector 4 | Surface | 4 |
| Circumcircle radius of deflector 4 | Rpol (mm) | 10 |
| Center position of deflector 4 | PX (mm) | −5.683 |
| Center position of deflector 4 | PY (mm) | 4.315 |
| Aperture stop diameter | Rectangle (mm) | Main 2.30 × |
| | | Sub 2.00 |

Lens surface data of imaging optical system 85b

| | | first fθ lens 5 | | Second fθ lens 6b | |
|---|---|---|---|---|---|
| | | Incident | Exit | Incident | Exit |
| | | Surface | Surface | Surface | Surface |
| Generatrix | R | −64.070 | −40.165 | 846.690 | 9931.528 |
| | ky | −22.378 | −0.628 | −6220.656 | −105244.770 |
| | B1 | 0.000E+00 | 0.000E+00 | 0.000E+00 | 0.000E+00 |
| | B2 | 0.000E+00 | 0.000E+00 | 0.000E+00 | 0.000E+00 |
| | B3 | 0.000E+00 | 0.000E+00 | 0.000E+00 | 0.000E+00 |
| | B4 | −1.870E−05 | −5.854E−06 | −3.973E−06 | −4.507E−06 |
| | B5 | 0.000E+00 | 0.000E+00 | 6.971E−09 | 8.253E−09 |
| | B6 | 2.176E−08 | 8.722E−09 | 7.602E−10 | 1.468E−09 |
| | B7 | 0.000E+00 | 0.000E+00 | 5.237E−12 | −3.439E−12 |
| | B8 | −2.559E−11 | −1.408E−11 | 8.432E−13 | −6.848E−13 |
| | B9 | 0.000E+00 | 0.000E+00 | −1.092E−14 | 2.878E−15 |
| | B10 | 1.700E−27 | −3.667E−28 | −2.691E−16 | 5.396E−16 |
| | B11 | 0.000E+00 | 0.000E+00 | 1.147E−18 | −3.887E−18 |
| | B12 | −3.397E−31 | 6.470E−32 | −2.617E−32 | −1.236E−19 |
| Sagittal | r | 50.000 | 12.190 | 23.647 | −49.374 |
| | E1 | 0.000E+00 | 0.000E+00 | 3.847E−06 | −2.426E−06 |
| | E2 | 0.000E+00 | −8.388E−05 | 5.230E−05 | 5.196E−05 |
| | E3 | 0.000E+00 | 0.000E+00 | −1.298E−07 | 2.595E−08 |
| | E4 | 0.000E+00 | 4.939E−08 | −8.912E−08 | −7.165E−08 |
| | E5 | 0.000E+00 | 0.000E+00 | 1.182E−10 | −2.452E−10 |
| | E6 | 0.000E+00 | −7.383E−12 | 9.781E−11 | 6.167E−11 |
| | E7 | 0.000E+00 | 0.000E+00 | 1.065E−12 | 9.428E−13 |
| | E8 | 0.000E+00 | 3.776E−27 | −5.764E−14 | −2.371E−14 |
| | E9 | 0.000E+00 | 0.000E+00 | −7.913E−16 | −3.947E−16 |
| | E10 | 0.000E+00 | −1.889E−30 | 2.540E−18 | −5.190E−18 |
| | E11 | 0.000E+00 | 0.000E+00 | −7.988E−20 | −1.353E−19 |
| | E12 | 0.000E+00 | 3.516E−34 | −1.617E−33 | −1.819E−33 |
| | m0_1 | 0.000E+00 | 5.501E−02 | 3.406E−01 | 2.277E−01 |
| | m1_1 | 0.000E+00 | 0.000E+00 | 3.141E−05 | 3.569E−05 |
| | m2_1 | 0.000E+00 | 2.145E−04 | −2.234E−05 | 1.717E−05 |
| | m3_1 | 0.000E+00 | 0.000E+00 | 7.213E−07 | 5.927E−07 |
| | m4_1 | 0.000E+00 | −6.292E−07 | 5.307E−08 | −5.146E−09 |
| | m5_1 | 0.000E+00 | 0.000E+00 | 5.825E−10 | 4.545E−10 |
| | m6_1 | 0.000E+00 | −1.858E−11 | −9.397E−11 | −1.642E−11 |
| | m7_1 | 0.000E+00 | 0.000E+00 | −4.123E−12 | −2.419E−12 |
| | m8_1 | 0.000E+00 | −1.555E−26 | 1.811E−15 | −2.804E−14 |
| | m9_1 | 0.000E+00 | 0.000E+00 | 5.008E−15 | 2.511E−15 |
| | m10_1 | 0.000E+00 | 7.767E−30 | 2.164E−17 | 2.117E−17 |
| | m11_1 | 0.000E+00 | 0.000E+00 | −1.516E−18 | −6.249E−19 |
| | m12_1 | 0.000E+00 | −1.449E−33 | −7.587E−21 | −6.014E−21 |

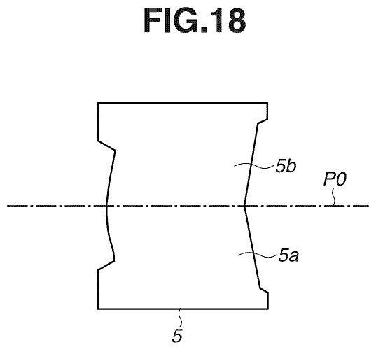

Next, the effects of the optical scanning device 100 according to the present exemplary embodiment will be described. In the present exemplary embodiment, the imaging optical systems 85a and 85b have different optical path lengths. Compared to the case where the optical path lengths are the same, this improves the degree of freedom in the layout of optical parts, and enables converging (guiding) the light beams RA and RB upon the photosensitive drums 8a and 8b while preventing interference of the optical parts and the light beams. This leads to a reduction in size of the optical scanning device 100. To implement such a configuration, the first fθ lens 5 has different generatrix shapes and sagittal shapes for the imaging optical systems 85a and 85b as illustrated in Tables 17 and 18, and thus has an asymmetric shape in the sub scanning direction with respect to the reference plane P0 (interface) as illustrated in FIG. 18.

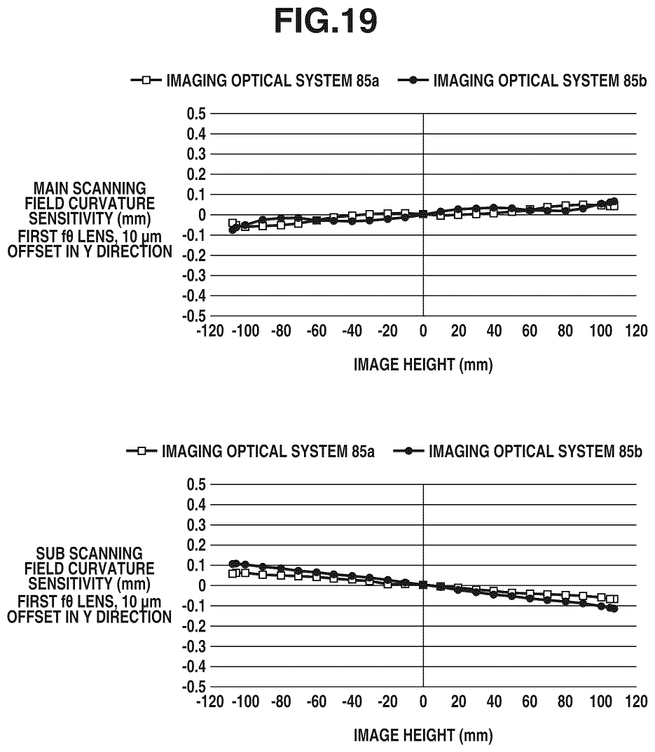

The shapes of the incident surface and exit surface of the first fθ lens 5 in the main scanning direction (generatrix shapes) are desirably symmetrical about the optical axis. This reduces a difference in the optical performance of the imaging optical systems 85a and 85b with different optical path lengths. Here, it is sufficient for at least the pair where the sagittal shapes are asymmetric to have symmetric generatrix shapes about the optical axis. The other pair may have asymmetric generatrix shapes about the optical axis as appropriate. A difference in the optical performance of the imaging optical systems 85a and 85b with different optical path lengths are reduced by satisfying the following inequality (4):

$$0.8 < β1 / β 2 < 1.2 , \qquad ( 4 )$$

where β1 and β2 are the sub scanning magnifications of the imaging optical system 85a and 85b, respectively. FIG. 19 illustrates the field curvature sensitivities of the imaging optical systems 85a and 85b when the first fθ lens 5 is offset by 10 μm in the Y direction. A degradation in image quality is prevented by reducing the difference in the optical performance of the imaging optical systems 85a and 85b.

In the present exemplary embodiment, as illustrated in Tables 17 and 18, the incident surface and exit surface of the first fθ lens 5 are symmetrical in the main scanning direction. β1=−2.05 and β2=−2.46, and βa/βb is 0.82. This satisfies inequality (4), and a degradation in image quality is prevented. The sub scanning magnifications β1 and β2 more desirably satisfy the following inequality (4a):

$$0.8 < β 1 / β 2 < 1.0 . \qquad ( 4 a )$$

With the foregoing configuration using the first fθ lens 5, the optical scanning device 100 according to the present exemplary embodiment thus achieves miniaturization in a compatible manner with the prevention of image quality degradation through reduction of the difference in optical performance between the imaging optical systems 85a and 85b.

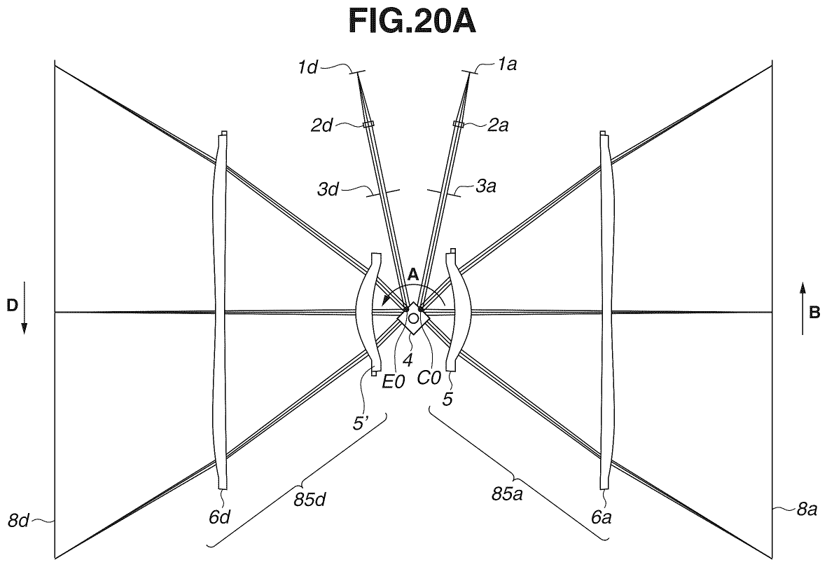

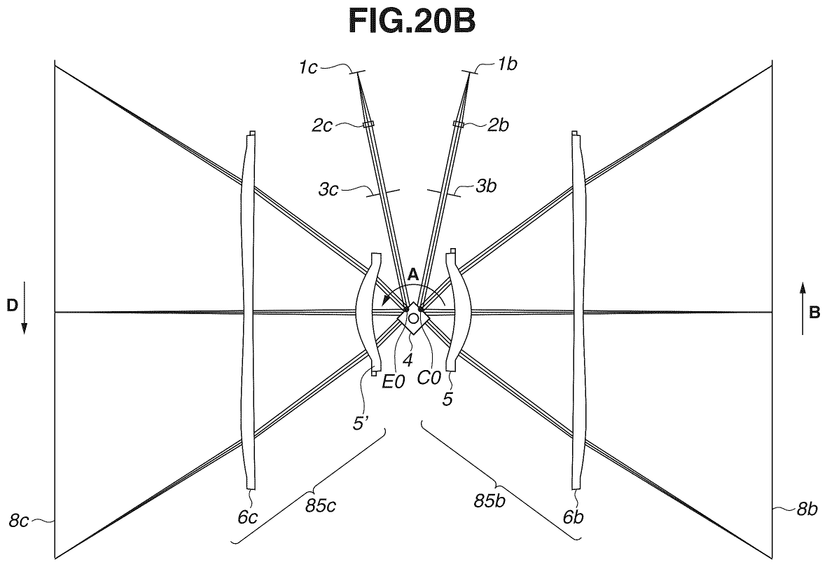

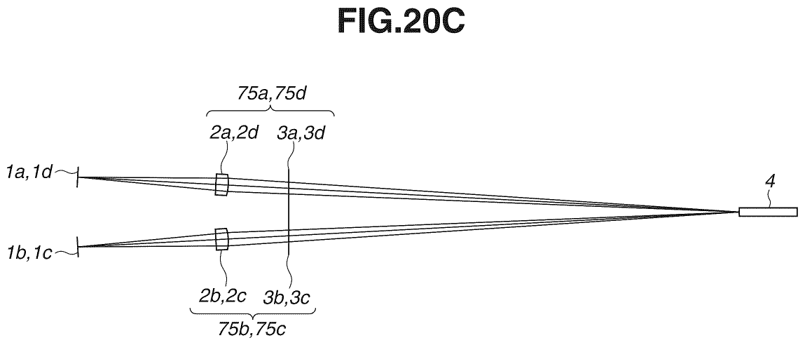

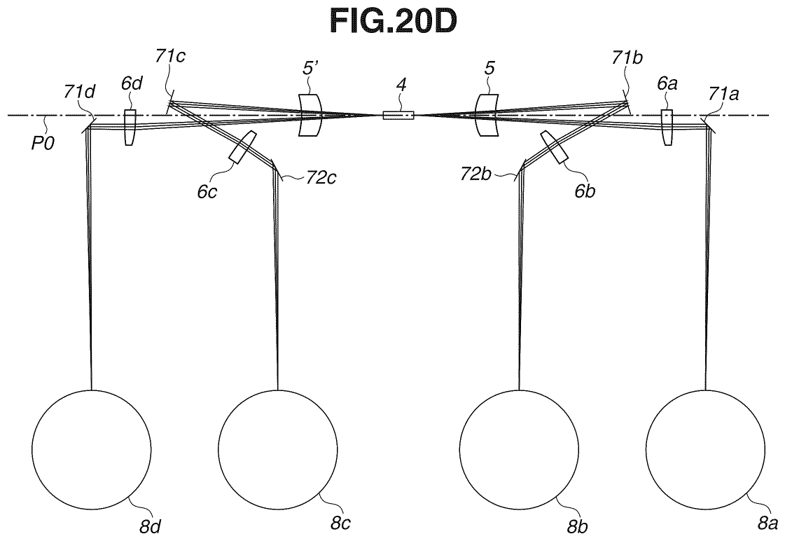

FIGS. 20A and 20B are optical path diagrams of an optical scanning device 200 according to a sixth exemplary embodiment in main scanning sections. FIG. 20C is a sub scanning sectional view of incident optical systems included in the optical scanning device 200 according to the sixth exemplary embodiment. FIG. 20D is a sub scanning sectional view of imaging optical systems included in the optical scanning device 200 according to the sixth exemplary embodiment.

The optical scanning device 200 according to the present exemplary embodiment includes first, second, third, and fourth light sources 1a, 1b, 1c, and 1d, first, second, third, and fourth anamorphic lenses 2a, 2b, 2c, and 2d, and first, second, third, and fourth aperture stops 3a, 3b, 3c, and 3d.

The optical scanning device 200 according to the present exemplary embodiment also includes a deflector 4, first fθ lenses 5 and 5′, second fθ lenses 6a, 6b, 6c, and 6d, and reflective members 71a, 71b, 72b, 71c, 72c, and 71d.

Semiconductor lasers are used as the first, second, third, and fourth light sources 1a, 1b, 1c, and 1d.

The first, second, third, and fourth anamorphic lenses 2a, 2b, 2c, and 2d have different positive powers (refractive powers) in the main scanning direction and the sub scanning direction separately so that light beams RA, RB, RC, and RD (first, second, third, and fourth light beams) emitted from the first to fourth light sources 1a to 1d are converted into approximately parallel beams in the main scanning direction and converged in the sub scanning direction. Here, parallel beams are not limited to strictly parallel ones but include approximately parallel beams such as weakly diverging beams and weakly converging beams.

The first, second, third, and fourth aperture stops 3a, 3b, 3c, and 3d limit the beam diameters of the light beams RA to RD passed through the first to fourth anamorphic lenses 2a to 2d.

The light beams RA and RB emitted from the first and second light sources 1a and 1b are thus converged near a first deflection surface 41 of the deflector 4 only in the sub scanning direction, and formed as line images long in the main scanning direction.

The light beams RC and RD emitted from the third and fourth light sources 1c and 1d are converged near a second deflection surface 42 of the deflector 4 only in the sub scanning direction, and formed as line images long in the main scanning direction.

The deflector 4 is rotated in the direction of the arrow A in the diagram by a not-illustrated driving unit such as a motor, and thereby deflects the light beams LA to RD incident on the deflector 4. The deflector 4 consists of a polygon mirror, for example.

The first fθ lens 5 and the second fθ lenses 6a and 6b are anamorphic imaging lenses having different power in the main scanning section and the sub scanning section. The first fθ lens 5 and the second fθ lenses 6a and 6b converge (guide) the light beams RA and RB deflected by the first deflection surface 41 of the deflector 4 onto first and second scanned surfaces 8a and 8b.

The first fθ lens 5′ and the second fθ lenses 6c and 6d are anamorphic imaging lenses having different power in the main scanning section and the sub scanning section. The first fθ lens 5′ and the second fθ lenses 6c and 6d converge (guide) the light beams RC and RD deflected by the second deflection surface 42 of the deflector 4 onto third and fourth scanned surfaces 8c and 8d.

The first fθ lens 5 is a multi-stage lens where a first optical portion 5a and a second optical portion 5b are arranged in the sub scanning direction. More specifically, the incident surface of the first fθ lens 5 consists of the incident surface of the first optical portion 5a and the incident surface of the second optical portion 5b. The exit surface of the first fθ lens 5 consists of the exit surface of the first optical portion 5a and the exit surface of the second optical portion 5b. The exit surfaces of the first and second optical portions 5a and 5b are shaped to have different sagittal tilt amounts, each being a sagittal tilt changing surface where the sagittal tilt amount changes in the main scanning direction.

The first fθ lens 5′ is a multi-stage lens where a first optical portion 5c (third optical portion) and a second optical portion 5d (fourth optical portion) are arranged in the sub scanning direction. More specifically, the incident surface of the first fθ lens 5′ consists of the incident surface of the third optical portion 5c and the incident surface of the fourth optical portion 5d. The exit surface of the first fθ lens 5′ consists of the exit surface of the third optical portion 5c and the exit surface of the fourth optical portion 5d. The exit surfaces of the third and fourth optical portions 5c and 5d are shaped to have different sagittal tilt amounts, each being a sagittal tilt changing surface where the sagittal tilt amount changes in the main scanning direction.

The reflective members 71a, 71b, 72b, 71c, 72c, and 71d are units for reflecting a light beam. Vapor deposition mirrors are used as the reflective members 71a, 71b, 72b, 71c, 72c, and 71d.

In the optical scanning device 200 according to the present exemplary embodiment, a first imaging optical system 85a consists of the first optical portion 5a of the first f lens 5 and the second f lens 6a. A second imaging optical system 85b consists of the second optical portion 5b of the first fθ lens 5 and the second fθ lens 6b.

A third imaging optical system 85c consists of the third optical portion 5c of the first f lens 5′ and the second fθ lens 6c. A fourth imaging optical system 85d consists of the fourth optical portion 5d of the first fθ lens 5′ and the second fθ lens 6d.

In the optical scanning device 200 according to the present exemplary embodiment, the optical axes of first and second incident optical systems 75a and 75b form an angle of +2.7° and −2.7° with the main scanning section, respectively, in the sub scanning section.

The optical axes of third and fourth incident optical systems 75c and 75d form an angle of −2.7° and +2.7° with the main scanning section, respectively, in the sub scanning section.

The first and second light beams RA and RB emitted from the emission points of the first and second light sources 1a and 1b are converted into parallel beams in the main scanning direction and converged in the sub scanning direction by the first and second anamorphic lenses 2a and 2b.

The resulting first and second light beams RA and RB pass through the first and second aperture stops 3a and 3b and are incident on the first deflection surface 41 of the deflector 4 from above and below in the sub scanning direction, respectively.

The first and second light beams RA and RB emitted from the first and second light sources 1a and 1b and incident on the first deflection surface 41 of the deflector 4 are deflected by the deflector 4, are then converged upon the first and second scanned surfaces 8a and 8b by the first and second imaging optical systems 85a and 85b, and scan the first and second scanned surfaces 8a and 8b at constant speed.

The third and fourth light beams RC and RD emitted from the emission points of the third and fourth light sources 1c and 1d are converted into parallel beams in the main scanning direction and converged in the sub scanning direction by the third and fourth anamorphic lenses 2c and 2d.

The resulting third and fourth light beams RC and RD pass through the third and fourth aperture stops 3c and 3d and are incident on the second deflection surface 42 of the deflector 4 from below and above in the sub scanning direction, respectively.

The third and fourth light beams RC and RD emitted from the third and fourth light sources 1c and 1d and incident on the second deflection surface 42 of the deflector 4 are deflected by the deflector 4, are then converged upon the third and fourth scanned surfaces 8c and 8d by the third and fourth imaging optical systems 85c and 85d, and scan the third and fourth scanned surfaces 8c and 8d at constant speed.

Since the deflector 4 rotates in the direction of the arrow A in the diagram, the deflected light beams RA and RB scan the first and second scanned surfaces 8a and 8b in the direction of the arrow B in the diagram, respectively. The deflected light beams RC and RD scan the third and fourth scanned surfaces 8c and 8d in the direction of the arrow D in the diagram, respectively.

The deflection point (axial deflection point) of the principal rays of the axial light beams on the first deflection surface 41 of the deflector 4 is denoted by C0. In the sub scanning direction, the light beams RA and RB emitted from the first and second light sources 1a and 1b intersect at the deflection point C0. The deflection point C0 serves as a reference point for the first and second imaging optical systems 85a and 85b.

The deflection point (axial deflection point) of the principal rays of the axial light beams on the second deflection surface 42 of the deflector 4 is denoted by E0. In the sub scanning direction, the light beams RC and RD emitted from the third and fourth light sources 1c and 1d intersect at the deflection point E0. The deflection point E0 serves as a reference point for the third and fourth imaging optical systems 85c and 85d.

The plane (reference plane) that intersects with the deflection points C0 and E0 and is perpendicular to the rotation axis of the deflector 4 is denoted by P0. In the following description, the lengths of the optical paths from the deflection point C0 to the scanned surfaces 8a and 8b and the lengths of the optical paths from the deflection point E0 to the scanned surfaces 8c and 8d will be referred to as the optical path lengths of the imaging optical systems 85a, 85b, 85c, and 85d.

In the present exemplary embodiment, first, second, third, and fourth photosensitive drums 8a, 8b, 8c, and 8d are used as the first, second, third, and fourth scanned surfaces 8a, 8b, 8c, and 8d.

The exposure distributions on the first to fourth photosensitive drums 8a to 8d in the sub scanning direction are formed by rotating the first to fourth photosensitive drums 8a to 8d in the sub scanning direction upon each main scanning exposure.

Tables 19 and 20 below illustrate the characteristics of the first to fourth incident optical systems 75a to 75d and the first to fourth imaging optical system 85a to 85d of the optical scanning device 200 according to the present exemplary embodiment.

TABLE 19
Configuration of incident optical systems 75a and 75d•and
layout of imaging optical systems 85a and 85d

| | | |
|---|---|---|
| Use wavelength | λ (nm) | 790 |
| Number of Light emissions | n | 1 |
| Laser cover glass thickness | d1 (mm) | 0.250 |
| Laser cover glass refractive index | n1 | 1.510 |
| From light source light emission point to incident surface of | d2 (mm) | 33.590 |
| anamorphic lens | | |
| Anamorphic lens thickness | d3 (mm) | 3.000 |
| Anamorphic lens refractive index | n2 | 1.528 |
| Main incident surface of anamorphic lens | R1m (mm) | −0.0078 |
| Sub incident surface of anamorphic lens | R1s (mm) | −0.0087 |
| Radius of curvature of exit surface of anamorphic lens in main | R2m (mm) | −37.169 |
| scanning direction | | |
| Radius of curvature of exit surface of anamorphic lens in sub | R2s (mm) | −26.170 |
| scanning direction | | |
| From exit surface of anamorphic lens to aperture stop | d4 (mm) | 15.150 |
| From main scanning aperture stop to deflection reference point | d5 (mm) | 109.960 |
| Deflection reference point to incident surface of first fθ lens | d6 (mm) | 26.000 |
| First fθ lens thickness | d7 (mm) | 8.200 |
| First fθ lens refractive index | n3 | 1.528 |
| From exit surface of first fe lens to incident surface of second fθ lens | d8 (mm) | 69.300 |
| Second fθ lens thickness | d9 (mm) | 4.300 |
| Second fθ lens refractive index | n4 | 1.528 |
| From exit surface of Second fθ lens to reflective member | d10 (mm) | 10.670 |
| From deflection reference point to scanned surface | (mm) | 233.000 |
| Incident angle of light on deflector 4 in main scanning direction in | α (degree) | 78.000 |
| optical system | | |
| Incident angle of light on deflector 4 in sub scanning direction optical | β (degree) | 2.700 |
| system | | |
| fθ coefficient | K (mm/rad) | 207.000 |
| Effective scanning angle | θ (degree) | ±45.12 |
| Effective scanning width | W(mm) | ±163 |
| Number of surfaces of deflector 4 | Surface | 4 |
| Circumcircle radius of deflector 4 | Rpol (mm) | 10 |
| Center position of deflector 4 | PX (mm) | −6.03/+6.03 |
| Center position of deflector 4 | PY (mm) | −3.79 |
| Aperture stop diameter | Rectangle | Main 3.75 × |
| | (mm) | Sub 2.84 |

| | | Imaging optical system 85a | | | |
|---|---|---|---|---|---|
| | | First fθ lens 5 in | | | |
| | | optical portion 5a | | Second fθ lens 6a | |
| | | Incident | Exit | Incident | Exit |
| | | surface | surface | surface | surface |
| Generatrix | R | −71.101 | −42.946 | −4000.000 | 350.123 |
| | ky | 0.946 | −0.515 | 0.000 | −87.532 |
| | B1 | 0.000E+00 | 0.000E+00 | 0.000E+00 | 0.000E+00 |
| | B2 | 0.000E+00 | 0.000E+00 | 0.000E+00 | 0.000E+00 |
| | B3 | 0.000E+00 | 0.000E+00 | 0.000E+00 | 0.000E+00 |
| | B4 | −9.147E−07 | −3.477E−07 | 0.000E+00 | −2.020E−07 |
| | B5 | 0.000E+00 | 0.000E+00 | 0.000E+00 | 0.000E+00 |
| | B6 | 6.784E−09 | 1.690E−09 | 0.000E+00 | 1.609E−11 |
| | B7 | 0.000E−00 | 0.000E+00 | 0.000E+00 | 0.000E+00 |
| | B8 | −5.767E−12 | 1.110E−12 | 0.000E+00 | −9.313E−16 |
| | B9 | 0.000E+00 | 0.000E+00 | 0.000E+00 | 0.000E+00 |
| | B10 | 1.638E−15 | −1.224E−15 | 0.000E+00 | 2.524E−20 |
| | B11 | 0.000E+00 | 0.000E+00 | 0.000E+00 | 0.000E+00 |
| | B12 | 0.000E+00 | 0.000E+00 | 0.000E+00 | 0.000E+00 |
| | B13 | 0.000E+00 | 0.000E+00 | 0.000E+00 | 0.000E+00 |
| | B14 | 0.000E+00 | 0.000E+00 | 0.000E+00 | 0.000E+00 |
| | B15 | 0.000E+00 | 0.000E+00 | 0.000E+00 | 0.000E+00 |
| | B16 | 0.000E+00 | 0.000E+00 | 0.000E+00 | 0.000E+00 |
| Sagittal | r | 20.000 | 25.004 | 37.079 | −154.008 |
| | E1 | 0.000E+00 | 0.000E+00 | 0.000E+00 | −1.278E−07 |
| | E2 | 0.000E+00 | 1.522E−05 | −7.458E−07 | 1.813E−06 |
| | E3 | 0.000E+00 | 0.000E+00 | 0.000E+00 | −3.240E−09 |
| | E4 | 0.000E+00 | 8.486E−10 | 0.000E+00 | −3.041E−10 |
| | E5 | 0.000E+00 | 0.000E+00 | 0.000E+00 | 1.339E−12 |
| | E6 | 0.000E+00 | −2.508E−11 | 0.000E+00 | 3.082E−14 |
| | E7 | 0.000E+00 | 0.000E+00 | 0.000E+00 | −2.009E−16 |
| | E8 | 0.000E+00 | 7.607E−15 | 0.000E+00 | −1.954E−18 |
| | E9 | 0.000E+00 | 0.000E+00 | 0.000E+00 | 9.859E−21 |
| | E10 | 0.000E+00 | 1.610E−17 | 0.000E+00 | 5.812E−23 |
| | E11 | 0.000E+00 | 0.000E+00 | 0.000E+00 | 0.000E+00 |
| | E12 | 0.000E+00 | 0.000E+00 | 0.000E+00 | 0.000E+00 |
| | E13 | 0.000E+00 | 0.000E+00 | 0.000E+00 | 0.000E+00 |
| | E14 | 0.000E+00 | 0.000E+00 | 0.000E+00 | 0.000E+00 |
| | E15 | 0.000E+00 | 0.000E+00 | 0.000E+00 | 0.000E+00 |
| | E16 | 0.000E+00 | 0.000E+00 | 0.000E+00 | 0.000E+00 |
| | m0_1 | 0.000E+00 | −2.124E−02 | −1.007E−01 | 2.315E−02 |
| | m1_1 | 0.000E+00 | 0.000E+00 | −2.129E−04 | −2.002E−04 |
| | m2_1 | 0.000E+00 | 3.321E−05 | −1.314E−05 | −2.370E−05 |
| | m3_1 | 0.000E+00 | 0.000E+00 | 1.161E−07 | 1.056E−07 |
| | m4_1 | 0.000E+00 | 0.000E+00 | 1.765E−09 | 3.675E−09 |
| | m5_1 | 0.000E+00 | 0.000E+00 | −1.616E−11 | −1.409E−11 |
| | m6_1 | 0.000E+00 | 0.000E+00 | 3.014E−13 | −3.052E−13 |
| | m7_1 | 0.000E+00 | 0.000E+00 | 1.061E−15 | 9.733E−16 |
| | m8_1 | 0.000E+00 | 0.000E+00 | −1.306E−17 | 6.574E−17 |
| | m9_1 | 0.000E+00 | 0.000E+00 | −1.657E−20 | −1.738E−20 |
| | M10_1 | 0.000E+00 | 0.000E+00 | −8.536E−22 | −3.960E−21 |
| | m11_1 | 0.000E+00 | 0.000E+00 | 0.000E+00 | 0.000E+00 |
| | m12_1 | 0.000E+00 | 0.000E+00 | 0.000E+00 | 0.000E+00 |
| | m13_1 | 0.000E+00 | 0.000E+00 | 0.000E+00 | 0.000E+00 |
| | m14_1 | 0.000E+00 | 0.000E+00 | 0.000E+00 | 0.000E+00 |
| | m15_1 | 0.000E+00 | 0.000E+00 | 0.000E+00 | 0.000E+00 |
| | m16_1 | 0.000E+00 | 0.000E+00 | 0.000E+00 | 0.000E+00 |

| | | Imaging optical system 85d | | | |
|---|---|---|---|---|---|
| | | First fθ lens 5′ in | | | |
| | | optical portion 5d | | Second fθ lens 6d | |
| | | Incident | Exit | Incident | Exit |
| | | surface | surface | surface | surface |
| Generatrix | R | −71.101 | −42.946 | −4000.000 | 350.123 |
| | ky | 0.946 | −0.515 | 0.000 | −87.532 |
| | B1 | 0.000E+00 | 0.000E+00 | 0.000E+00 | 0.000E+00 |
| | B2 | 0.000E+00 | 0.000E+00 | 0.000E+00 | 0.000E+00 |
| | B3 | 0.000E+00 | 0.000E+00 | 0.000E+00 | 0.000E+00 |
| | B4 | −9.147E−07 | −3.477E−07 | 0.000E+00 | −2.020E−07 |
| | B5 | 0.000E+00 | 0.000E+00 | 0.000E+00 | 0.000E+00 |
| | B6 | 6.784E−09 | 1.690E−09 | 0.000E+00 | 1.609E−11 |
| | B7 | 0.000E+00 | 0.000E+00 | 0.000E+00 | 0.000E+00 |
| | B8 | −5.767E−12 | 1.110E−12 | 0.000E+00 | −9.313E−16 |
| | B9 | 0.000E+00 | 0.000E+00 | 0.000E+00 | 0.000E+00 |
| | B10 | 1.638E−15 | −1.224E−15 | 0.000E+00 | 2.524E−20 |
| | B11 | 0.000E+00 | 0.000E+00 | 0.000E+00 | 0.000E+00 |
| | B12 | 0.000E+00 | 0.000E+00 | 0.000E+00 | 0.000E+00 |
| | B13 | 0.000E+00 | 0.000E+00 | 0.000E+00 | 0.000E+00 |
| | B14 | 0.000E+00 | 0.000E+00 | 0.000E+00 | 0.000E+00 |
| | B15 | 0.000E+00 | 0.000E+00 | 0.000E+00 | 0.000E+00 |
| | B16 | 0.000E+00 | 0.000E+00 | 0.000E+00 | 0.000E+00 |
| Sagittal | r | 20.000 | 25.004 | 37.079 | −154.008 |
| | E1 | 0.000E+00 | 0.000E+00 | 0.000E+00 | −1.278E−07 |
| | E2 | 0.000E+00 | 1.522E−05 | −7.458E−07 | 1.813E−06 |
| | E3 | 0.000E+00 | 0.000E+00 | 0.000E+00 | −3.240E−09 |
| | E4 | 0.000E+00 | 8.486E−10 | 0.000E+00 | −3.041E−10 |
| | E5 | 0.000E+00 | 0.000E+00 | 0.000E+00 | 1.339E−12 |
| | E6 | 0.000E+00 | −2.508E−11 | 0.000E+00 | 3.082E−14 |
| | E7 | 0.000E+00 | 0.000E+00 | 0.000E+00 | −2.009E−16 |
| | E8 | 0.000E+00 | 7.607E−15 | 0.000E+00 | −1.954E−18 |
| | E9 | 0.000E+00 | 0.000E+00 | 0.000E+00 | 9.859E−21 |
| | E10 | 0.000E+00 | 1.610E−17 | 0.000E+00 | 5.812E−23 |
| | E11 | 0.000E+00 | 0.000E+00 | 0.000E+00 | 0.000E+00 |
| | E12 | 0.000E+00 | 0.000E+00 | 0.000E+00 | 0.000E+00 |
| | E13 | 0.000E+00 | 0.000E+00 | 0.000E+00 | 0.000E+00 |
| | E14 | 0.000E+00 | 0.000E+00 | 0.000E+00 | 0.000E+00 |
| | E15 | 0.000E+00 | 0.000E+00 | 0.000E+00 | 0.000E+00 |
| | E16 | 0.000E+00 | 0.000E+00 | 0.000E+00 | 0.000E+00 |
| | m0_1 | 0.000E+00 | −2.124E−02 | 1.007E−01 | −2.315E−02 |
| | m1_1 | 0.000E+00 | 0.000E+00 | 2.129E−04 | 2.002E−04 |
| | m2_1 | 0.000E+00 | 3.321E−05 | 1.314E−05 | 2.370E−05 |
| | m3_1 | 0.000E+00 | 0.000E+00 | −1.161E−07 | −1.056E−07 |
| | m4_1 | 0.000E+00 | 0.000E+00 | −1.765E−09 | −3.675E−09 |
| | m5_1 | 0.000E+00 | 0.000E+00 | 1.616E−11 | 1.409E−11 |
| | m6_1 | 0.000E+00 | 0.000E+00 | −3.014E−13 | 3.052E−13 |
| | m7_1 | 0.000E+00 | 0.000E+00 | −1.061E−15 | −9.733E−16 |
| | m8_1 | 0.000E+00 | 0.000E+00 | 1.306E−17 | −6.574E−17 |
| | m9_1 | 0.000E+00 | 0.000E+00 | 1.657E−20 | 1.728E−20 |
| | M10_1 | 0.000E+00 | 0.000E+00 | 8.536E−22 | 3.960E−21 |
| | m11_1 | 0.000E+00 | 0.000E+00 | 0.000E+00 | 0.000E+00 |
| | m12_1 | 0.000E+00 | 0.000E+00 | 0.000E+00 | 0.000E+00 |
| | m13_1 | 0.000E+00 | 0.000E+00 | 0.000E+00 | 0.000E+00 |
| | m14_1 | 0.000E+00 | 0.000E+00 | 0.000E+00 | 0.000E+00 |
| | m15_1 | 0.000E+00 | 0.000E+00 | 0.000E+00 | 0.000E+00 |
| | m16_1 | 0.000E+00 | 0.000E+00 | 0.000E+00 | 0.000E+00 |

TABLE 20
Configuration of incident optical systems 75b and 75c•and
layout of imaging optical systems 85b and 85c

| | | |
|---|---|---|
| Use wavelength | λ (nm) | 790 |
| Number of Light emissions | n | 1 |
| Laser cover glass thickness | d1 (mm) | 0.250 |
| Laser cover glass refractive index | n1 | 1.510 |
| From light source light emission point to incident surface of | d2 (mm) | 33.590 |
| anamorphic lens | | |
| Anamorphic lens thickness | d3 (mm) | 3.000 |
| Anamorphic lens refractive index | n2 | 1.528 |
| Main incident surface of anamorphic lens | R1m (mm) | −0.0078 |
| Sub incident surface of anamorphic lens | R1s (mm) | −0.0087 |
| Radius of curvature of exit surface of anamorphic lens in main | R2m (mm) | −37.169 |
| scanning direction | | |
| Radius of curvature of exit surface of anamorphic lens in | R2s (mm) | −26.170 |
| sub scanning direction | | |
| From exit surface of anamorphic lens to aperture stop | d4 (mm) | 15.150 |
| From main scanning aperture stop to deflection reference point | d5 (mm) | 109.960 |
| Deflection reference point to incident surface of first fθ lens | d6 (mm) | 26.000 |
| First fθ lens thickness | d7 (mm) | 8.200 |
| First fθ lens refractive index | n3 | 1.528 |
| From exit surface of first fθ lens to reflective member | d8 (mm) | 56.316 |
| From reflective member to incident surface of second fθ lens | d9 (mm) | 31.484 |
| Second fθ lens thickness | d10 (mm) | 4.300 |
| Second fθ lens refractive index | n4 | 1.528 |
| From exit surface of second fθ lens to reflective member | d12 (mm) | 26.358 |
| From deflection reference point to scanned surface | (mm) | 233.000 |
| Incident angle of light on deflector 4 in main scanning direction in | α (degree) | 78.000 |
| optical system | | |
| Incident angle of light on deflector 4 in sub scanning direction in | β (degree) | 2.700 |
| optical system | | |
| fθ coefficient | K (mm/rad) | 207.000 |
| Effective scanning angle | θ (degree) | ±45.12 |
| Effective scanning width | W(mm) | ±163 |
| Number of surfaces of deflector 4 | Surface | 4 |
| Circumcircle radius of deflector 4 | Rpol (mm) | 10 |
| Center position of deflector 4 | PX (mm) | −6.03/+6.03 |
| Center position of deflector 4 | PY (mm) | −3.79 |
| Aperture stop diameter | Reftangle | Main 3.75 × |
| | (mm) | Sub 2.84 |

| | | Imaging optical system 85b | | | |
|---|---|---|---|---|---|
| | | First fθ lens 5 in | | | |
| | | optical portion 5b | | Second fθ lens 6a | |
| | | Incident | Exit | Incident | Exit |
| | | surface | surface | surface | surface |
| Generatrix | R | −71.101 | −43.800 | −4000.000 | 379.967 |
| | ky | 0.946 | −0.932 | 0.000 | −74.124 |
| | B1 | 0.000E+00 | 0.000E+00 | 0.000E+00 | 0.000E+00 |
| | B2 | 0.000E+00 | 0.000E+00 | 0.000E+00 | 0.000E+00 |
| | B3 | 0.000E+00 | 0.000E+00 | 0.000E+00 | 0.000E+00 |
| | B4 | −9.147E−07 | −1.355E−06 | 0.000E+00 | −1.332E−07 |
| | B5 | 0.000E+00 | 0.000E+00 | 0.000E+00 | 0.000E+00 |
| | B6 | 6.784E−09 | 1.719E−09 | 0.000E+00 | 7.206E−12 |
| | B7 | 0.000E+00 | 0.000E+00 | 0.000E+00 | 0.000E+00 |
| | B8 | −5.767E−12 | 8.761E−13 | 0.000E+00 | −3.070E−16 |
| | B9 | 0.000E+00 | 0.000E+00 | 0.000E+00 | 0.000E+00 |
| | B10 | 1.638E−15 | −1.069E−15 | 0.000E+00 | 6.089E−21 |
| | B11 | 0.000E+00 | 0.000E+00 | 0.000E+00 | 0.000E+00 |
| | B12 | 0.000E+00 | 0.000E+00 | 0.000E+00 | 0.000E+00 |
| | B13 | 0.000E+00 | 0.000E+00 | 0.000E+00 | 0.000E+00 |
| | B14 | 0.000E+00 | 0.000E+00 | 0.000E+00 | 0.000E+00 |
| | B15 | 0.000E+00 | 0.000E+00 | 0.000E+00 | 0.000E+00 |
| | B16 | 0.000E+00 | 0.000E+00 | 0.000E+00 | 0.000E+00 |
| Sagittal | r | 20.000 | 55.261 | 37.426 | −249.993 |
| | E1 | 0.000E+00 | 0.000E+00 | 0.000E+00 | 9.4105E−09 |
| | E2 | 0.000E+00 | 6.894E−06 | −3.482E−07 | 1.446E−06 |
| | E3 | 0.000E+00 | 0.000E+00 | 0.000E+00 | −1.616E−09 |
| | E4 | 0.000E+00 | 8.425E−08 | 0.000E+00 | −2.793E−10 |
| | E5 | 0.000E+00 | 0.000E+00 | 0.000E+00 | 4.721E−13 |
| | E6 | 0.000E+00 | −2.679E−10 | 0.000E+00 | 4.455E−14 |
| | E7 | 0.000E+00 | 0.000E+00 | 0.000E+00 | −5.354E−17 |
| | E8 | 0.000E+00 | 3.436E−13 | 0.000E+00 | −3.936E−18 |
| | E9 | 0.000E+00 | 0.000E+00 | 0.000E+00 | 2.027E−21 |
| | E10 | 0.000E+00 | −1.539E−16 | 0.000E+00 | 1.363E−22 |
| | E11 | 0.000E+00 | 0.000E+00 | 0.000E+00 | 0.000E+00 |
| | E12 | 0.000E+00 | 0.000E+00 | 0.000E+00 | 0.000E+00 |
| | E13 | 0.000E+00 | 0.000E+00 | 0.000E+00 | 0.000E+00 |
| | E14 | 0.000E+00 | 0.000E+00 | 0.000E+00 | 0.000E+00 |
| | E15 | 0.000E+00 | 0.000E+00 | 0.000E+00 | 0.000E+00 |
| | E16 | 0.000E+00 | 0.000E+00 | 0.000E+00 | 0.000E+00 |
| | m0_1 | 0.000E+00 | 7.661E−02 | −1.211E−01 | 5.801E−02 |
| | m1_1 | 0.000E+00 | 0.000E+00 | −2.129E−04 | −2.002E−04 |
| | m2_1 | 0.000E+00 | −3.906E−05 | −1.111E−05 | −2.292E−05 |
| | m3_1 | 0.000E+00 | 0.000E+00 | 1.419E−07 | 1.288E−07 |
| | m4_1 | 0.000E+00 | 0.000E+00 | 5.557E−10 | 2.627E−09 |
| | m5_1 | 0.000E+00 | 0.000E+00 | −2.589E−11 | −2.174E−11 |
| | m6_1 | 0.000E+00 | 0.000E+00 | 2.459E−13 | −2.067E−13 |
| | m7_1 | 0.000E+00 | 0.000E+00 | 2.150E−15 | 1.675E−15 |
| | m8_1 | 0.000E+00 | 0.000E+00 | −1.182E−17 | 3.209E−17 |
| | m9_1 | 0.000E+00 | 0.000E+00 | −6.130E−20 | −4.199E−20 |
| | m10_1 | 0.000E+00 | 0.000E+00 | −9.717E−23 | −1.487E−21 |
| | m11_1 | 0.000E+00 | 0.000E+00 | 0.000E+00 | 0.000E+00 |
| | m12_1 | 0.000E+00 | 0.000E+00 | 0.000E+00 | 0.000E+00 |
| | m13_1 | 0.000E+00 | 0.000E+00 | 0.000E+00 | 0.000E+00 |
| | m14_1 | 0.000E+00 | 0.000E+00 | 0.000E+00 | 0.000E+00 |
| | m15_1 | 0.000E+00 | 0.000E+00 | 0.000E+00 | 0.000E+00 |
| | m16_1 | 0.000E+00 | 0.000E+00 | 0.000E+00 | 0.000E+00 |

| | | Imaging optical system 85c | | | |
|---|---|---|---|---|---|
| | | First fθ lens 5′ in | | | |
| | | optical portion 5c | | Second fθ lens 6d | |
| | | Incident | Exit | Incident | Exit |
| | | surface | surface | surface | surface |
| Generatrix | R | −71.101 | −43.800 | −4000.000 | 379.967 |
| | ky | 0.946 | −0.932 | 0.000 | −74.124 |
| | B1 | 0.000E+00 | 0.000E+00 | 0.000E+00 | 0.000E+00 |
| | B2 | 0.000E+00 | 0.000E+00 | 0.000E+00 | 0.000E+00 |
| | B3 | 0.000E+00 | 0.000E+00 | 0.000E+00 | 0.000E+00 |
| | B4 | −9.147E−07 | −1.355E−06 | 0.000E+00 | −1.332E−07 |
| | B5 | 0.000E+00 | 0.000E+00 | 0.000E+00 | 0.000E+00 |
| | B6 | 6.784E−09 | 1.719E−09 | 0.000E+00 | 7.206E−12 |
| | B7 | 0.000E+00 | 0.000E+00 | 0.000E+00 | 0.000E+00 |
| | B8 | −5.767E−12 | 8.761E−13 | 0.000E+00 | −3.070E−16 |
| | B9 | 0.000E+00 | 0.000E+00 | 0.000E+00 | 0.000E+00 |
| | B10 | 1.638E−15 | −1.069E−15 | 0.000E+00 | 6.089E−21 |
| | B11 | 0.000E+00 | 0.000E+00 | 0.000E+00 | 0.000E+00 |
| | B12 | 0.000E+00 | 0.000E+00 | 0.000E+00 | 0.000E+00 |
| | B13 | 0.000E+00 | 0.000E+00 | 0.000E+00 | 0.000E+00 |
| | B14 | 0.000E+00 | 0.000E+00 | 0.000E+00 | 0.000E+00 |
| | B15 | 0.000E+00 | 0.000E+00 | 0.000E+00 | 0.000E+00 |
| | B16 | 0.000E+00 | 0.000E+00 | 0.000E+00 | 0.000E+00 |
| Sagittal | r | 20.000 | 55.261 | 37.426 | −249.993 |
| | E1 | 0.000E+00 | 0.000E+00 | 0.000E+00 | 9.410E−09 |
| | E2 | 0.000E+00 | 6.894E−06 | −3.482E−07 | 1.446E−06 |
| | E3 | 0.000E+00 | 0.000E+00 | 0.000E+00 | −1.616E−09 |
| | E4 | 0.000E+00 | 8.425E−08 | 0.000E+00 | −2.793E−10 |
| | E5 | 0.000E+00 | 0.000E+00 | 0.000E+00 | 4.721E−13 |
| | E6 | 0.000E+00 | −2.679E−10 | 0.000E+00 | 4.455E−14 |
| | E7 | 0.000E+00 | 0.000E+00 | 0.000E+00 | −5.354E−17 |
| | E8 | 0.000E+00 | 3.436E−13 | 0.000E+00 | −3.936E−18 |
| | E9 | 0.000E+00 | 0.000E+00 | 0.000E+00 | 2.027E−21 |
| | E10 | 0.000E+00 | −1.539E−16 | 0.000E+00 | 1.363E−22 |
| | E11 | 0.000E+00 | 0.000E+00 | 0.000E+00 | 0.000E+00 |
| | E12 | 0.000E+00 | 0.000E+00 | 0.000E+00 | 0.000E+00 |
| | E13 | 0.000E+00 | 0.000E+00 | 0.000E+00 | 0.000E+00 |
| | E14 | 0.000E+00 | 0.000E+00 | 0.000E+00 | 0.000E+00 |
| | E15 | 0.000E+00 | 0.000E+00 | 0.000E+00 | 0.000E+00 |
| | E16 | 0.000E+00 | 0.000E+00 | 0.000E+00 | 0.000E+00 |
| | m0_1 | 0.000E+00 | 7.661E−02 | 1.211E−01 | −5.801E−02 |
| | m1_1 | 0.000E+00 | 0.000E+00 | 2.129E−04 | 2.002E−04 |
| | m2_1 | 0.000E+00 | +3.906E−05 | 1.111E−05 | 2.292E−05 |
| | m3_1 | 0.000E+00 | 0.000E+00 | −1.419E−07 | −1.288E−07 |
| | m4_1 | 0.000E+00 | 0.000E+00 | −5.557E−10 | −2.627E−09 |
| | m5_1 | 0.000E+00 | 0.000E+00 | 2.589E−11 | 2.174E−11 |
| | m6_1 | 0.000E+00 | 0.000E+00 | −2.459E−13 | 2.067E−13 |
| | m7_1 | 0.000E+00 | 0.000E+00 | −2.150E−15 | −1.675E−15 |
| | m8_1 | 0.000E+00 | 0.000E+00 | 1.182E−17 | −3.209E−17 |
| | m9_1 | 0.000E+00 | 0.000E+00 | 6.130E−20 | 4.199E−20 |
| | m10_1 | 0.000E+00 | 0.000E+00 | 9.717E−23 | 1.487E−21 |
| | m11_1 | 0.000E+00 | 0.000E+00 | 0.000E+00 | 0.000E+00 |
| | m12_1 | 0.000E+00 | 0.000E+00 | 0.000E+00 | 0.000E+00 |
| | m13_1 | 0.000E+00 | 0.000E+00 | 0.000E+00 | 0.000E+00 |
| | m14_1 | 0.000E+00 | 0.000E+00 | 0.000E+00 | 0.000E+00 |
| | m15_1 | 0.000E+00 | 0.000E+00 | 0.000E+00 | 0.000E+00 |
| | m16_1 | 0.000E+00 | 0.000E+00 | 0.000E+00 | 0.000E+00 |

The radius of curvature r′ in the sub scanning section changes continuously with the y coordinate of the lens surface.

Next, the effects of the optical scanning device 200 according to the present exemplary embodiment will be described. A description of effects similar to those of the optical scanning device 100 according to the fifth exemplary embodiment will be omitted.

The optical scanning device 200 according to the present exemplary embodiment scans the four scanned surfaces 8a, 8b, 8c, and 8d using the single deflector 4.

The distance on the optical path from the deflection point C0 to the incident surface of the second fθ lens 6a and the distance on the optical path from the deflection point C0 to the incident surface of the second fθ lens 6b are different.

The distance on the optical path from the deflection point E0 to the incident surface of the second fθ lens 6c and the distance on the optical path from the deflection point E0 to the incident surface of the second fθ lens 6d are different.

Compared to the case where the optical path lengths are the same, this improves the degree of freedom in the layout of optical parts, and enables converging (guiding) the light beams upon the photosensitive drums while preventing interference of the optical parts and the light beams. This leads to a reductio in size of the optical scanning device 200. To implement such a configuration, the first fθ lenses 5 and 5′ of the imaging optical systems 85a and 85b and the imaging optical systems 85c and 85d have different generatrix shapes and different sagittal shapes as illustrated in Tables 19 and 20, and thus have asymmetric shapes in the sub scanning direction with respect to the reference plane P0.

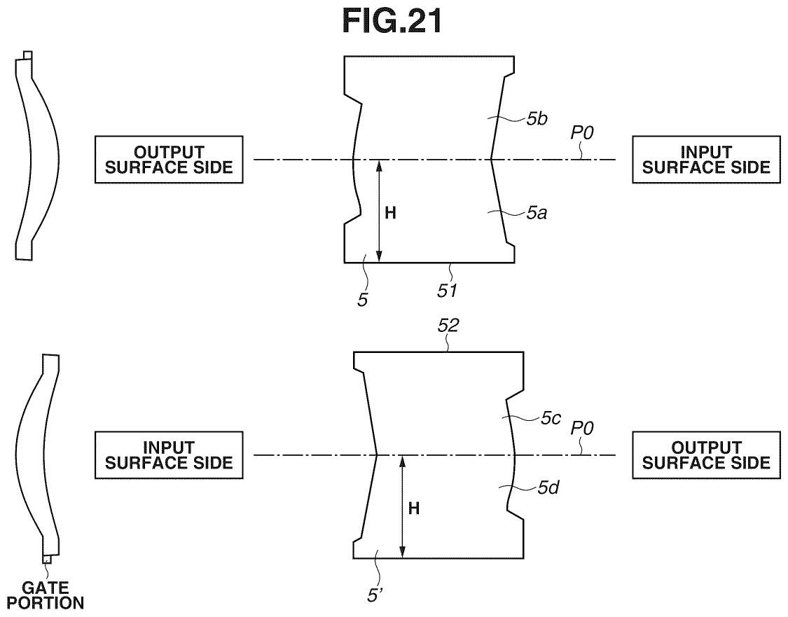

The same lenses are used as the first fθ lenses 5 and 5′. The left part of FIG. 21 is a main scanning sectional view of the first fθ lenses 5 and 5′ included in the optical scanning device 200 according to the present exemplary embodiment. The first θ lenses 5 and 5′ each have a gate portion on either one of the outer ends in the main scanning direction. As employed herein, a gate portion refers to a portion (protrusion) corresponding to a resin inlet of the die in injection molding the lens. A gate portion is formed on either one of the ends of each lens in the main scanning direction. As illustrated in FIGS. 20A and 20B, the first fθ lens 5 is disposed with its gate portion on the side of the first and second light sources 1a and 1b. The first fθ lens 5′ is disposed with its gate portion on the side away from the third and fourth light sources 1c and 1d. In other words, the gate portion of the first fθ lens 5 (first optical element) and the gate portion of the first fθ lens 5′ (fourth optical element) are located on opposite sides of the optical axes in the main scanning section. This facilitates reducing a difference in optical performance between the optical systems.

The right part of FIG. 21 is a sub scanning sectional view of the first fθ lenses 5 and 5′ included in the optical scanning device 200 according to the present exemplary embodiment. The first fθ lenses 5 and 5′ are positioned using the same lens seats 51. Even if the dimensions between the reference plane P0 and the lens seats 51 and 52 have errors due to the manufacturing of the lenses, positioning the first fθ lenses 5 and 5′ using the lens seats 51 make the amounts of error of the first fθ lenses 5 and 5′ in the Z direction the same between the imaging optical systems 85a and 85b and the imaging optical systems 85c and 85d. This leads to a reduction in a difference in the optical performance between the imaging optical systems 85a and 85b and the imaging optical systems 85c and 85d.

As described above, in the optical scanning device 200 according to the present exemplary embodiment, the use of the foregoing first fθ lenses 5 and 5′ reduces a difference in optical performance between the imaging optical systems 85a, 85b, 85c, and 85d, and an optical scanning device of even smaller size is provided. [Image Forming Apparatus]

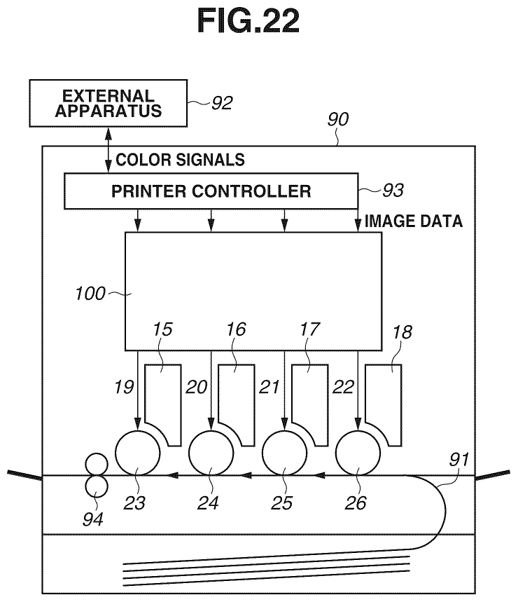

FIG. 22 is a sub scanning sectional view of essential parts of a color image forming apparatus 90 on which an optical scanning device 100 according to any one of the exemplary embodiments is mounted.

The image forming apparatus 90 is a tandem type color image forming apparatus that records image information on the surfaces of photosensitive drums that are image bearing members, using the optical scanning device 100.

The image forming apparatus 90 includes the optical scanning device 100, photosensitive drums (photosensitive members) 23, 24, 25, and 26 serving as image bearing members, and developing devices 15, 16, 17, and 18. The image forming apparatus 90 also includes a conveyance belt 91, a printer controller 93, and a fixing device 94.

Red (R), green (G), and blue (B) color signals (code data) output from an external apparatus 92 such as a personal computer are input to the image forming apparatus 90.

The printer controller 93 in the image forming apparatus 90 converts the input color signals into C, M, Y, and K, respective pieces of image data (dot data).

The pieces of converted image data are input to the optical scanning device 100. The optical scanning device 100 emits light beams 19, 20, 21, and 22 modulated based on the respective pieces of image data. The photosensitive surfaces of the photosensitive drums 23, 24, 25, and 26 are exposed by the light beams 19, 20, 21, and 22.

Charging rollers (not illustrated) that uniformly charge the surfaces of the photosensitive drums 23, 24, 25, and 26 are disposed in contact with the surfaces. The optical scanning device 100 irradiates the surfaces of the photosensitive drums 23, 24, 25, and 26 charged by the charging rollers with the light beams 19, 20, 21, and 22.

As described above, the light beams 19, 20, 21, and 22 are modulated based on the image data of respective colors. The irradiation with the light beams 19, 20, 21, and 22 forms electrostatic latent images on the surfaces of the photosensitive drums 23, 24, 25, and 26. The formed electrostatic latent images are developed into toner images by the developing devices 15, 16, 17, and 18 disposed in contact with the photosensitive drums 23, 24, 25, and 26.

The toner images developed by the developing devices 15 to 18 are transferred to a not-illustrated sheet (material to be transferred) conveyed on the conveyance belt 91 in a superposed manner by not-illustrated transfer rollers (transfer devices) opposed to the photosensitive drums 23 to 26, whereby a full-color image is formed.

The sheet to which the unfixed toner image is thus transferred is further conveyed to the fixing device 94 behind (in FIG. 22, on the left of) the photosensitive drums 23, 24, 25, and 26. The fixing device 95 consists of a fixing roller including a fixing heater (not illustrated) inside and a pressure roller disposed to press against the fixing roller. The sheet conveyed from the transfer section is pressed and heated at the pressing portion between the fixing roller and the pressure roller, whereby the unfixed toner image on the sheet is fixed. A not-illustrated discharge roller is further disposed behind the fixing roller. The discharge roller discharges the fixed sheet to outside the image forming apparatus 90.

The color image forming apparatus 90 records the image signals (image information) on the photosensitive surfaces of the photosensitive drums 23, 34, 25, and 26 corresponding to C, M, Y, and K colors using the optical scanning device 100, and prints color images at high speed.

For example, a color image reading apparatus with a charge-coupled device (CCD) sensor may be used as the external apparatus 92. In such a case, the color image reading apparatus and the color image forming apparatus 90 constitute a color digital copying machine.

While some exemplary embodiments have been described above, some embodiments are not limited to these exemplary embodiments, and various modifications and changes can be made within the scope of the gist of the present disclosure. The configurations of the above-described exemplary embodiments can be combined with each other. That is, a configuration adopted in one exemplary embodiment may be adopted in another exemplary embodiment, or may be adopted as necessary even if it is not adopted.

This application claims priority to Japanese Patent Applications No. 2023-215781, which was filed on Dec. 21, 2023; No. 2023-215782, which was filed on Dec. 21, 2023, No. 2023-215785, which was filed on Dec. 21, 2023, and No. 2024-199436, filed Nov. 15, 2024, which are hereby incorporated by reference herein in their entireties.

What is claimed is:

1. An optical scanning device comprising:
a deflector including a first deflection surface configured to deflect first and second light beams to scan first and second scanned surfaces in a main scanning direction, respectively; and
first and second optical systems configured to guide the first and second light beams deflected by the first deflection surface to the first and second scanned surfaces,
wherein the first and second optical systems include a common first optical element disposed on first and second optical paths extending from the first deflection surface to the first and second scanned surfaces, respectively,
wherein the first optical system includes a second optical element located on the first optical path, between the first optical element and the first scanned surface,
wherein the second optical system includes a third optical element located on the second optical path, between the first optical element and the second scanned surface, and
wherein the first optical element includes first and second optical portions on which the first and second light beams are incident.

2. The optical scanning device according to claim 1, wherein at least either a pair of incident surfaces or a pair of exit surfaces of the first and second optical portions is offset in an optical axis direction at their interface.

3. The optical scanning device according to claim 2, wherein the following inequality is satisfied:
0.01≤|Xmax|≤1.0,
where Xmax (mm) is a maximum value of an amount of offset of the at least either a pair of incident surfaces or a pair of exit surfaces of the first and second optical portions at the interface in the optical axis direction.

4. The optical scanning device according to claim 1, wherein the incident surfaces of the respective first and second optical portions have a same shape.

5. The optical scanning device according to claim 1, wherein optical path lengths from the first deflection surface to the second and third optical elements are different.

6. The optical scanning device according to claim 1, wherein optical path lengths from the first deflection surface to the first and second scanned surfaces are different.

7. The optical scanning device according to claim 1, wherein the following inequalities are satisfied:
$$\vert θ2 \vert \geq \vert θ1 \vert , and$$
$$- 2.5 < θ 2 / θ 1 < 2.5 ,$$
where θ1 is an incident angle of a principal ray of the first light beam on the first deflection surface and θ2 is an incident angle of a principal ray of the second light beam on the first deflection surface in a sub scanning section.

8. The optical scanning device according to claim 1, wherein the at least either a pair of incident surfaces or a pair of exit surfaces of the first and second optical portions has different curvatures on an optical axis in a sub scanning section.

9. The optical scanning device according to claim 1, wherein a curvature of the at least either a pair of incident surfaces or a pair of exit surfaces of the first and second optical portions in a sub scanning section changes in the main scanning direction.

10. The optical scanning device according to claim 9, wherein the curvature of the pair of exit surfaces of the first and second optical portions in the sub scanning section changes in the main scanning direction.

11. The optical scanning device according to claim 1, wherein a distance from the second optical element to the first scanned surface and a distance from the third optical element to the second scanned surface are different.

12. The optical scanning device according to claim 1,
wherein the following inequality is satisfied:
θ2/θ1<0, and
wherein a difference between a number of reflective elements disposed between the first deflection surface and the first scanned surface and a number of reflective elements disposed between the first deflection surface and the second scanned surface is an odd number.

13. The optical scanning device according to claim 1,
wherein the following inequality is satisfied:
θ2/θ1>0, and
wherein a difference between a number of reflective elements disposed between the first deflection surface and the first scanned surface and a number of reflective elements disposed between the first deflection surface and the second scanned surface is an even number.

14. The optical scanning device according to claim 1, wherein the at least either a pair of incident surfaces or a pair of exit surfaces of the first and second optical portions has mutually asymmetric shapes in a sub scanning section.

15. The optical scanning device according to claim 14, wherein the pair having the mutually asymmetric shapes in the sub scanning section has shapes symmetrical about an optical axis in a main scanning section.

16. The optical scanning device according to claim 1, wherein the following inequality is satisfied:
$$0.8 < β 1 / β 2 < 1.2 ,$$
where β1 and β2 are imaging magnifications of the first and second optical systems in a sub scanning section, respectively.

17. The optical scanning device according to claim 1, wherein the first optical element includes an optical surface of which a normal to a generatrix is nonparallel to an optical axis in a sub scanning section including the optical axis.

18. The optical scanning device according to claim 1, wherein the at least either a pair of incident surfaces or a pair of exit surfaces of the first and second optical portions has different shapes in a main scanning section.

19. The optical scanning device according to claim 1,
wherein the deflector includes a second deflection surface configured to deflect third and fourth light beams to scan third and fourth scanned surfaces in the main scanning direction, respectively,
wherein the optical scanning device further comprises third and fourth optical systems configured to guide the third and fourth light beams deflected by the second deflection surface to the third and fourth scanned surfaces,
wherein the third and fourth optical systems include a common fourth optical element disposed on third and fourth optical paths extending from the second deflection surface to the third and fourth scanned surfaces, respectively,
wherein the third optical system includes a fifth optical element located on the third optical path, between the fourth optical element and the third scanned surface,
wherein the fourth optical system includes a sixth optical element located on the fourth optical path, between the fourth optical element and the fourth scanned surface, and
wherein the fourth optical element includes third and fourth optical portions on which the third and fourth light beams are incident.

20. The optical scanning device according to claim 19, wherein the first and fourth optical portions have same shapes if one is rotated 180° relative to the other in a sub scanning section.

21. The optical scanning device according to claim 19,
wherein the first and fourth optical elements each include a gate portion disposed on either one of its ends in the main scanning direction, and
wherein the gate portions of the first and fourth optical elements are located on opposite sides of an optical axis in a main scanning section.

22. An image forming apparatus comprising:
the optical scanning device according to claim 1; and
a developing device configured to develop an electrostatic latent image formed by the optical scanning device into a toner image.

23. An image forming apparatus comprising:
the optical scanning device according to claim 1; and
a printer controller configured to convert code data output from an external apparatus into an image signal and input the image signal to the optical scanning device.
